(19) United States
(12) Patent Application Publication
(10) Pub. No.: US 2026/0143312 A1
(43) Pub. Date: May 21, 2026

(54) SYSTEMS AND METHODS FOR DETERMINATION OF SENSING ROLES IN A MESH NETWORK

(71) Applicant: COGNITIVE SYSTEMS CORP., Waterloo (CA)

(72) Inventors: Chris BEG, Waterloo (CA); Mohammad OMER, Waterloo (CA)

(21) Appl. No.: 19/123,364

(22) PCT Filed: Oct. 23, 2023
(86) PCT No.: PCT/IB2023/060485

§ 371 Date: Apr. 22, 2025

Related U.S. Application Data
(60) Provisional application No. 63/381,092, filed on Oct. 26, 2022.
(60) Provisional application No. 63/383,636, filed on Nov. 14, 2022.

(51) Int. Cl. H04W 4/38; H04B 17/15; H04W 84/18

(52) U.S. Cl. CPC H04W 4/38; H04B 17/191; H04W 84/18

(57) ABSTRACT

Systems and methods for Wi-Fi sensing are provided. Wi-Fi sensing methods may be carried out by a networking device configured to operate as an access point (AP) within a mesh network. The AP may be configured to identify a reciprocal AP with which the AP has a reciprocal wireless link. The AP may be configured to determine a first AP role determination metric associated with the AP and receive a second AP role determination metric associated with the reciprocal AP. The AP may be configured to compare the first AP role determination metric to the second AP role determination metric to allocate a first sensing role to the AP based on the comparing and allocate a second sensing role to the reciprocal AP based on the comparing.

### RELATED APPLICATIONS

This application claims priority to U.S. Provisional Application No. 63/381,092, filed Oct. 26, 2022 and to U.S. Provisional Application No. 63/383,636, filed Nov. 14, 2022, both of which are hereby incorporated herein in their entirety.

### TECHNICAL FIELD

The present disclosure generally relates to systems and methods for Wi-Fi sensing. In particular, the present disclosure relates to systems and methods for determination of sensing roles in a mesh sensing network.

### BACKGROUND OF THE DISCLOSURE

Motion detection systems have been used to detect movement, for example, of objects in a room or an outdoor area. In some example motion detection systems, infrared or optical sensors are used to detect movement of objects in the sensor's field of view. Motion detection systems have been used in security systems, automated control systems, and other types of systems. A WLAN sensing system (which may be referred to as a Wi-Fi sensing system) is one recent addition to motion detection systems. A Wi-Fi sensing system may be a network of Wi-Fi-enabled devices that may be a part of an IEEE 802.11 network. In an example, a Wi-Fi sensing system may be configured to detect features of interest in a sensing space. A sensing space may refer to any physical space in which the Wi-Fi sensing system may operate, such as a place of residence, a place of work, a shopping mall, a sports hall or sports stadium, a garden, or any other physical space. Features of interest may include motion of objects and motion tracking, presence detection, intrusion detection, gesture recognition, fall detection, breathing rate detection, and other applications.

### BRIEF SUMMARY OF THE DISCLOSURE

The present disclosure generally relates to systems and methods for Wi-Fi sensing. In particular, the present disclosure relates to systems and methods for determination of sensing roles in a mesh sensing network.

Systems and methods are provided for Wi-Fi sensing. In an example embodiment, a method for Wi-Fi sensing is described. The method is carried out by a networking device configured to operate as an access point (AP) within a mesh network and including at least a receiving antenna, a transmitting antenna, and at least one processor configured to execute instructions. The method includes identifying a reciprocal AP with which the AP has a reciprocal wireless link. In some embodiments, the method includes determining a first AP role determination metric associated with the AP. Further, in some embodiments, the method includes receiving a second AP role determination metric associated with the reciprocal AP and comparing the first AP role determination metric to the second AP role determination metric. In some embodiments, the method includes allocating a first sensing role to the AP and allocating a second sensing role to the reciprocal AP based on the comparing.

In some embodiments, identifying the reciprocal AP includes transmitting a first sensing transmission to the reciprocal AP, receiving a first sensing measurement made on the first sensing transmission by the reciprocal AP, receiving a second sensing transmission from the reciprocal AP, generating a second sensing measurement based on the second sensing transmission, comparing the first sensing measurement to the second sensing measurement, and responsive to the comparing, identifying the reciprocal AP as having the reciprocal wireless link.

In some embodiments, determining the first AP role determination metric includes determining a first AP congestion metric.

In some embodiments, determining the first AP congestion metric is based on a number of associated STAs metric. In examples, the number of associated STAs metric is determined according to a number of stations associated with the AP scaled by respective levels of activity on the stations.

In some embodiments, determining the first AP role determination metric is based on a first AP bandwidth metric. In examples, the first AP bandwidth metric is determined according to orthogonal frequency-division multiple access (OFDMA) activity of stations associated with the AP. In some embodiments, the first AP bandwidth metric is based on a total bandwidth allocated to stations associated with the AP.

In some embodiments, determining the first AP role determination metric is based on a first computational metric of the AP.

In some embodiments, determining the first AP role determination metric is based on a first over the air (OTA) metric of the AP. In examples, the first OTA metric is determined according to a space metric and a hops metric. In an example, the hops metric is equal to a number of wireless links between the AP and an internet connected AP. Further, in an example, the space metric is based on a location and visibility of the AP.

In some embodiments, the first sensing role is a sensing receiver role, and allocating the first sensing role to the AP includes assigning the sensing receiver role to the AP based on the comparing.

In some embodiments, the first AP role determination metric is determined according to a first AP bandwidth metric, a first computational metric, and a first OTA metric.

In some embodiments, the method further includes determining to use a trigger based protocol or a non-trigger based protocol according to first sensing role and the reciprocal wireless link.

In some embodiments, the first AP role determination metric is a combined AP role determination metric determined according to a first combination of at least two of a first AP bandwidth metric, a first computational metric, and a first OTA metric.

In some embodiments, the second AP role determination metric is a combined AP role determination metric determined according to a second combination of at least two of a second AP bandwidth metric, a second computational metric, and a second OTA metric.

In some embodiments the first combination and the second combination are weighted combinations.

Other aspects and advantages of the disclosure will become apparent from the following detailed description, taken in conjunction with the accompanying drawings, which illustrate by way of example, the principles of the disclosure.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a diagram showing an example wireless communication system.

FIG. 2A and FIG. 2B are diagrams showing example wireless signals communicated between wireless communication devices.

FIG. 3A and FIG. 3B are plots showing examples of channel responses computed from the wireless signals communicated between wireless communication devices in FIG. 2A and FIG. 2B.

FIG. 4A and FIG. 4B are diagrams showing example channel responses associated with motion of an object in distinct regions of a space.

FIG. 4C and FIG. 4D are plots showing the example channel responses of FIG. 4A and FIG. 4B overlaid on an example channel response associated with no motion occurring in the space.

FIG. 5 depicts an implementation of some of an architecture of a system for Wi-Fi sensing, according to some embodiments.

FIG. 6 depicts an example of a WLAN sensing procedure, according to some embodiments.

FIG. 7A depicts an example of a Sensing Measurement Setup Request frame format, according to some embodiments.

FIG. 7B illustrates an example of a Sensing Measurement Parameters element, according to some embodiments.

FIG. 7C illustrates an example of a format of a Sensing Measurement Parameters field, according to some embodiments.

FIG. 7D depicts an example of a Sensing Measurement Setup Response frame, according to some embodiments.

FIG. 8A depicts one-to-many and many-to-one aspects of an example of a WLAN sensing procedure, according to some embodiments.

FIG. 8B depicts pairwise aspects of an example of a WLAN sensing procedure, according to some embodiments.

FIG. 9 depicts a message flow of a trigger-based (TB) sensing measurement instance of a WLAN sensing procedure that consists of either NDPA sounding or TF sounding, according to some embodiments.

FIG. 10A and FIG. 10B depict examples of trigger-based (TB) sensing measurement instances, according to some embodiments.

FIG. 11A and FIG. 11B depict an example of a single TB sensing measurement instance including a polling phase, a trigger frame sounding phase, and an NDPA sounding phase, according to some embodiments.

FIG. 12 depicts a message flow of a non-TB sensing measurement instance of a WLAN sensing procedure with both uplink and downlink sounding, according to some embodiments.

FIG. 13 depicts an example of a single non-TB sensing measurement instance, according to some embodiments.

FIG. 14 depicts an example of a Public Action frame format of a Sensing Measurement Report frame and a Sensing Measurement Report field format, according to some embodiments.

FIG. 15A to FIG. 15H depict a hierarchy of fields within a sensing trigger, according to some embodiments.

FIG. 16 depicts an example of a Wi-Fi sensing network implemented by an Easy Mesh network, according to some embodiments.

FIG. 17A and FIG. 17B depict an example of a high space metric and a low space metric for an AP, according to some embodiments.

FIG. 18 depicts an example of allocation of sensing roles based on a combined AP determination metric, according to some embodiments.

FIG. 19A and FIG. 19B depict a flowchart for allocating a first sensing role to an AP and a second sensing role to a reciprocal AP based on a comparison of a first AP role determination metric and a second AP role determination metric, according to some embodiments.

FIG. 20A, FIG. 20B, and FIG. 20C depict a flowchart for identifying a reciprocal AP with which an AP has a reciprocal wireless link and allocating a first sensing role to the AP and a second sensing role to the reciprocal AP based on a comparison of a first AP role determination metric and a second AP role determination metric, according to some embodiments.

### DETAILED DESCRIPTION

Wireless sensing enables a device to obtain sensing measurements of transmission channel(s) between two or more devices. With the execution of a wireless sensing procedure, it is possible for a device to obtain sensing measurements useful for detecting and tracking changes in the environment. In some aspects of what is described herein, a wireless sensing system may be used for a variety of wireless sensing applications by processing wireless signals (e.g., radio frequency (RF) signals) transmitted through a space between wireless communication devices. Example wireless sensing applications include motion detection, which can include the following: detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications. Other examples of wireless sensing applications include object recognition, speaking recognition, keystroke detection and recognition, tamper detection, touch detection, attack detection, user authentication, driver fatigue detection, traffic monitoring, smoking detection, school violence detection, human counting, human recognition, bike localization, human queue estimation, Wi-Fi imaging, and other types of wireless sensing applications. For instance, the wireless sensing system may operate as a motion detection system to detect the existence and location of motion based on Wi-Fi signals or other types of wireless signals. As described in more detail below, a wireless sensing system may be configured to control measurement rates, wireless connections, and device participation, for example, to improve system operation or to achieve other technical advantages. The system improvements and technical advantages achieved when the wireless sensing system is used for motion detection are also achieved in examples where the wireless sensing system is used for another type of wireless sensing application.

In some example wireless sensing systems, a wireless signal includes a component (e.g., a synchronization preamble in a Wi-Fi PHY frame, or another type of component) that wireless devices can use to estimate a channel response or other channel information, and the wireless sensing system can detect motion (or another characteristic depending on the wireless sensing application) by analyzing changes in the channel information collected over time. In some examples, a wireless sensing system can operate similar to a bistatic radar system, where a Wi-Fi access point (AP) assumes the receiver role, and each Wi-Fi device (station (STA), node, or peer) connected to the AP assumes the transmitter role. The wireless sensing system may trigger a connected device to generate a transmission and produce a channel response measurement at a receiver device. This triggering process can be repeated periodically to obtain a sequence of time variant measurements. A wireless sensing algorithm may then receive the generated time-series of channel response measurements (e.g., computed by Wi-Fi receivers) as input, and through a correlation or filtering process, may then make a determination (e.g., determine if there is motion or no motion within the environment represented by the channel response, for example, based on changes or patterns in the channel estimations). In examples where the wireless sensing system detects motion, it may also be possible to identify a location of the motion within the environment based on motion detection results among a number of wireless devices.

Accordingly, wireless signals received at each of the wireless communication devices in a wireless communication network may be analyzed to determine channel information for the various communication links (between respective pairs of wireless communication devices) in the network. The channel information may be representative of a physical medium that applies a transfer function to wireless signals that traverse a space. In some instances, the channel information includes a channel response. Channel responses can characterize a physical communication path, representing the combined effect of, for example, scattering, fading, and power decay within the space between the transmitter and receiver. In some instances, the channel information includes beamforming state information (e.g., a feedback matrix, a steering matrix, channel state information, etc.) provided by a beamforming system. Beamforming is a signal processing technique often used in multi antenna (multiple-input/multiple-output (MIMO)) radio systems for directional signal transmission or reception. Beamforming can be achieved by operating elements in an antenna array in such a way that signals at some angles experience constructive interference while others experience destructive interference.

The channel information for each of the communication links may be analyzed (e.g., by a hub device or other device in a wireless communication network, or a sensing transmitter, sensing receiver, or sensing initiator communicably coupled to the network) to, for example, detect whether motion has occurred in the space, to determine a relative location of the detected motion, or both. In some aspects, the channel information for each of the communication links may be analyzed to detect whether an object is present or absent, e.g., when no motion is detected in the space.

In some cases, a wireless sensing system can control a node measurement rate. For instance, a Wi-Fi motion system may configure variable measurement rates (e.g., channel estimation/environment measurement/sampling rates) based on criteria given by a current wireless sensing application (e.g., motion detection). In some implementations, when no motion is present or detected for a period of time, for example, the wireless sensing system can reduce the rate that the environment is measured, such that the connected device will be triggered or caused to make sensing transmissions or sensing measurements less frequently. In some implementations, when motion is present, for example, the wireless sensing system can increase the triggering rate or sensing transmissions rate or sensing measurement rate to produce a time-series of measurements with finer time resolution. Controlling a variable sensing measurement rate can allow energy conservation (through the device triggering), reduce processing (less data to correlate or filter), and improve resolution during specified times.

In some cases, a wireless sensing system can perform band steering or client steering of nodes throughout a wireless network, for example, in a Wi-Fi multi-AP or extended service set (ESS) topology, multiple coordinating wireless APs each provide a basic service set (BSS) which may occupy different frequency bands and allow devices to transparently move between from one participating AP to another (e.g., mesh). For instance, within a home mesh network, Wi-Fi devices can connect to any of the APs, but typically select one with good signal strength. The coverage footprint of the mesh APs typically overlap, often putting each device within communication range or more than one AP. If the AP supports multi-bands (e.g., 2.4 GHz and 5 GHZ), the wireless sensing system may keep a device connected to the same physical AP but instruct it to use a different frequency band to obtain more diverse information to help improve the accuracy or results of the wireless sensing algorithm (e.g., motion detection algorithm). In some implementations, the wireless sensing system can change a device from being connected to one mesh AP to being connected to another mesh AP. Such device steering can be performed, for example, during wireless sensing (e.g., motion detection), based on criteria detected in a specific area to improve detection coverage, or to better localize motion within an area.

In some cases, beamforming may be performed between wireless communication devices based on some knowledge of the communication channel (e.g., through feedback properties generated by a receiver), which can be used to generate one or more steering properties (e.g., a steering matrix) that are applied by a transmitter device to shape the transmitted beam/signal in a particular direction or directions. Thus, changes to the steering or feedback properties used in the beamforming process indicate changes, which may be caused by moving objects, in the space accessed by the wireless communication system. For example, motion may be detected by substantial changes in the communication channel, e.g., as indicated by a channel response, or steering or feedback properties, or any combination thereof, over a period of time.

In some implementations, for example, a steering matrix may be generated at a transmitter device (beamformer) based on a feedback matrix provided by a receiver device (beamformee) based on channel sounding. Because the steering and feedback matrices are related to propagation characteristics of the channel, these matrices change as objects move within the channel. Changes in the channel characteristics are accordingly reflected in these matrices, and by analyzing the matrices, motion can be detected, and different characteristics of the detected motion can be determined. In some implementations, a spatial map may be generated based on one or more beamforming matrices. The spatial map may indicate a general direction of an object in a space relative to a wireless communication device. In some cases, many beamforming matrices (e.g., feedback matrices or steering matrices) may be generated to represent a multitude of directions that an object may be located relative to a wireless communication device. These many beamforming matrices may be used to generate the spatial map. The spatial map may be used to detect the presence of motion in the space or to detect a location of the detected motion.

In some instances, a motion detection system can control a variable device measurement rate in a motion detection process. For example, a feedback control system for a multi-node wireless motion detection system may adaptively change the sample rate based on environmental conditions. In some cases, such controls can improve operation of the motion detection system or provide other technical advantages. For example, the measurement rate may be controlled in a manner that optimizes or otherwise improves air-time usage versus detection ability suitable for a wide range of different environments and different motion detection applications. The measurement rate may be controlled in a manner that reduces redundant measurement data to be processed, thereby reducing processor load/power requirements. In some cases, the measurement rate is controlled in a manner that is adaptive, for instance, an adaptive sample can be controlled individually for each participating device. An adaptive sample rate can be used with a tuning control loop for different use cases, or device characteristics.

In some cases, a wireless sensing system can allow devices to dynamically indicate and communicate their wireless sensing capability or wireless sensing willingness to the wireless sensing system. For example, there may be times when a device does not want to be periodically interrupted or triggered to transmit a wireless signal that would allow the AP to produce a channel measurement. For instance, if a device is sleeping, frequently waking the device up to transmit or receive wireless sensing signals could consume resources (e.g., causing a cell phone battery to discharge faster). These and other events could make a device willing or not willing to participate in wireless sensing system operations. In some cases, a cell phone running on its battery may not want to participate, but when the cell phone is plugged into the charger, it may be willing to participate. Accordingly, if the cell phone is unplugged, it may indicate to the wireless sensing system to exclude the cell phone from participating; whereas if the cell phone is plugged in, it may indicate to the wireless sensing system to include the cell phone in wireless sensing system operations. In some cases, if a device is under load (e.g., a device streaming audio or video) or busy performing a primary function, the device may not want to participate; whereas when the same device's load is reduced and participating will not interfere with a primary function, the device may indicate to the wireless sensing system that it is willing to participate.

Example wireless sensing systems are described below in the context of motion detection (detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications). However, the operation, system improvements, and technical advantages achieved when the wireless sensing system is operating as a motion detection system are also applicable in examples where the wireless sensing system is used for another type of wireless sensing application.

In various embodiments of the disclosure, non-limiting definitions of one or more terms that will be used in the description are provided below.

A wireless access point (WAP) or simply an access point (AP) is a networking device in a WLAN network that allows other networking devices in a WLAN network to connect to a wired network. In examples, an AP creates a wireless local area network.

A station (STA) is any device that is connected to a WLAN network and which contains 802.11 compliant MAC and PHY interface to the wireless medium. A STA may be a laptop, desktop, smartphone, or a smart appliance. A STA may be fixed, mobile or portable. A STA that does not take on the roles of an AP may be referred to as a non-AP STA.

A term “transmission opportunity (TXOP)” may refer to a negotiated interval of time during which a particular quality of service (QoS) station (e.g., a STA, an AP, or either a STA or an AP, for example in the role of a sensing initiator, a sensing responder, a sensing transmitter or a sensing receiver) may have the right to initiate a frame exchange onto a wireless medium. A QoS access category (AC) of the transmission opportunity may be requested as part of a service or session negotiation.

A term “Quality of Service (QoS) access category (AC)” may refer to an identifier for a frame which classifies a priority of transmission that the frame requires. In an example, four QoS access categories are defined namely AC_VI: Video, AC_VO: Voice, AC_BE: Best-Effort, and AC_BK: Background. Further, each QoS access category may have different TXOP parameters defined for it.

A term “short interframe space (SIFS)” may refer to a period within which a processing element (for example, a microprocessor, dedicated hardware, or any such element) within a device of a Wi-Fi sensing system is able to process data presented to it in a frame. In an example, a short interframe space may be 10 ms.

A term “PHY-layer Protocol Data Unit (PPDU)” may refer to a data unit that includes preamble and data fields. The preamble field may include transmission vector format information and the data field may include payload and higher layer headers.

A term “null data PPDU (NDP)” may refer to a PPDU that does not include a data field. In an example, a null data PPDU may be used for a sensing transmission, where a MAC header of the NDP includes information required for a sensing receiver to make a sensing measurement on the sensing transmission.

A term “transmission parameters” may refer to a set of IEEE 802.11 PHY transmitter configuration parameters which are defined as a part of transmission vector (TXVECTOR) corresponding to a specific PHY and which may be configurable for each PHY-layer PPDU transmission or each null data PPDU (NDP) transmission.

A term “resource unit (RU)” may refer to an allocation of orthogonal frequency division multiplexing (OFDM) channels which may be used to carry a modulated signal. An RU may include a variable number of carriers depending on the mode of the modem.

A term “tone” may refer to an individual subcarrier in an OFDM signal. A tone may be represented in time domain or frequency domain. In time domain, a tone may also be referred to as a symbol. In frequency domain, a tone may also be referred to as a subcarrier.

A term “time domain pulse” may refer to a complex number that represents amplitude and phase of discretized energy in time domain. When frequency domain channel state information values are obtained for each tone from a baseband receiver, time domain pulses may be obtained by performing an IFFT on the channel state information values.

A term “sensing goal” may refer to a goal of a sensing activity at a time. A sensing goal is not static and may change at any time. In an example, a sensing goal may require sensing measurements of a specific type, a specific format, or a specific precision, resolution, or accuracy to be available to a sensing algorithm.

A term “sensing space” may refer to any physical space in which a Wi-Fi sensing system may operate.

A term “wireless local area network (WLAN) sensing session” or “Wi-Fi sensing session” may refer to a period during which objects in a physical space may be probed, detected and/or characterized. In an example, during a WLAN sensing session, several devices participate in, and thereby contribute to the generation of sensing measurements. A WLAN sensing session may be referred to as a “measurement campaign.”

A term “non-sensing message” may refer to a message which is not primarily related to sensing. In an example, non-sensing messages may include data, management, and control messages.

A term “sensing measurement” may refer to a measurement of a state of a wireless channel between a transmitter device (for example, a sensing transmitter) and a receiver device (for example, a sensing receiver) derived from a sensing transmission. In an example, sensing measurement may also be referred to as channel response measurement.

A term “sensing algorithm” may refer to a computational algorithm that achieves a sensing goal. A sensing algorithm may be executed on any device in a Wi-Fi sensing system.

Wireless network management (WNM) may provide information on network conditions and may also provide a means to obtain and exchange WLAN sensing information.

A sensing receiver is a station (STA) that receives sensing transmissions (for example, PPDUs or any other transmission including a data transmission which may be opportunistically used as a sensing transmission) sent by a sensing transmitter and performs sensing measurements as part of a WLAN sensing procedure. An AP is an example of a sensing receiver. In some examples, a STA may also be a sensing receiver.

A sensing transmitter is a station (STA) that transmits a sensing transmission (for example, PPDUs or any other transmission) used for sensing measurements (for example, channel state information) in a WLAN sensing procedure. In an example, a STA is an example of a sensing transmitter. In some examples, an AP may be a sensing transmitter for Wi-Fi sensing purposes, for example where a STA acts as a sensing receiver.

A sensing initiator is a station (STA) that initiates a WLAN sensing procedure. The role of sensing initiator may be taken on by a sensing receiver, a sensing transmitter, or a separate device which includes a sensing algorithm (for example, a remote processing device).

A sensing responder is a station (STA) that participates in a WLAN sensing procedure initiated by a sensing initiator. The role of sensing responder may be taken on by a sensing receiver or a sensing transmitter. In examples, multiple sensing responders may take part in a Wi-Fi sensing session.

A sensing by proxy (SBP) initiator is defined as a non-AP STA acting as a sensing initiator that transmits a SBP Request frame. In examples, sensing by proxy (SBP) enables a non-AP STA to obtain sensing measurements of the channel between an AP and one or more non-AP STAs or between a receive antenna and a transmit antenna of an AP. With the execution of the SBP procedure, it is possible for a non-AP STA to obtain sensing measurements necessary for detecting and tracking changes in the environment. A sensing by proxy (SBP) responder is an AP that receives or is the intended recipient of an SBP Request frame.

A term “sensing transmission” may refer to a transmission made from a sensing transmitter to a sensing receiver which may be used to make a sensing measurement. In an example, a sensing transmission may also be referred to as wireless sensing signal or wireless signal.

A term “sensing trigger message” may refer to a message sent from a sensing initiator to a sensing transmitter to initiate or trigger one or more sensing transmissions.

A term “sensing response message” may refer to a message which is included within a sensing transmission from a sensing transmitter to a sensing receiver. A sensing transmission that includes a sensing response message may be used by a sensing receiver to perform a sensing measurement.

A term “sensing response announcement” may refer to a message that is included within a sensing transmission from a sensing transmitter to a sensing receiver that announces that a sensing response NDP will follow within a short interframe space (SIFS). An example of a sensing response announcement is an NDP announcement, or NDPA. In examples, a sensing response NDP may be transmitted using a requested transmission configuration.

A term “sensing response NDP” may refer to a response transmitted by a sensing transmitter and used for a sensing measurement at a sensing receiver. In examples, a sensing response NDP may be used when a requested transmission configuration is incompatible with transmission parameters required for successful non-sensing message reception. A sensing response NDP may be announced by a sensing response announcement. In an example, a sensing response NDP may be implemented with a null data PPDU. In some examples, a sensing response NDP may be implemented with a frame that does not contain any data.

A term “channel representation information (CRI)” may refer to properties of a communications channel, such as how wireless signals propagate from a sensing transmitter to a sensing receiver along multiple paths, which are known or measured by a technique of channel estimation. For example, CRI may refer to one or more sensing measurements made on one or more sensing transmissions during a sampling instance which together represent the state of the channel at the sampling instance between two devices.

A term “channel state information (CSI)” may refer to an example of CRI which is represented in a frequency domain. CSI is typically a matrix of complex values representing the amplitude attenuation and phase shift of signals, which may also be expressed in in-phase (I) and quadrature (Q) components, which provides an estimation of a communications channel.

A term “time-domain channel representation information (TD-CRI)” may refer to an example of CRI which is represented in a time domain. TD-CRI may be generated by applying an inverse transform, such as an IDFT or an IFFT, to CSI.

A term “feature of interest” may refer to an item or a state of an item in a sensing space which is positively detected and/or identified by a sensing algorithm.

A term “requested transmission configuration” may refer to transmission parameters a sensing transmitter is requested to use when sending a sensing transmission.

A term “delivered transmission configuration” may refer to transmission parameters applied by a sensing transmitter to a sensing transmission.

A term “steering matrix configuration” may refer to a matrix of complex values representing real and complex phase required to pre-condition one or more antenna of a radio frequency (RF) transmission signal chain for each transmit signal. Application of a steering matrix configuration (for example, by a spatial mapper) enables beamforming and beam-steering.

A term “spatial mapper” may refer to a signal processing element that adjusts the amplitude and phase (or in-phase (I) and quadrature (Q) component representation) of a signal input to an RF transmission chain in a sensing transmitter. A spatial mapper may include elements to process the signal to each RF chain implemented. The operation carried out may be called spatial mapping. The output of a spatial mapper is one or more spatial streams.

A term “mesh network” may refer to a Wi-Fi network that constitutes more than one access point where the more than one access point act as a single Wi-Fi network.

A term “backhaul link” may refer to a link between access points in a mesh network.

A term “fronthaul link” may refer to a link between an access point and a station.

A term “sensing role” may refer to a role that a Wi-Fi device (or a networking device) carries out in a Wi-Fi sensing system. Examples of a sensing role are sensing initiator, sensing responder, sensing transmitter, and sensing receiver. A Wi-Fi device may be one of a sensing initiator and a sensing responder and one of a sensing transmitter and a sensing receiver together.

A term “AP congestion” may refer to a measure of computation load on a processor of an access point. In examples, AP congestion is the usage of computational resources of an access point. In an example, AP congestion may be defined as an absolute value such as millions of instructions per second (MIPS). In some examples, AP congestion may be defined as a percentage or fraction of available computational resources (for example, 5 percent of the available computational resources).

A term “available computational resources” may refer to total computation resources on an access point for all processing tasks, including communications, management, and sensing.

A term “number of associated STAs metric” may refer to a metric that represents the number of stations associated with an access point. In examples, the number of associated STAs metric may be adjusted to reflect aspects of the associated stations.

A term “computational load value” may refer to a value that represents the computational load of a process or a task running on an access point.

A term “computational metric” may represent the AP congestion based on the total processes or tasks running on an access point.

A term “hops metric” may refer to a metric that represents a number of hops between access points that a sensing measurement takes to reach the Internet or a sensing algorithm.

A term “space metric” may refer to a metric that represents a sensing space in which an access point is located. The space metric may consider obstacles and obstructions within the sensing space and that may affect a sensing transmission between access points.

A term “over the air (OTA) metric” may be a combined metric that represents the journey over the air that a sensing measurement is required to take to reach the Internet or a sensing algorithm. In an example, an OTA metric may be a combination of a hops metric and a space metric.

A term “AP congestion metric” may refer to a metric that relates to an aspect of a Wi-Fi device or of a Wi-Fi sensing network such as allocated bandwidth to a station or a number of stations associated with an AP. In examples, AP congestion metrics may allow ranking of all APs based on their AP congestion.

For purposes of reading the description of the various embodiments below, the following descriptions of the sections of the specifications and their respective contents may be helpful:

Section A describes a wireless communications system, wireless transmissions and sensing measurements which may be useful for practicing embodiments described herein.

Section B describes systems and methods that are useful for a wireless sensing system configurated to send sensing transmissions and make sensing measurements.

Section C describes embodiments of systems and methods that are useful for determination of sensing roles in a mesh sensing network.

### A. Wireless Communications System, Wireless Transmissions and Sensing Measurements

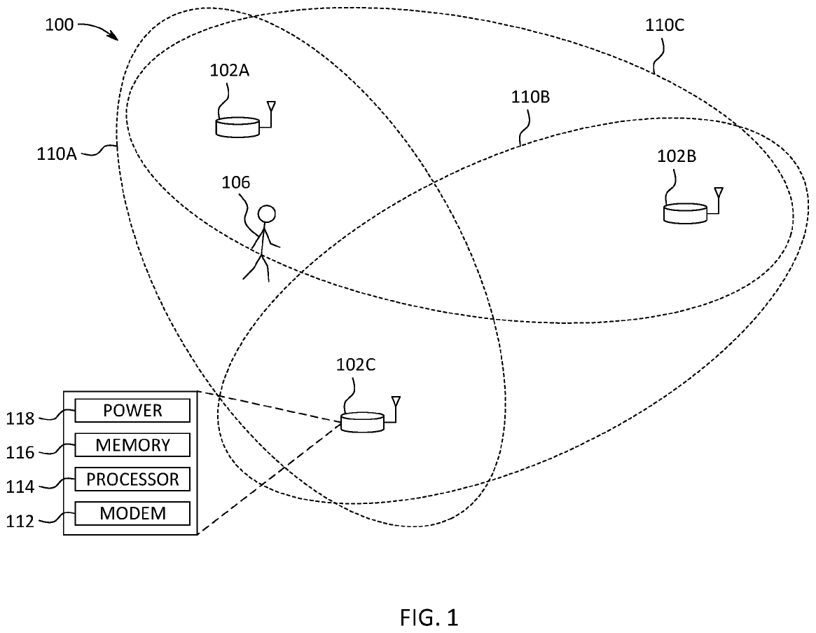

FIG. 1 illustrates wireless communication system 100. Wireless communication system 100 includes three wireless communication devices: first wireless communication device 102A, second wireless communication device 102B, and third wireless communication device 102C. Wireless communication system 100 may include additional wireless communication devices and other components (e.g., additional wireless communication devices, one or more network servers, network routers, network switches, cables, or other communication links, etc.).

Wireless communication devices 102A, 102B, 102C can operate in a wireless network, for example, according to a wireless network standard or another type of wireless communication protocol. For example, the wireless network may be configured to operate as a wireless local area network (WLAN), a personal area network (PAN), a metropolitan area network (MAN), or another type of wireless network. Examples of WLANs include networks configured to operate according to one or more of the 802.11 family of standards developed by IEEE (e.g., Wi-Fi networks), and others. Examples of PANs include networks that operate according to short-range communication standards (e.g., Bluetooth®., Near Field Communication (NFC), ZigBee), millimeter wave communications, and others.

In some implementations, wireless communication devices 102A, 102B, 102C may be configured to communicate in a cellular network, for example, according to a cellular network standard. Examples of cellular networks include networks configured according to 2G standards such as Global System for Mobile (GSM) and Enhanced Data rates for GSM Evolution (EDGE) or EGPRS; 3G standards such as code division multiple access (CDMA), wideband code division multiple access (WCDMA), Universal Mobile Telecommunications System (UMTS), and time division synchronous code division multiple access (TD-SCDMA); 4G standards such as Long-Term Evolution (LTE) and LTE-Advanced (LTE-A); 5G standards, and others.

In the example shown in FIG. 1, wireless communication devices 102A, 102B, 102C can be, or they may include standard wireless network components. For example, wireless communication devices 102A, 102B, 102C may be commercially available Wi-Fi APs or another type of wireless access point (WAP) performing one or more operations as described herein that are embedded as instructions (e.g., software or firmware) on the modem of the WAP. In some cases, wireless communication devices 102A, 102B, 102C may be nodes of a wireless mesh network, such as, for example, a commercially available mesh network system (e.g., Plume Wi-Fi, Google Wi-Fi, Qualcomm Wi-Fi SON, etc.). In some cases, another type of standard or conventional Wi-Fi transmitter device may be used. In some instances, one or more of wireless communication devices 102A, 102B, 102C may be implemented as WAPs in a mesh network, while other wireless communication device(s) 102A, 102B, 102C are implemented as leaf devices (e.g., mobile devices, smart devices, etc.) that access the mesh network through one of the WAPs. In some cases, one or more of wireless communication devices 102A, 102B, 102C is a mobile device (e.g., a smartphone, a smart watch, a tablet, a laptop computer, etc.), a wireless-enabled device (e.g., a smart thermostat, a Wi-Fi enabled camera, a smart TV), or another type of device that communicates in a wireless network.

Wireless communication devices 102A, 102B, 102C may be implemented without Wi-Fi components; for example, other types of standard or non-standard wireless communication may be used for motion detection. In some cases, wireless communication devices 102A, 102B, 102C can be, or they may be part of, a dedicated motion detection system. For example, the dedicated motion detection system can include a hub device and one or more beacon devices (as remote sensor devices), and wireless communication devices 102A, 102B, 102C can be either a hub device or a beacon device in the motion detection system.

As shown in FIG. 1, wireless communication device 102C includes modem 112, processor 114, memory 116, and power unit 118; any of wireless communication devices 102A, 102B, 102C in wireless communication system 100 may include the same, additional, or different components, and the components may be configured to operate as shown in FIG. 1 or in another manner. In some implementations, modem 112, processor 114, memory 116, and power unit 118 of a wireless communication device are housed together in a common housing or other assembly. In some implementations, one or more of the components of a wireless communication device can be housed separately, for example, in a separate housing or other assembly.

Modem 112 can communicate (receive, transmit, or both) wireless signals. For example, modem 112 may be configured to communicate RF signals formatted according to a wireless communication standard (e.g., Wi-Fi or Bluetooth). Modem 112 may be implemented as the example wireless network modem 112 shown in FIG. 1, or may be implemented in another manner, for example, with other types of components or subsystems. In some implementations, modem 112 includes a radio subsystem and a baseband subsystem. In some cases, the baseband subsystem and radio subsystem can be implemented on a common chip or chipset, or they may be implemented in a card or another type of assembled device. The baseband subsystem can be coupled to the radio subsystem, for example, by leads, pins, wires, or other types of connections.

In some cases, a radio subsystem in modem 112 can include one or more antennas and RF circuitry. The RF circuitry can include, for example, circuitry that filters, amplifies, or otherwise conditions analog signals, circuitry that up-converts baseband signals to RF signals, circuitry that down-converts RF signals to baseband signals, etc. Such circuitry may include, for example, filters, amplifiers, mixers, a local oscillator, etc. The radio subsystem can be configured to communicate radio frequency wireless signals on the wireless communication channels. As an example, the radio subsystem may include a radio chip, an RF front end, and one or more antennas. A radio subsystem may include additional or different components. In some implementations, the radio subsystem can be or may include the radio electronics (e.g., RF front end, radio chip, or analogous components) from a conventional modem, for example, from a Wi-Fi modem, pico base station modem, etc. In some implementations, the antenna includes multiple antennas.

In some cases, a baseband subsystem in modem 112 can include, for example, digital electronics configured to process digital baseband data. As an example, the baseband subsystem may include a baseband chip. A baseband subsystem may include additional or different components. In some cases, the baseband subsystem may include a digital signal processor (DSP) device or another type of processor device. In some cases, the baseband system includes digital processing logic to operate the radio subsystem, to communicate wireless network traffic through the radio subsystem, to detect motion based on motion detection signals received through the radio subsystem or to perform other types of processes. For instance, the baseband subsystem may include one or more chips, chipsets, or other types of devices that are configured to encode signals and deliver the encoded signals to the radio subsystem for transmission, or to identify and analyze data encoded in signals from the radio subsystem (e.g., by decoding the signals according to a wireless communication standard, by processing the signals according to a motion detection process, or otherwise).

In some instances, the radio subsystem in modem 112 receives baseband signals from the baseband subsystem, up-converts the baseband signals to RF signals, and wirelessly transmits the RF signals (e.g., through an antenna). In some instances, the radio subsystem in modem 112 wirelessly receives RF signals (e.g., through an antenna), down-converts the RF to baseband signals, and sends the baseband signals to the baseband subsystem. The signals exchanged between the radio subsystem and the baseband subsystem may be digital or analog signals. In some examples, the baseband subsystem includes conversion circuitry (e.g., a digital-to-analog converter, an analog-to-digital converter) and exchanges analog signals with the radio subsystem. In some examples, the radio subsystem includes conversion circuitry (e.g., a digital-to-analog converter, an analog-to-digital converter) and exchanges digital signals with the baseband subsystem.

In some cases, the baseband subsystem of modem 112 can communicate wireless network traffic (e.g., data packets) in the wireless communication network through the radio subsystem on one or more network traffic channels. The baseband subsystem of modem 112 may also transmit or receive (or both) signals (e.g., motion probe signals or motion detection signals) through the radio subsystem on a dedicated wireless communication channel. In some instances, the baseband subsystem generates motion probe signals for transmission, for example, to probe a space for motion. In some instances, the baseband subsystem processes received motion detection signals (signals based on motion probe signals transmitted through the space), for example, to detect motion of an object in a space.

Processor 114 can execute instructions, for example, to generate output data based on data inputs. The instructions can include programs, codes, scripts, or other types of data stored in memory. Additionally, or alternatively, the instructions can be encoded as pre-programmed or re-programmable logic circuits, logic gates, or other types of hardware or firmware components. Processor 114 may be or include a general-purpose microprocessor, as a specialized co-processor or another type of data processing apparatus. In some cases, processor 114 performs high level operation of the wireless communication device 102C. For example, processor 114 may be configured to execute or interpret software, scripts, programs, functions, executables, or other instructions stored in memory 116. In some implementations, processor 114 may be included in modem 112.

Memory 116 can include computer-readable storage media, for example, a volatile memory device, a non-volatile memory device, or both. Memory 116 can include one or more read-only memory devices, random-access memory devices, buffer memory devices, or a combination of these and other types of memory devices. In some instances, one or more components of the memory can be integrated or otherwise associated with another component of wireless communication device 102C. Memory 116 may store instructions that are executable by processor 114. For example, the instructions may include instructions for time-aligning signals using an interference buffer and a motion detection buffer, such as through one or more of the operations of the example processes herein disclosed.

Power unit 118 provides power to the other components of wireless communication device 102C. For example, the other components may operate based on electrical power provided by power unit 118 through a voltage bus or other connection. In some implementations, power unit 118 includes a battery or a battery system, for example, a rechargeable battery. In some implementations, power unit 118 includes an adapter (e.g., an alternating current (AC) adapter) that receives an external power signal (from an external source) and coverts the external power signal to an internal power signal conditioned for a component of wireless communication device 102C. Power unit 118 may include other components or operate in another manner.

In the example shown in FIG. 1, wireless communication devices 102A, 102B transmit wireless signals (e.g., according to a wireless network standard, a motion detection protocol, or otherwise). For instance, wireless communication devices 102A, 102B may broadcast wireless motion probe signals (e.g., reference signals, beacon signals, status signals, etc.), or they may send wireless signals addressed to other devices (e.g., a user equipment, a client device, a server, etc.), and the other devices (not shown) as well as wireless communication device 102C may receive the wireless signals transmitted by wireless communication devices 102A, 102B. In some cases, the wireless signals transmitted by wireless communication devices 102A, 102B are repeated periodically, for example, according to a wireless communication standard or otherwise.

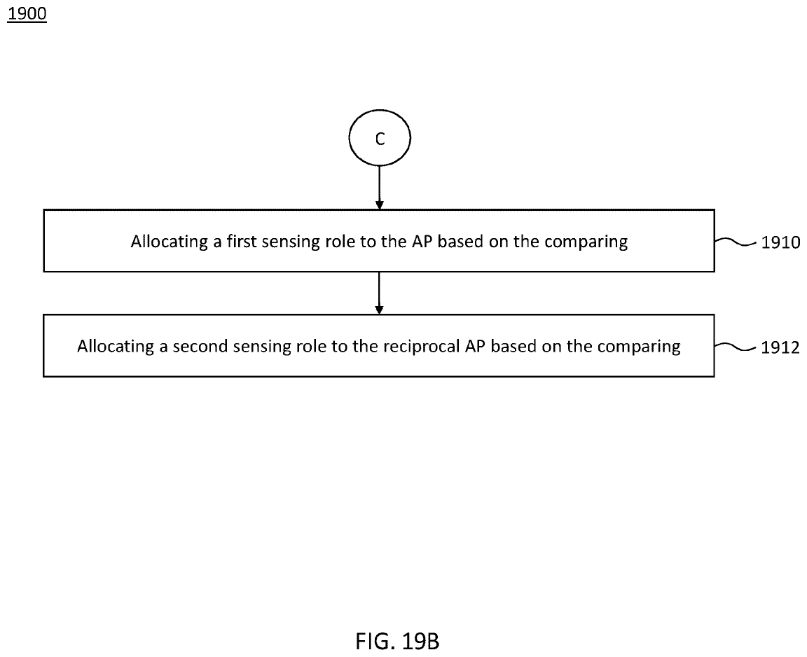

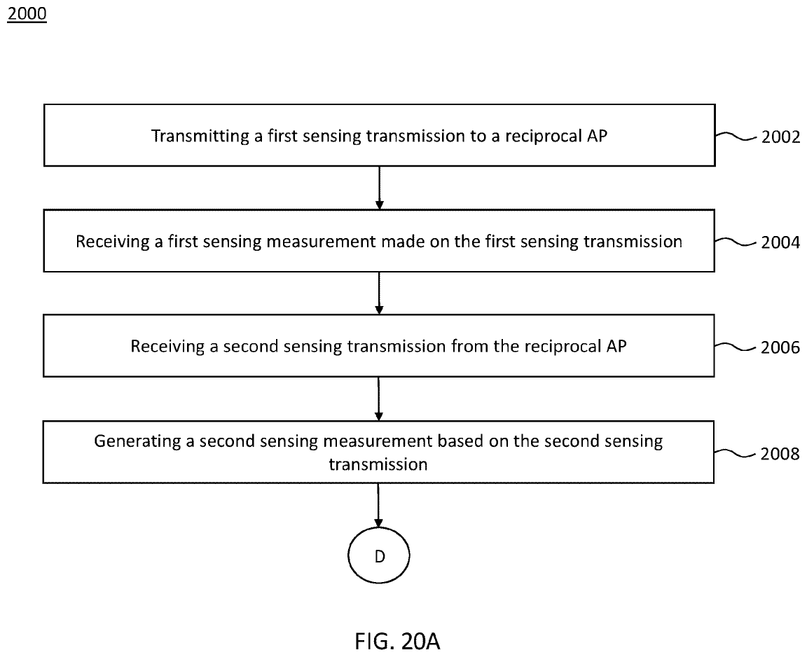

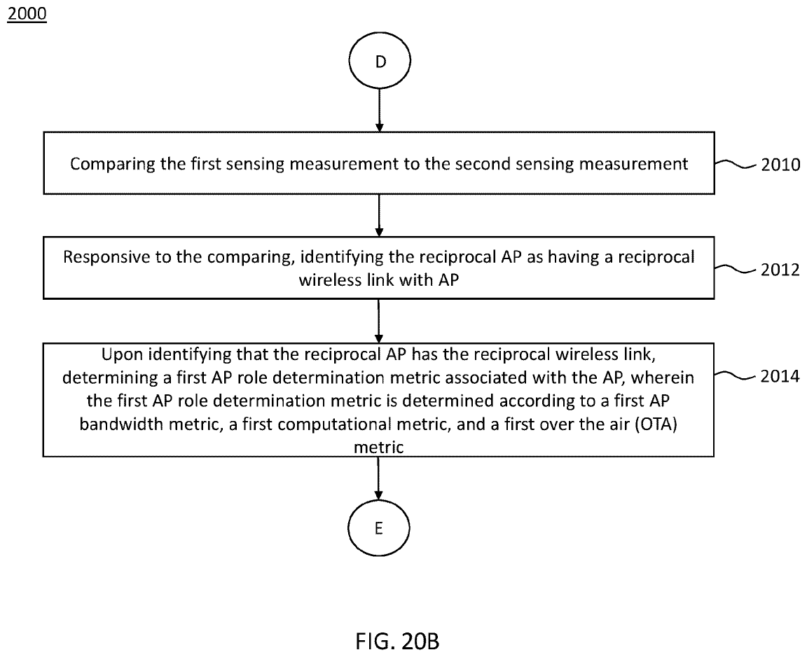

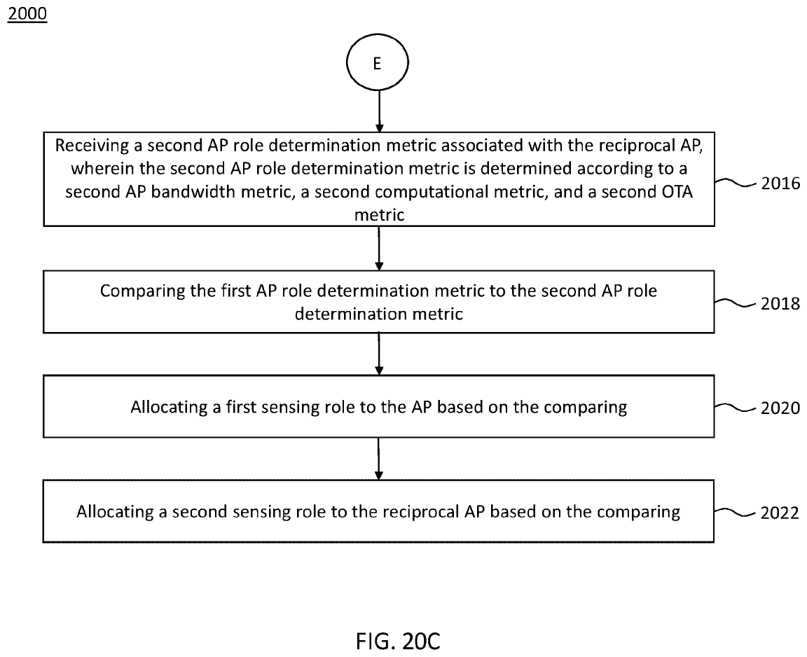

In the example shown, wireless communication device 102C processes the wireless signals from wireless communication devices 102A, 102B to detect motion of an object in a space accessed by the wireless signals, to determine a location of the detected motion, or both. For example, wireless communication device 102C may perform one or more operations of the example processes described below with respect to FIG. 19A, FIG. 19B, FIG. 20A, FIG. 20B, and FIG. 20C, or another type of process for detecting motion or determining a location of detected motion. The space accessed by the wireless signals can be an indoor or outdoor space, which may include, for example, one or more fully or partially enclosed areas, an open area without enclosure, etc. The space can be or can include an interior of a room, multiple rooms, a building, or the like. In some cases, the wireless communication system 100 can be modified, for instance, such that wireless communication device 102C can transmit wireless signals and wireless communication devices 102A, 102B can processes the wireless signals from wireless communication device 102C to detect motion or determine a location of detected motion.

The wireless signals used for motion detection can include, for example, a beacon signal (e.g., Bluetooth Beacons, Wi-Fi Beacons, other wireless beacon signals), another standard signal generated for other purposes according to a wireless network standard, or non-standard signals (e.g., random signals, reference signals, etc.) generated for motion detection or other purposes. In examples, motion detection may be carried out by analyzing one or more training fields carried by the wireless signals or by analyzing other data carried by the signal. In some examples data will be added for the express purpose of motion detection or the data used will nominally be for another purpose and reused or repurposed for motion detection. In some examples, the wireless signals propagate through an object (e.g., a wall) before or after interacting with a moving object, which may allow the moving object's movement to be detected without an optical line-of-sight between the moving object and the transmission or receiving hardware. Based on the received signals, wireless communication device 102C may generate motion detection data. In some instances, wireless communication device 102C may communicate the motion detection data to another device or system, such as a security system, which may include a control center for monitoring movement within a space, such as a room, building, outdoor area, etc.

In some implementations, wireless communication devices 102A, 102B can be modified to transmit motion probe signals (which may include, e.g., a reference signal, beacon signal, or another signal used to probe a space for motion) on a separate wireless communication channel (e.g., a frequency channel or coded channel) from wireless network traffic signals. For example, the modulation applied to the payload of a motion probe signal and the type of data or data structure in the payload may be known by wireless communication device 102C, which may reduce the amount of processing that wireless communication device 102C performs for motion sensing. The header may include additional information such as, for example, an indication of whether motion was detected by another device in communication system 100, an indication of the modulation type, an identification of the device transmitting the signal, etc.

In the example shown in FIG. 1, wireless communication system 100 is a wireless mesh network, with wireless communication links between each of wireless communication devices 102. In the example shown, the wireless communication link between wireless communication device 102C and wireless communication device 102A can be used to probe motion detection field 110A, the wireless communication link between wireless communication device 102C and wireless communication device 102B can be used to probe motion detection field 110B, and the wireless communication link between wireless communication device 102A and wireless communication device 102B can be used to probe motion detection field 110C. In some instances, each wireless communication device 102 detects motion in motion detection fields 110 accessed by that device by processing received signals that are based on wireless signals transmitted by wireless communication devices 102 through motion detection fields 110. For example, when person 106 shown in FIG. 1 moves in motion detection field 110A and motion detection field 110C, wireless communication devices 102 may detect the motion based on signals they received that are based on wireless signals transmitted through respective motion detection fields 110. For instance, wireless communication device 102A can detect motion of person 106 in motion detection fields 110A, 110C, wireless communication device 102B can detect motion of person 106 in motion detection field 110C, and wireless communication device 102C can detect motion of person 106 in motion detection field 110A.

In some instances, motion detection fields 110 can include, for example, air, solid materials, liquids, or another medium through which wireless electromagnetic signals may propagate. In the example shown in FIG. 1, motion detection field 110A provides a wireless communication channel between wireless communication device 102A and wireless communication device 102C, motion detection field 110B provides a wireless communication channel between wireless communication device 102B and wireless communication device 102C, and motion detection field 110C provides a wireless communication channel between wireless communication device 102A and wireless communication device 102B. In some aspects of operation, wireless signals transmitted on a wireless communication channel (separate from or shared with the wireless communication channel for network traffic) are used to detect movement of an object in a space. The objects can be any type of static or moveable object and can be living or inanimate. For example, the object can be a human (e.g., person 106 shown in FIG. 1), an animal, an inorganic object, or another device, apparatus, or assembly, an object that defines all or part of the boundary of a space (e.g., a wall, door, window, etc.), or another type of object. In some implementations, motion information from the wireless communication devices may be analyzed to determine a location of the detected motion. For example, as described further below, one of wireless communication devices 102 (or another device communicably coupled to wireless communications devices 102) may determine that the detected motion is nearby a particular wireless communication device.

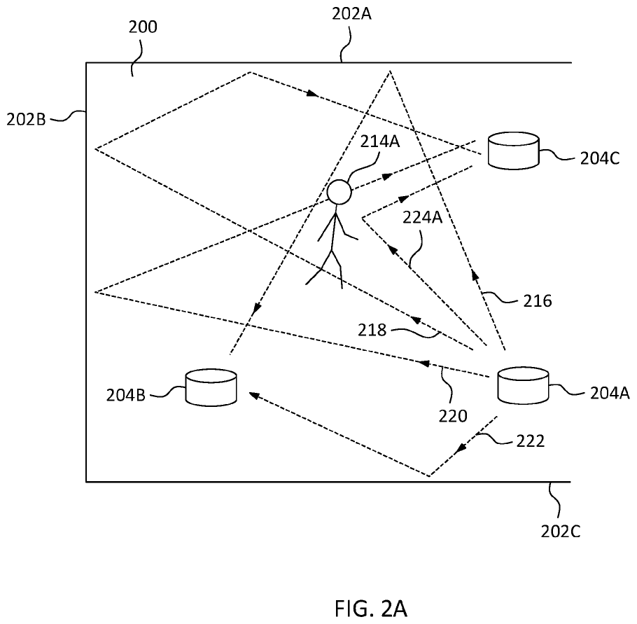

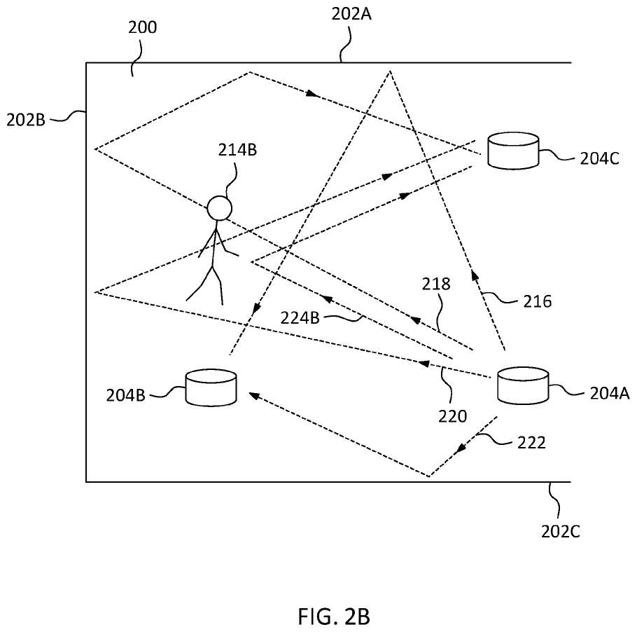

FIG. 2A and FIG. 2B are diagrams showing example wireless signals communicated between wireless communication devices 204A, 204B, 204C. Wireless communication devices 204A, 204B, 204C can be, for example, wireless communication devices 102A, 102B, 102C shown in FIG. 1, or other types of wireless communication devices. Wireless communication devices 204A, 204B, 204C transmit wireless signals through space 200. Space 200 can be completely or partially enclosed or open at one or more boundaries. In an example, space 200 may be a sensing space. Space 200 can be or can include an interior of a room, multiple rooms, a building, an indoor area, outdoor area, or the like. First wall 202A, second wall 202B, and third wall 202C at least partially enclose space 200 in the example shown.

In the example shown in FIG. 2A and FIG. 2B, wireless communication device 204A is operable to transmit wireless signals repeatedly (e.g., periodically, intermittently, at scheduled, unscheduled or random intervals, etc.). Wireless communication devices 204B, 204C are operable to receive signals based on those transmitted by wireless communication device 204A. Wireless communication devices 204B, 204C each have a modem (e.g., modem 112 shown in FIG. 1) that is configured to process received signals to detect motion of an object in space 200.

As shown, an object is in first position 214A in FIG. 2A, and the object has moved to second position 214B in FIG. 2B. In FIG. 2A and FIG. 2B, the moving object in space 200 is represented as a human, but the moving object can be another type of object. For example, the moving object can be an animal, an inorganic object (e.g., a system, device, apparatus, or assembly), an object that defines all or part of the boundary of space 200 (e.g., a wall, door, window, etc.), or another type of object.

As shown in FIG. 2A and FIG. 2B, multiple example paths of the wireless signals transmitted from wireless communication device 204A are illustrated by dashed lines. Along first signal path 216, the wireless signal is transmitted from wireless communication device 204A and reflected off first wall 202A toward the wireless communication device 204B. Along second signal path 218, the wireless signal is transmitted from the wireless communication device 204A and reflected off second wall 202B and first wall 202A toward wireless communication device 204C. Along third signal path 220, the wireless signal is transmitted from the wireless communication device 204A and reflected off second wall 202B toward wireless communication device 204C. Along fourth signal path 222, the wireless signal is transmitted from the wireless communication device 204A and reflected off third wall 202C toward the wireless communication device 204B.

In FIG. 2A, along fifth signal path 224A, the wireless signal is transmitted from wireless communication device 204A and reflected off the object at first position 214A toward wireless communication device 204C. Between FIG. 2A and FIG. 2B, a surface of the object moves from first position 214A to second position 214B in space 200 (e.g., some distance away from first position 214A). In FIG. 2B, along sixth signal path 224B, the wireless signal is transmitted from wireless communication device 204A and reflected off the object at second position 214B toward wireless communication device 204C. Sixth signal path 224B depicted in FIG. 2B is longer than fifth signal path 224A depicted in FIG. 2A due to the movement of the object from first position 214A to second position 214B. In some examples, a signal path can be added, removed, or otherwise modified due to movement of an object in a space.

The example wireless signals shown in FIG. 2A and FIG. 2B may experience attenuation, frequency shifts, phase shifts, or other effects through their respective paths and may have portions that propagate in another direction, for example, through the first, second and third walls 202A, 202B, and 202C. In some examples, the wireless signals are radio frequency (RF) signals. The wireless signals may include other types of signals.

In the example shown in FIG. 2A and FIG. 2B, wireless communication device 204A can repeatedly transmit a wireless signal. In particular, FIG. 2A shows the wireless signal being transmitted from wireless communication device 204A at a first time, and FIG. 2B shows the same wireless signal being transmitted from wireless communication device 204A at a second, later time. The transmitted signal can be transmitted continuously, periodically, at random or intermittent times or the like, or a combination thereof. The transmitted signal can have a number of frequency components in a frequency bandwidth. The transmitted signal can be transmitted from wireless communication device 204A in an omnidirectional manner, in a directional manner or otherwise. In the example shown, the wireless signals traverse multiple respective paths in space 200, and the signal along each path may become attenuated due to path losses, scattering, reflection, or the like and may have a phase or frequency offset.

As shown in FIG. 2A and FIG. 2B, the signals from first to sixth paths 216, 218, 220, 222, 224A, and 224B combine at wireless communication device 204C and wireless communication device 204B to form received signals. Because of the effects of the multiple paths in space 200 on the transmitted signal, space 200 may be represented as a transfer function (e.g., a filter) in which the transmitted signal is input and the received signal is output. When an object moves in space 200, the attenuation or phase offset affected upon a signal in a signal path can change, and hence, the transfer function of space 200 can change. Assuming the same wireless signal is transmitted from wireless communication device 204A, if the transfer function of space 200 changes, the output of that transfer function—the received signal—will also change. A change in the received signal can be used to detect movement of an object.

Mathematically, a transmitted signal f(t) transmitted from the first wireless communication device 204A may be described according to Equation (1):

$$f ( t ) = {\sum }_{n = - ∞}^{∞} {c}_{n} {e}^{j {ω}_{n} t} \qquad ( 1 )$$

Where ωₙ represents the frequency of nth frequency component of the transmitted signal, cₙ represents the complex coefficient of the nth frequency component, and t represents time. With the f(t) being transmitted from the first wireless communication device 204A, an output signal rₖ(t) from a path, k, may be described according to Equation (2):

$${r}_{k} ( t ) = {\sum }_{n = - ∞}^{∞} {α}_{n , k} {c}_{n} {e}^{j ( {ω}_{n} t + {ϕ}_{n , k} )} \qquad ( 2 )$$

Where α_{n,k} represents an attenuation factor (or channel response; e.g., due to scattering, reflection, and path losses) for the nth frequency component along k, and φ_{n,k} represents the phase of the signal for nth frequency component along k. Then, the received signal, R, at a wireless communication device can be described as the summation of all output signals rₖ(t) from all paths to the wireless communication device, which is shown in Equation (3):

$$R = {\sum }_{k} {r}_{k} ( t ) \qquad ( 3 )$$

Substituting Equation (2) into Equation (3) renders the following Equation (4):

$$R = {\sum }_{k} {\sum }_{n = - ∞}^{∞} ( {α}_{n , k} {e}^{j {ϕ}_{n , k}} ) {c}_{n} {e}^{j {ω}_{n} t} \qquad ( 4 )$$

R at a wireless communication device can then be analyzed. R at a wireless communication device can be transformed to the frequency domain, for example, using a fast Fourier transform (FFT) or another type of algorithm. The transformed signal can represent R as a series of n complex values, one for each of the respective frequency components (at the n frequencies ωₙ). For a frequency component at frequency ωₙ, a complex value, Hₙ, may be represented as follows in Equation (5):

$${H}_{n} = {\sum }_{k} {c}_{n} {α}_{n , k} {e}^{j {ϕ}_{n , k}} \qquad ( 5 )$$

Hₙ for a given ωₙ indicates a relative magnitude and phase offset of the received signal at ωₙ. When an object moves in the space, Hₙ changes due to α_{n,k} of the space changing. Accordingly, a change detected in the channel response can be indicative of movement of an object within the communication channel. In some instances, noise, interference, or other phenomena can influence the channel response detected by the receiver, and the motion detection system can reduce or isolate such influences to improve the accuracy and quality of motion detection capabilities. In some implementations, the overall channel response can be represented as follows in Equation (6):

$${h}_{c h} = {\sum }_{k} {\sum }_{n = - ∞}^{∞} {α}_{n , k} \qquad ( 6 )$$

In some instances, the channel response, h_{ch}, for a space can be determined, for example, based on the mathematical theory of estimation. For instance, a reference signal, R_{ef}, can be modified with candidate h_{ch}, and then a maximum likelihood approach can be used to select the candidate channel which gives best match to the received signal (R_{cvd}). In some cases, an estimated received signal (\hat{R}_{cvd}) is obtained from the convolution of R_{ef} with the candidate h_{ch}, and then the channel coefficients of h_{ch} are varied to minimize the squared error of \hat{R}_{cvd}. This can be mathematically illustrated as follows in Equation (7):

$${R}_{cvd} = {R}_{e f} ⊗ {h}_{c h} = {\sum }_{k = - m}^{m} {R}_{e f} ( n - k ) {h}_{c h} ( k ) \qquad ( 7 )$$

with the optimization criterion as in Equation (8):

$${min}_{{h}_{c h}} \{ \sum {( {\hat{R}}_{cvd} - {R}_{cvd} )}^{2} \} \qquad ( 8 )$$

The minimizing, or optimizing, process can utilize an adaptive filtering technique, such as least mean squares (LMS), recursive least squares (RLS), batch least squares (BLS), etc. The channel response can be a finite impulse response (FIR) filter, infinite impulse response (IIR) filter, or the like. As shown in the equation above, the received signal can be considered as a convolution of the reference signal and the channel response. The convolution operation means that the channel coefficients possess a degree of correlation with each of the delayed replicas of the reference signal. The convolution operation as shown in the equation above, therefore shows that the received signal appears at different delay points, each delayed replica being weighted by the channel coefficient.

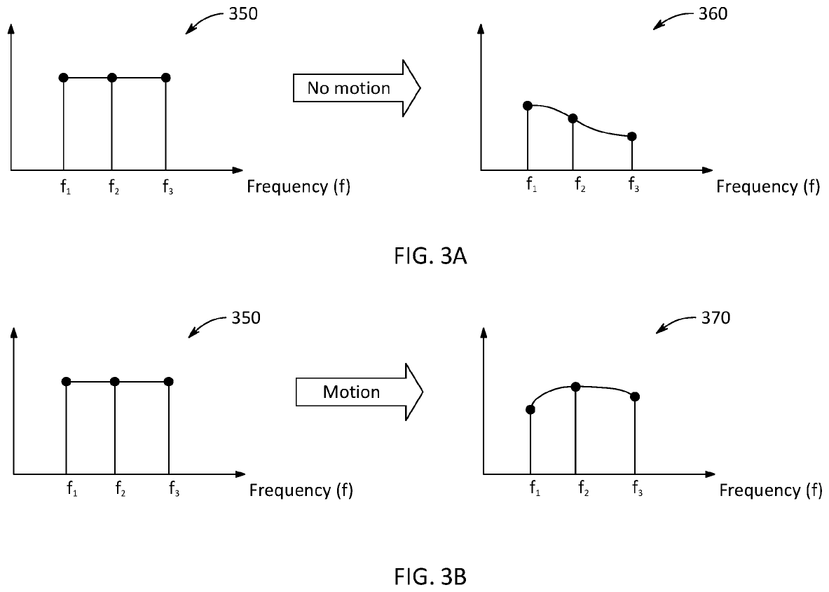

FIG. 3A and FIG. 3B are plots showing examples of channel responses 360, 370 computed from the wireless signals communicated between wireless communication devices 204A, 204B, 204C in FIG. 2A and FIG. 2B. FIG. 3A and FIG. 3B also show frequency domain representation 350 of an initial wireless signal transmitted by wireless communication device 204A. In the examples shown, channel response 360 in FIG. 3A represents the signals received by wireless communication device 204B when there is no motion in space 200, and channel response 370 in FIG. 3B represents the signals received by wireless communication device 204B in FIG. 2B after the object has moved in space 200.

In the example shown in FIG. 3A and FIG. 3B, for illustration purposes, wireless communication device 204A transmits a signal that has a flat frequency profile (the magnitude of each frequency component, f₁, f₂ and f₃ is the same), as shown in frequency domain representation 350. Because of the interaction of the signal with space 200 (and the objects therein), the signals received at wireless communication device 204B that are based on the signal sent from wireless communication device 204A are different from the transmitted signal. In this example, where the transmitted signal has a flat frequency profile, the received signal represents the channel response of space 200. As shown in FIG. 3A and FIG. 3B, channel responses 360, 370 are different from frequency domain representation 350 of the transmitted signal. When motion occurs in space 200, a variation in the channel response will also occur. For example, as shown in FIG. 3B, channel response 370 that is associated with motion of object in space 200 varies from channel response 360 that is associated with no motion in space 200.

Furthermore, as an object moves within space 200, the channel response may vary from channel response 370. In some cases, space 200 can be divided into distinct regions and the channel responses associated with each region may share one or more characteristics (e.g., shape), as described below. Thus, motion of an object within different distinct regions can be distinguished, and the location of detected motion can be determined based on an analysis of channel responses.

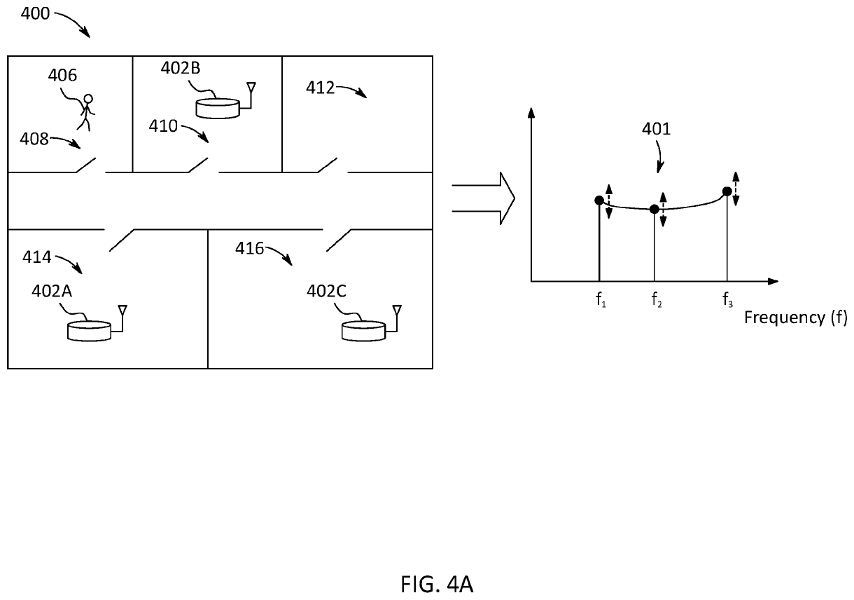

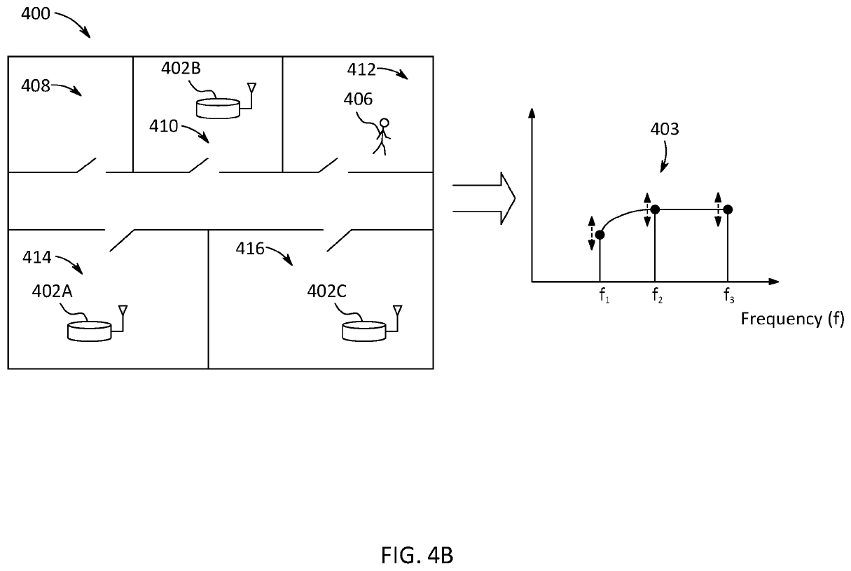

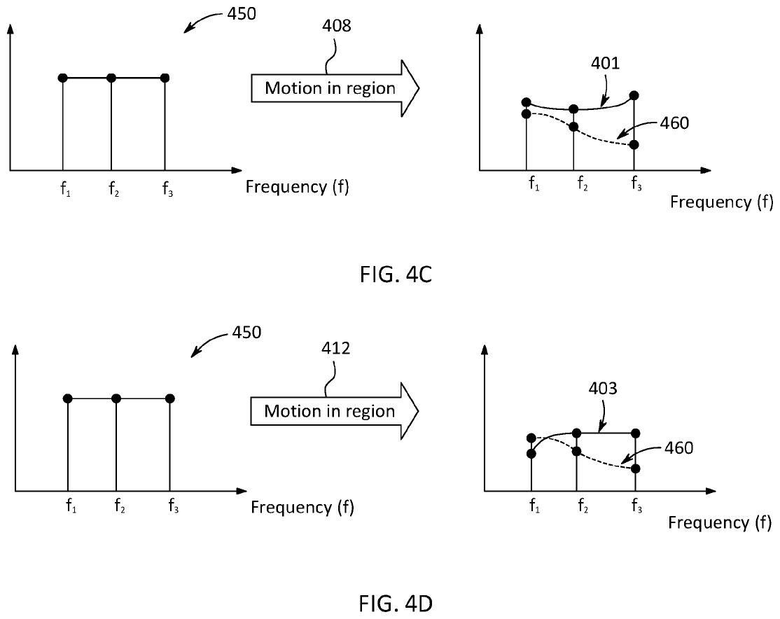

FIG. 4A and FIG. 4B are diagrams showing example channel responses 401, 403 associated with motion of object 406 in distinct regions 408, 412 of space 400. In the examples shown, space 400 is a building, and space 400 is divided into a plurality of distinct regions-first region 408, second region 410, third region 412, fourth region 414, and fifth region 416. Space 400 may include additional or fewer regions, in some instances. As shown in FIG. 4A and FIG. 4B, the regions within space 400 may be defined by walls between rooms. In addition, the regions may be defined by ceilings between floors of a building. For example, space 400 may include additional floors with additional rooms. In addition, in some instances, the plurality of regions of a space can be or include a number of floors in a multistory building, a number of rooms in the building, or a number of rooms on a particular floor of the building. In the example shown in FIG. 4A, an object located in first region 408 is represented as person 406, but the moving object can be another type of object, such as an animal or an inorganic object.

In the example shown, wireless communication device 402A is located in fourth region 414 of space 400, wireless communication device 402B is located in second region 410 of space 400, and wireless communication device 402C is located in fifth region 416 of space 400. Wireless communication devices 402 can operate in the same or similar manner as wireless communication devices 102 of FIG. 1. For instance, wireless communication devices 402 may be configured to transmit and receive wireless signals and detect whether motion has occurred in space 400 based on the received signals. As an example, wireless communication devices 402 may periodically or repeatedly transmit motion probe signals through space 400, and receive signals based on the motion probe signals. Wireless communication devices 402 can analyze the received signals to detect whether an object has moved in space 400, such as, for example, by analyzing channel responses associated with space 400 based on the received signals. In addition, in some implementations, wireless communication devices 402 can analyze the received signals to identify a location of detected motion within space 400. For example, wireless communication devices 402 can analyze characteristics of the channel response to determine whether the channel responses share the same or similar characteristics to channel responses known to be associated with first to fifth regions 408, 410, 412, 414, 416 of space 400.

In the examples shown, one (or more) of wireless communication devices 402 repeatedly transmits a motion probe signal (e.g., a reference signal) through space 400. The motion probe signals may have a flat frequency profile in some instances, wherein the magnitude of f₁, f₂ and f₃ is the same or nearly the same. For example, the motion probe signals may have a frequency response similar to frequency domain representation 350 shown in FIG. 3A and FIG. 3B. The motion probe signals may have a different frequency profile in some instances. Because of the interaction of the reference signal with space 400 (and the objects therein), the signals received at another wireless communication device 402 that are based on the motion probe signal transmitted from the other wireless communication device 402 are different from the transmitted reference signal.

Based on the received signals, wireless communication devices 402 can determine a channel response for space 400. When motion occurs in distinct regions within the space, distinct characteristics may be seen in the channel responses. For example, while the channel responses may differ slightly for motion within the same region of space 400, the channel responses associated with motion in distinct regions may generally share the same shape or other characteristics. For instance, channel response 401 of FIG. 4A represents an example channel response associated with motion of object 406 in first region 408 of space 400, while channel response 403 of FIG. 4B represents an example channel response associated with motion of object 406 in third region 412 of space 400. Channel responses 401, 403 are associated with signals received by the same wireless communication device 402 in space 400.

FIG. 4C and FIG. 4D are plots showing channel responses 401, 403 of FIG. 4A and FIG. 4B overlaid on channel response 460 associated with no motion occurring in space 400. In the example shown, wireless communication device 402 transmits a motion probe signal that has a flat frequency profile as shown in frequency domain representation 450. When motion occurs in space 400, a variation in the channel response will occur relative to channel response 460 associated with no motion, and thus, motion of an object in space 400 can be detected by analyzing variations in the channel responses. In addition, a relative location of the detected motion within space 400 can be identified. For example, the shape of channel responses associated with motion can be compared with reference information (e.g., using a trained artificial intelligence (AI) model) to categorize the motion as having occurred within a distinct region of space 400.

When there is no motion in space 400 (e.g., when object 406 is not present), wireless communication device 402 may compute channel response 460 associated with no motion. Slight variations may occur in the channel response due to a number of factors; however, multiple channel responses 460 associated with different periods of time may share one or more characteristics. In the example shown, channel response 460 associated with no motion has a decreasing frequency profile (the magnitude of each of f₁, f₂ and f₃ is less than the previous). The profile of channel response 460 may differ in some instances (e.g., based on different room layouts or placement of wireless communication devices 402).

When motion occurs in space 400, a variation in the channel response will occur. For instance, in the examples shown in FIG. 4C and FIG. 4D, channel response 401 associated with motion of object 406 in first region 408 differs from channel response 460 associated with no motion and channel response 403 associated with motion of object 406 in third region 412 differs from channel response 460 associated with no motion. Channel response 401 has a concave-parabolic frequency profile (the magnitude of the middle frequency component, f₂, is less than the outer frequency components f₁ and f₃), while channel response 403 has a convex-asymptotic frequency profile (the magnitude of the middle frequency component f₂ is greater than the outer frequency components, f₁ and f₃). The profiles of channel responses 401, 403 may differ in some instances (e.g., based on different room layouts or placement of the wireless communication devices 402).

Analyzing channel responses may be considered similar to analyzing a digital filter. A channel response may be formed through the reflections of objects in a space as well as reflections created by a moving or static human. When a reflector (e.g., a human) moves, it changes the channel response. This may translate to a change in equivalent taps of a digital filter, which can be thought of as having poles and zeros (poles amplify the frequency components of a channel response and appear as peaks or high points in the response, while zeros attenuate the frequency components of a channel response and appear as troughs, low points, or nulls in the response). A changing digital filter can be characterized by the locations of its peaks and troughs, and a channel response may be characterized similarly by its peaks and troughs. For example, in some implementations, analyzing nulls and peaks in the frequency components of a channel response (e.g., by marking their location on the frequency axis and their magnitude), motion can be detected.

In some implementations, a time series aggregation can be used to detect motion. A time series aggregation may be performed by observing the features of a channel response over a moving window and aggregating the windowed result by using statistical measures (e.g., mean, variance, principal components, etc.). During instances of motion, the characteristic digital-filter features would be displaced in location and flip-flop between some values due to the continuous change in the scattering scene. That is, an equivalent digital filter exhibits a range of values for its peaks and nulls (due to the motion). By looking this range of values, unique profiles (in examples profiles may also be referred to as signatures) may be identified for distinct regions within a space.

In some implementations, an AI model may be used to process data. AI models may be of a variety of types, for example linear regression models, logistic regression models, linear discriminant analysis models, decision tree models, naïve bayes models, K-nearest neighbors models, learning vector quantization models, support vector machines, bagging and random forest models, and deep neural networks. In general, all AI models aim to learn a function which provides the most precise correlation between input values and output values and are trained using historic sets of inputs and outputs that are known to be correlated. In examples, artificial intelligence may also be referred to as machine learning.

In some implementations, the profiles of the channel responses associated with motion in distinct regions of space 400 can be learned. For example, machine learning may be used to categorize channel response characteristics with motion of an object within distinct regions of a space. In some cases, a user associated with wireless communication devices 402 (e.g., an owner or other occupier of space 400) can assist with the learning process. For instance, referring to the examples shown in FIG. 4A and FIG. 4B, the user can move in each of first to fifth regions 408, 410, 412, 414, 416 during a learning phase and may indicate (e.g., through a user interface on a mobile computing device) that he/she is moving in one of the particular regions in space 400. For example, while the user is moving through first region 408 (e.g., as shown in FIG. 4A) the user may indicate on a mobile computing device that he/she is in first region 408 (and may name the region as “bedroom”, “living room”, “kitchen”, or another type of room of a building, as appropriate). Channel responses may be obtained as the user moves through the region, and the channel responses may be “tagged” with the user's indicated location (region). The user may repeat the same process for the other regions of space 400. The term “tagged” as used herein may refer to marking and identifying channel responses with the user's indicated location or any other information.

The tagged channel responses can then be processed (e.g., by machine learning software) to identify unique characteristics of the channel responses associated with motion in the distinct regions. Once identified, the identified unique characteristics may be used to determine a location of detected motion for newly computed channel responses. For example, an AI model may be trained using the tagged channel responses, and once trained, newly computed channel responses can be input to the AI model, and the AI model can output a location of the detected motion. For example, in some cases, mean, range, and absolute values are input to an AI model. In some instances, magnitude and phase of the complex channel response itself may be input as well. These values allow the AI model to design arbitrary front-end filters to pick up the features that are most relevant to making accurate predictions with respect to motion in distinct regions of a space. In some implementations, the AI model is trained by performing a stochastic gradient descent. For instance, channel response variations that are most active during a certain zone may be monitored during the training, and the specific channel variations may be weighted heavily (by training and adapting the weights in the first layer to correlate with those shapes, trends, etc.). The weighted channel variations may be used to create a metric that activates when a user is present in a certain region.

For extracted features like channel response nulls and peaks, a time-series (of the nulls/peaks) may be created using an aggregation within a moving window, taking a snapshot of few features in the past and present, and using that aggregated value as input to the network. Thus, the network, while adapting its weights, will be trying to aggregate values in a certain region to cluster them, which can be done by creating a logistic classifier based decision surfaces. The decision surfaces divide different clusters and subsequent layers can form categories based on a single cluster or a combination of clusters.

In some implementations, an AI model includes two or more layers of inference. The first layer acts as a logistic classifier which can divide different concentrations of values into separate clusters, while the second layer combines some of these clusters together to create a category for a distinct region. Additionally, subsequent layers can help in extending the distinct regions over more than two categories of clusters. For example, a fully connected AI model may include an input layer corresponding to the number of features tracked, a middle layer corresponding to the number of effective clusters (through iterating between choices), and a final layer corresponding to different regions. Where complete channel response information is input to the AI model, the first layer may act as a shape filter that can correlate certain shapes. Thus, the first layer may lock to a certain shape, the second layer may generate a measure of variation happening in those shapes, and third and subsequent layers may create a combination of those variations and map them to different regions within the space. The output of different layers may then be combined through a fusing layer.

### B. Wi-Fi Sensing System Example Methods and Apparatus

Section B describes systems and methods that are useful for a wireless sensing system configurated to send sensing transmissions and make sensing measurements.

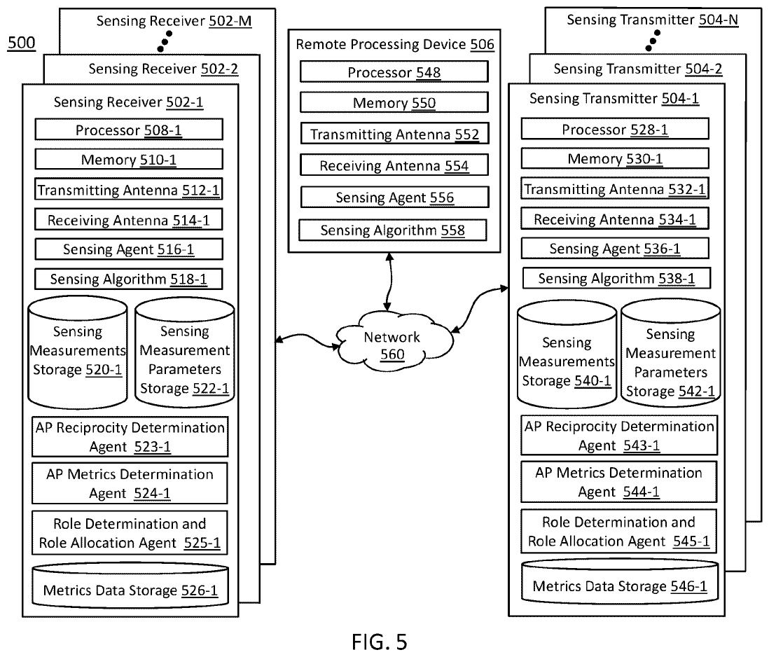

FIG. 5 depicts an implementation of some of an architecture of an implementation of system 500 for Wi-Fi sensing, according to some embodiments.

System 500 may include a plurality of networking devices. In an example, system 500 may include plurality of sensing receivers 502-(1-M), plurality of sensing transmitters 504-(1-N), remote processing device 506, and network 560 enabling communication between the system components for information exchange. In an example implementation, plurality of sensing receivers 502-(1-M) may include at least first sensing receiver 502-1 and second sensing receiver 502-2. In an example implementation, plurality of sensing transmitters 504-(1-N) may include at least first sensing transmitter 504-1 and second sensing transmitter 504-2. System 500 may be an example or instance of wireless communication system 100 and network 560 may be an example or instance of wireless network or cellular network, details of which are provided with reference to FIG. 1 and its accompanying description.

According to an embodiment, plurality of sensing receivers 502-(1-M) may be configured to receive one or more sensing transmissions (for example, from one or more of plurality of sensing transmitters 504-(1-N)) and perform one or more measurements (for example, channel representation information (CRI) measurements such as channel state information (CSI) or time domain channel representation information (TD-CRI)) useful for Wi-Fi sensing. In examples, these measurements may be known as sensing measurements. Sensing measurements may be processed to achieve a sensing goal of system 500. In an embodiment, one or more of plurality of sensing receivers 502-(1-M) may be an AP. In some embodiments, one or more of plurality of sensing receivers 502-(1-M) may take a role of sensing initiator and/or sensing responder.

According to an implementation, one or more of plurality of sensing receivers 502-(1-M) may be implemented by a device, such as wireless communication device 102 shown in FIG. 1. In some implementations, one or more of plurality of sensing receivers 502-(1-M) may be implemented by a device, such as wireless communication device 204 shown in FIG. 2A and FIG. 2B. Further, one or more of plurality of sensing receivers 502-(1-M) may be implemented by a device, such as wireless communication device 402 shown in FIG. 4A and FIG. 4B. In an implementation, one or more of plurality of sensing receivers 502-(1-M) may coordinate and control communication among plurality of sensing transmitters 504-(1-N). According to an implementation, one or more of plurality of sensing receivers 502-(1-M) may be enabled to control a sensing measurement session comprising one or more sensing measurement instances to ensure that required sensing transmissions are made at required times and to ensure an accurate determination of one or more sensing measurements. The terms ‘sensing measurement instance’ and ‘sensing measurement exchange’ may be used interchangeably with no loss of generality or functionality. In some embodiments, one or more of plurality of sensing receivers 502-(1-M) may process sensing measurements to achieve the sensing goal of system 500. In some embodiments, one or more of plurality of sensing receivers 502-(1-M) may be configured to transmit sensing measurements to one or more of plurality of sensing transmitters 504-(1-N), and one or more of plurality of sensing transmitters 504-(1-N) may be configured to process the sensing measurements to achieve a sensing result of system 500.

In an embodiment, one or more of plurality of sensing receivers 502-(1-M) may be a STA. In an embodiment, one or more of plurality of sensing receivers 502-(1-M) may be an AP. In some embodiments, one or more of plurality of sensing receivers 502-(1-M) may be configured to transmit sensing measurements to remote processing device 506, and remote processing device 506 may be configured to process sensing measurements to achieve the sensing goal of system 500. In some embodiments, first sensing receiver 502-1 may be any computing device, such as a desktop computer, a laptop, a tablet computer, a mobile device, a personal digital assistant (PDA), or any other computing device.

Referring again to FIG. 5, in some embodiments, one or more of plurality of sensing transmitters 504-(1-N) may be configured to send one or more sensing transmissions to one or more of plurality of sensing receivers 502-(1-M) based on which one or more sensing measurements may be performed for Wi-Fi sensing. In an embodiment, one or more of plurality of sensing transmitters 504-(1-N) may be a STA. In an embodiment, one or more of plurality of sensing transmitters 504-(1-N) may be an AP. In some embodiments, one or more of plurality of sensing transmitters 504-(1-N) may take a role of sensing initiator and/or sensing responder.

According to an implementation, one or more of plurality of sensing transmitters 504-(1-N) may be implemented by a device, such as wireless communication device 102 shown in FIG. 1. In some implementations, one or more of plurality of sensing transmitters 504-(1-N) may be implemented by a device, such as wireless communication device 204 shown in FIG. 2A and FIG. 2B. Further, one or more of plurality of sensing transmitters 504-(1-N) may be implemented by a device, such as wireless communication device 402 shown in FIG. 4A and FIG. 4B. In some embodiments, first sensing transmitter 504-1 may be any computing device, such as a desktop computer, a laptop, a tablet computer, a mobile device, a PDA, or any other computing device. In some implementations, communication between one or more of plurality of sensing receivers 502-(1-M) and one or more of plurality of sensing transmitters 504-(1-N) may happen via station management entity (SME) and MAC layer management entity (MLME) protocols.

In some embodiments, remote processing device 506 may be configured to receive sensing measurements from one or more of plurality of sensing receivers 502-(1-M) and process the sensing measurements. In an example, remote processing device 506 may process and analyze sensing measurements to identify one or more features of interest. According to some implementations, remote processing device 506 may include/execute a sensing algorithm. In an embodiment, remote processing device 506 may be a STA. In some embodiments, remote processing device 506 may be an AP. According to an implementation, remote processing device 506 may be implemented by a device, such as wireless communication device 102 shown in FIG. 1. In some implementations, remote processing device 506 may be implemented by a device, such as wireless communication device 204 shown in FIG. 2A and FIG. 2B. Further, remote processing device 506 may be implemented by a device, such as wireless communication device 402 shown in FIG. 4A and FIG. 4B. In some embodiments, remote processing device 506 may be any computing device, such as a desktop computer, a laptop, a tablet computer, a mobile device, a personal digital assistant (PDA) or any other computing device. In embodiments, remote processing device 506 may take a role of sensing initiator where a sensing algorithm determines a Wi-Fi sensing session and the sensing measurements required to fulfill the measurement campaign. In an example, remote processing device 506 may communicate sensing measurement parameters and/or transmission parameters required to initiate a Wi-Fi sensing session to one or more of plurality of sensing receivers 502-(1-M) and/or to one or more of plurality of sensing transmitters 504-(1-N) to coordinate and control sensing transmissions for performing sensing measurements.

Referring to FIG. 5 in more detail, sensing receiver 502-1 (which is an example of one or more of plurality of sensing receivers 502-(1-M)) may include processor 508-1 and memory 510-1. For example, processor 508-1 and memory 510-1 of sensing receiver 502-1 may be processor 114 and memory 116, respectively, as shown in FIG. 1. In an embodiment, sensing receiver 502-1 may further include transmitting antenna(s) 512-1, receiving antenna(s) 514-1, and sensing agent 516-1. In some embodiments, an antenna may be used to both transmit and receive signals in a half-duplex format. When the antenna is transmitting, it may be referred to as transmitting antenna 512-1, and when the antenna is receiving, it may be referred to as receiving antenna 514-1. It is understood by a person of normal skill in the art that the same antenna may be transmitting antenna 512-1 in some instances and receiving antenna 514-1 in other instances. In the case of an antenna array, one or more antenna elements may be used to transmit or receive a signal, for example, in a beamforming environment. In some examples, a group of antenna elements used to transmit a composite signal may be referred to as transmitting antenna 512-1, and a group of antenna elements used to receive a composite signal may be referred to as receiving antenna 514-1. In some examples, each antenna is equipped with its own transmission and receive paths, which may be alternately switched to connect to the antenna depending on whether the antenna is operating as transmitting antenna 512-1 or receiving antenna 514-1.

In an implementation, sensing agent 516-1 may be responsible for causing sensing receiver 502-1 to receive sensing transmissions and associated sensing measurement parameters and/or transmission parameters, to calculate sensing measurements. In examples, sensing agent 516-1 may be responsible for processing sensing measurements to fulfill a sensing goal. In some implementations, receiving sensing transmissions and optionally associated sensing measurement parameters and/or transmission parameters, and calculating sensing measurements may be carried out by sensing agent 516-1 running in the medium access control (MAC) layer of sensing receiver 502-1 and processing sensing measurements to fulfill a sensing goal may be carried out by an algorithm running in the application layer of sensing receiver 502-1, for example sensing algorithm 518-1. In examples, a sensing algorithm 518-1 running in the application layer of sensing receiver 502-1 may be known as a Wi-Fi sensing agent, a sensing application, or sensing algorithm. In examples, sensing algorithm 518-1 may include and/or execute sensing agent 516-1. According to some implementations, sensing agent 516-1 may include and/or execute sensing algorithm 518-1. In some implementations, sensing agent 516-1 running in the MAC layer of sensing receiver 502-1 and sensing algorithm 518-1 running in the application layer of sensing receiver 502-1 may run separately on processor 508-1. In an implementation, sensing agent 516-1 may pass one or more of sensing measurement parameters, transmission parameters, or physical layer parameters (e.g., such as channel representation information, examples of which are CSI and TD-CRI) between the MAC layer of sensing receiver 502-1 and the application layer of sensing receiver 502-1. In an example, sensing agent 516-1 in the MAC layer or sensing algorithm 518-1 in the application layer may operate on physical layer parameters, for example, to detect one or more features of interest. In examples, sensing algorithm 518-1 may form services or features, which may be presented to an end-user. According to an implementation, communication between the MAC layer of sensing receiver 502-1 and other layers or components of sensing receiver 502-1 (including the application layer) may take place based on communication interfaces, such as an MLME interface and a data interface. In examples, sensing agent 516-1 may be configured to determine a number and timing of sensing transmissions and sensing measurements for the purpose of Wi-Fi sensing. In some implementations, sensing agent 516-1 may be configured to transmit sensing measurements to plurality of sensing transmitters 504-(1-N) and/or remote processing device 506 for further processing. In an implementation, sensing agent 516-1 may be configured to cause at least one transmitting antenna of transmitting antenna(s) 512-1 to transmit messages to one or more of plurality of sensing transmitters 504-(1-N) or to remote processing device 506. Further, sensing agent 516-1 may be configured to receive, via at least one receiving antenna of receiving antennas(s) 514-1, messages from one or more of plurality of sensing transmitters 504-(1-N) or from remote processing device 506. In an example, sensing agent 516-1 may be configured to make sensing measurements based on sensing transmissions received from one or more of plurality of sensing transmitters 504-(1-N).

In some embodiments, sensing receiver 502-1 may include sensing measurements storage 520-1. In an implementation, sensing measurements storage 520-1 may store sensing measurements computed by sensing receiver 502-1 based on received sensing transmissions. In an example, sensing measurements stored in sensing measurements storage 520-1 may be periodically or dynamically updated as required. In some embodiments, sensing receiver 502-1 may include sensing measurement parameters storage 522-1. In an implementation, sensing measurement parameters storage 522-1 may store sensing measurement parameters and/or transmission parameters applicable to one or more sensing measurement setups. In an implementation, sensing measurement parameters storage 522-1 may store sensing measurement parameters and/or transmission parameters applicable to one or more sensing measurement sessions. In an implementation, sensing measurement parameters storage 522-1 may store sensing measurement parameters and/or transmission parameters applicable to one or more sensing measurement instances. In an example, sensing measurement parameters and/or transmission parameters stored in sensing measurement parameters storage 522-1 may be periodically or dynamically updated as required. In an implementation, sensing measurements storage 520-1 and sensing measurement parameters storage 522-1 may include any type or form of storage, such as a database or a file system or coupled to memory 510-1.

In an implementation, sensing receiver 502-1 may include AP reciprocity determination agent 523-1, AP metrics determination agent 524-1, and role determination and role allocation agent 525-1. In an implementation, AP reciprocity determination agent 523-1, AP metrics determination agent 524-1, and role determination and role allocation agent 525-1 may be coupled to processor 508-1 and memory 510-1. In some embodiments, AP reciprocity determination agent 523-1, AP metrics determination agent 524-1, and role determination and role allocation agent 525-1 amongst other units, may include routines, programs, objects, components, data structures, etc., which may perform particular tasks or implement particular abstract data types. AP reciprocity determination agent 523-1, AP metrics determination agent 524-1, and role determination and role allocation agent 525-1 may also be implemented as, signal processor(s), state machine(s), logic circuitries, and/or any other device or component that manipulates signals based on operational instructions.

In some embodiments, AP reciprocity determination agent 523-1, AP metrics determination agent 524-1, and role determination and role allocation agent 525-1 may be implemented in hardware, instructions executed by a processing unit, or by a combination thereof. The processing unit may comprise a computer, a processor, a state machine, a logic array or any other suitable devices capable of processing instructions. The processing unit may be a general-purpose processor that executes instructions to cause the general-purpose processor to perform the required tasks or the processing unit may be dedicated to performing the required functions. In some embodiments, AP reciprocity determination agent 523-1, AP metrics determination agent 524-1, and role determination and role allocation agent 525-1 may be machine-readable instructions that, when executed by a processor/processing unit, perform any of desired functionalities. The machine-readable instructions may be stored on an electronic memory device, hard disk, optical disk or other machine-readable storage medium or non-transitory medium. In an implementation, the machine-readable instructions may also be downloaded to the storage medium via a network connection. In an example, machine-readable instructions may be stored in memory 510-1.

In some embodiments, sensing receiver 502-1 may include metrics data storage 526-1. In an implementation, metrics data storage 526-1 may store information related to different metrics, such as an AP bandwidth metric, a computational metric, and an OTA metric. In examples, the AP bandwidth metric, the computational metric, and the OTA metric may be considered to determine an optimum sensing session setup for a backhaul link for optimum network performance. In an example, information stored in metrics data storage 526-1 may be periodically or dynamically updated as required. In an implementation, metrics data storage 526-1 may include any type or form of storage, such as a database or a file system or coupled to memory 510-1.

Referring again to FIG. 5, sensing transmitter 504-1 (which is an example of one or more of plurality of sensing transmitters 504-(1-N)) may include processor 528-1 and memory 530-1. For example, processor 528-1 and memory 530-1 of sensing transmitter 504-1 may be processor 114 and memory 116, respectively, as shown in FIG. 1. In an embodiment, sensing transmitter 504-1 may further include transmitting antenna(s) 532-1, receiving antenna(s) 534-1, and sensing agent 536-1.

Sensing agent 536-1 may be configured to cause at least one transmitting antenna of transmitting antenna(s) 532-1 and at least one receiving antenna of receiving antennas(s) 534-1 to exchange messages with one or more of plurality of sensing receivers 502-(1-M)) or with remote processing device 506. In some embodiments, an antenna may be used to both transmit and receive in a half-duplex format. When the antenna is transmitting, it may be referred to as transmitting antenna 532-1, and when the antenna is receiving, it may be referred to as receiving antenna 534-1. It is understood by a person of normal skill in the art that the same antenna may be transmitting antenna 532-1 in some instances and receiving antenna 534-1 in other instances. In the case of an antenna array, one or more antenna elements may be used to transmit or receive a signal, for example, in a beamforming environment. In some examples, a group of antenna elements used to transmit a composite signal may be referred to as transmitting antenna 532-1, and a group of antenna elements used to receive a composite signal may be referred to as receiving antenna 534-1. In some examples, each antenna is equipped with its own transmission and receive paths, which may be alternately switched to connect to the antenna depending on whether the antenna is operating as transmitting antenna 532-1 or receiving antenna 534-1.

In an implementation, sensing agent 536-1 may be responsible for causing sensing transmitter 504-1 to send sensing transmissions and/or, in examples, receive associated sensing measurements from one or more of plurality of sensing receivers 502-(1-M). In examples, sensing agent 536-1 may be responsible for processing sensing measurements to fulfill a sensing goal. In some implementations, sensing agent 536-1 may run in the medium access control (MAC) layer of sensing transmitter 504-1 and processing sensing measurements to fulfill a sensing goal may be carried out by sensing algorithm 538-1, which in examples may run in the application layer of sensing transmitter 504-1. In examples, sensing algorithm 538-1 running in the application layer of sensing transmitter 504-1 may be known as a Wi-Fi sensing agent, a sensing application, or a sensing algorithm. In examples, sensing algorithm 538-1 may include and/or execute sensing agent 536-1. According to some implementations, sensing agent 536-1 may include and/or execute sensing algorithm 538-1. In some implementations, sensing agent 536-1 may run in the MAC layer of sensing transmitter 504-1 and sensing algorithm 538-1 may run in the application layer of sensing transmitter 504-1. In some implementations, sensing agent 536-1 of sensing transmitter 504-1 and sensing algorithm 538-1 may run separately on processor 528-1. In an implementation, sensing agent 536-1 may pass sensing measurement parameters, transmission parameters, or physical layer parameters between the MAC layer of sensing transmitter 504-1 and the application layer of sensing transmitter 504-1. In an example, sensing agent 536-1 in the MAC layer or sensing algorithm 538-1 in the application layer may control physical layer parameters, for example physical layer parameters used to generate one or more sensing transmissions. In examples, sensing algorithm 538-1 may form services or features, which may be presented to an end-user. According to an implementation, communication between the MAC layer of sensing transmitter 504-1 and other layers or components of sensing transmitter 504-1 (including the application layer) may take place based on communication interfaces, such as an MLME interface and a data interface. In examples, sensing agent 536-1 may be configured to determine a number and timing of sensing transmissions for the purpose of Wi-Fi sensing. In some implementations, sensing agent 536-1 may be configured to cause sensing transmitter 504-1 to transmit sensing transmissions to one or more of plurality of sensing receivers 502-(1-M). In an implementation, sensing agent 536-1 may be configured to cause at least one transmitting antenna of transmitting antenna(s) 532-1 to transmit messages to one or more of plurality of sensing receivers 502-(1-M) or to remote processing device 506. Further, sensing agent 536-1 may be configured to receive, via at least one receiving antenna of receiving antennas(s) 534-1, messages from one or more of plurality of sensing receivers 502-(1-M) or from remote processing device 506.

In some embodiments, sensing transmitter 504-1 may include sensing measurements storage 540-1. In an implementation, sensing measurements storage 540-1 may store sensing measurements computed by one or more of plurality of sensing receivers 502-(1-M) based on sensing transmissions sent by sensing transmitter 504-1 and sent by one or more of plurality of sensing receivers 502-(1-M) to sensing transmitter 504-1. In an example, sensing measurements stored in sensing measurements storage 540-1 may be periodically or dynamically updated as required. In an implementation, sensing measurements storage 540-1 may include any type or form of storage, such as a database or a file system or coupled to memory 530-1.

In some embodiments, sensing transmitter 504-1 may include sensing measurement parameters storage 542-1. In an implementation, sensing measurement parameters storage 542-1 may store sensing measurement parameters and/or transmission parameters applicable to one or more sensing measurement sessions. In an implementation, sensing measurement parameters storage 542-1 may store sensing measurement parameters and/or transmission parameters applicable to one or more sensing measurement setups. In an implementation, sensing measurement parameters storage 542-1 may store sensing measurement parameters and/or transmission parameters applicable to one or more sensing measurement instances. In an example, sensing measurement parameters and/or transmission parameters stored in sensing measurement parameters storage 542-1 may be periodically or dynamically updated as required. In an implementation, sensing measurements storage 540-1 and sensing measurement parameters storage 542-1 may include any type or form of storage, such as a database or a file system or coupled to memory 530-1.

In an implementation, sensing transmitter 504-1 may include AP reciprocity determination agent 543-1, AP metrics determination agent 544-1, and role determination and role allocation agent 545-1. In an implementation, AP reciprocity determination agent 543-1, AP metrics determination agent 544-1, and role determination and role allocation agent 545-1 may be coupled to processor 528-1 and memory 530-1. In some embodiments, AP reciprocity determination agent 543-1, AP metrics determination agent 544-1, and role determination and role allocation agent 545-1 amongst other units, may include routines, programs, objects, components, data structures, etc., which may perform particular tasks or implement particular abstract data types. AP reciprocity determination agent 543-1, AP metrics determination agent 544-1, and role determination and role allocation agent 545-1 may also be implemented as, signal processor(s), state machine(s), logic circuitries, and/or any other device or component that manipulates signals based on operational instructions.

In some embodiments, AP reciprocity determination agent 543-1, AP metrics determination agent 544-1, and role determination and role allocation agent 545-1 may be implemented in hardware, instructions executed by a processing unit, or by a combination thereof. The processing unit may comprise a computer, a processor, a state machine, a logic array or any other suitable devices capable of processing instructions. The processing unit may be a general-purpose processor that executes instructions to cause the general-purpose processor to perform the required tasks or, the processing unit may be dedicated to performing the required functions. In some embodiments, AP reciprocity determination agent 543-1, AP metrics determination agent 544-1, and role determination and role allocation agent 545-1 may be machine-readable instructions that, when executed by a processor/processing unit, perform any of desired functionalities. The machine-readable instructions may be stored on an electronic memory device, hard disk, optical disk or other machine-readable storage medium or non-transitory medium. In an implementation, the machine-readable instructions may also be downloaded to the storage medium via a network connection. In an example, machine-readable instructions may be stored in memory 530-1.

In some embodiments, sensing transmitter 504-1 may include metrics data storage 546-1. In an implementation, metrics data storage 546-1 may store information related to different metrics, such as an AP bandwidth metric, a computational metric, and an OTA metric. In examples, the AP bandwidth metric, the computational metric, and the OTA metric may be considered to determine an optimum sensing session setup for a backhaul link for optimum network performance. In an example, information stored in metrics data storage 546-1 may be periodically or dynamically updated as required. In an implementation, metrics data storage 526-1 may include any type or form of storage, such as a database or a file system or coupled to memory 530-1.

Referring to FIG. 5 in more detail, remote processing device 506 may include processor 548 and memory 550. For example, processor 548 and memory 550 of remote processing device 506 may be processor 114 and memory 116, respectively, as shown in FIG. 1. In an embodiment, remote processing device 506 may further include transmitting antenna(s) 552, receiving antenna(s) 554, sensing agent 556, and sensing algorithm, 558. In some embodiments, an antenna may be used to both transmit and receive signals in a half-duplex format. When the antenna is transmitting, it may be referred to as transmitting antenna 552, and when the antenna is receiving, it may be referred to as receiving antenna 554. It is understood by a person of normal skill in the art that the same antenna may be transmitting antenna 552 in some instances and receiving antenna 554 in other instances. In the case of an antenna array, one or more antenna elements may be used to transmit or receive a signal, for example, in a beamforming environment. In some examples, a group of antenna elements used to transmit a composite signal may be referred to as transmitting antenna 552, and a group of antenna elements used to receive a composite signal may be referred to as receiving antenna 554. In some examples, each antenna is equipped with its own transmission and receive paths, which may be alternately switched to connect to the antenna depending on whether the antenna is operating as transmitting antenna 552 or receiving antenna 554.

In an implementation, sensing agent 556 may be responsible for determining sensing measurement parameters and/or transmission parameters for one or more sensing measurement setups. In examples, sensing agent 556 may receive sensing measurement parameters and/or transmission parameters for one or more sensing measurement setups from sensing algorithm 558. In an example, sensing agent 556 may receive sensing measurements from one or more of plurality of sensing receivers 502-(1-M) and may process the sensing measurements to fulfill a sensing goal. In an example, sensing agent 556 may receive channel representation information (such as CSI or TD-CRI) from one or more of plurality of sensing receivers 502-(1-M) and may process the channel representation information to fulfill a sensing goal. In implementations, sensing agent 556 may receive sensing measurements or channel representation information and may provide the received sensing measurements or channel representation information to sensing algorithm 558, and sensing algorithm 558 may receive the sensing measurements or channel representation information from sensing agent 556 and may process the information to fulfill a sensing goal.

In some implementations, receiving sensing measurements may be carried out by an algorithm running in the medium access control (MAC) layer of remote processing device 506 and processing sensing measurements to fulfill a sensing goal may be carried out by an algorithm running in the application layer of remote processing device 506. In examples, the algorithm running in the application layer of remote processing device 506 may be known as a Wi-Fi sensing agent, a sensing application, or sensing algorithm. In some implementations, the algorithm running in the MAC layer of remote processing device 506 and the algorithm running in the application layer of remote processing device 506 may run separately on processor 548. In an implementation, sensing agent 556 may pass physical layer parameters (e.g., such as channel representation information, examples of which are CSI and TD-CRI) from the MAC layer of remote processing device 506 to the application layer of remote processing device 506 and may use the physical layer parameters to detect one or more features of interest. In an example, the application layer may operate on the physical layer parameters and form services or features, which may be presented to an end-user. According to an implementation, communication between the MAC layer of remote processing device 506 and other layers or components of remote processing device 506 may take place based on communication interfaces, such as an MLME interface and a data interface. According to some implementations, sensing agent 556 may include/execute a sensing algorithm 558. In an implementation, sensing agent 556 may process and analyze sensing measurements using sensing algorithm 558 and identify one or more features of interest. Further, sensing agent 556 may be configured to determine a number and timing of sensing transmissions and sensing measurements for the purpose of Wi-Fi sensing. In some implementations, sensing agent 556 may be configured to cause one or more of plurality of sensing transmitters 504-(1-N) to transmit sensing measurements to one or more of plurality of sensing receivers 502-(1-M).

For ease of explanation and understanding, descriptions provided above may be with reference to sensing receiver 502-1 or sensing transmitter 504-1, however, the description is equally applicable to one or more of plurality of sensing receivers 502-(1-M) and/or one or more of plurality of sensing transmitters 504-(1-N).

According to one or more implementations, communications in network 560 may be governed by one or more of the 802.11 family of standards developed by IEEE. Some example IEEE standards may include IEEE 802.11-2020, IEEE 802.11ax-2021, IEEE 802.11me, IEEE 802.11az and IEEE 802.11be. IEEE 802.11-2020 and IEEE 802.11ax-2021 are fully ratified standards whilst IEEE 802.11 me reflects an ongoing maintenance update to the IEEE 802.11-2020 standard and IEEE 802.11be defines the next generation of standard. IEEE 802.11az is an extension of the IEEE 802.11-2020 and IEEE 802.11ax-2021 standards which adds new functionality. In some implementations, communications may be governed by other standards (other or additional IEEE standards or other types of standards). In some embodiments, parts of network 560 which are not required by system 500 to be governed by one or more of the 802.11 family of standards may be implemented by an instance of any type of network, including wireless network or cellular network. Further, IEEE 802.11ax included OFDMA, which allows sensing receiver 502 to simultaneously transmit data to one or more participating devices, such as plurality of sensing transmitters 504-(1-N), and vice versa using a single transmission opportunity (TXOP). The efficiency of OFDMA depends on how sensing receiver 502 schedules channel resources (interchangeably referred to as RUs) among plurality of sensing transmitters 504-(1-N) and configures transmission parameters. According to an implementation, system 500 may be an OFDMA enabled system.

Referring back to FIG. 5, according to one or more implementations, Wi-Fi sensing system 500 may participate in a sensing session. In examples, a sensing session is an agreement between a sensing initiator and a sensing responder to participate in a WLAN sensing procedure (also known as a Wi-Fi sensing procedure.) In examples, sensing measurement parameters associated with a sensing session may be determined by a sensing initiator and may be exchanged between the sensing initiator and a sensing responder. In examples, sensing initiator may be sensing transmitter 504-1 and sensing responder may be sensing receiver 502-1. In examples, sensing initiator may be sensing receiver 502-1 and sensing responder may be sensing transmitter 504-1. In examples, sensing initiator may be remote processing device 506, and both sensing transmitter 504-1 and sensing receiver 502-1 are sensing responders. In examples, sensing transmitter 504-1 may participate in multiple sensing sessions either as a sensing initiator or as a sensing responder. In examples, sensing receiver 502-1 may participate in multiple sensing sessions either as a sensing initiator or as a sensing responder. In examples, remote processing device may participate in multiple sensing sessions as a sensing initiator.

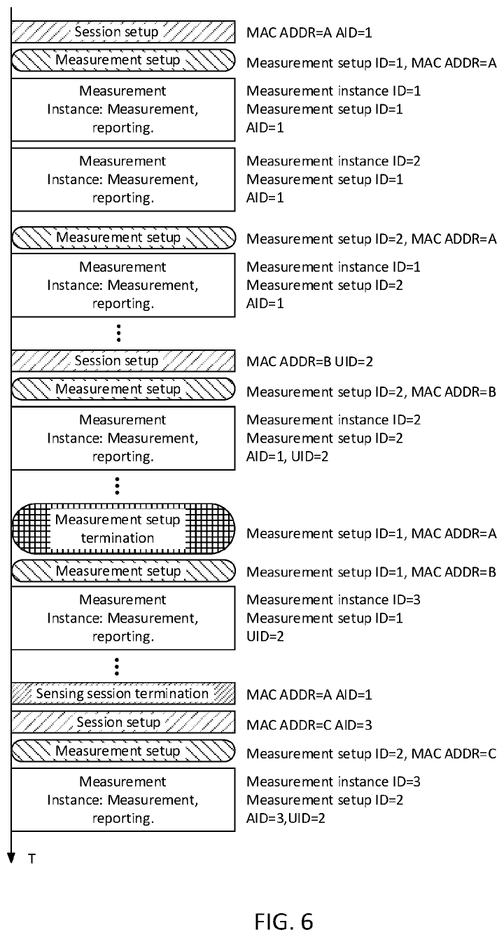

FIG. 6 illustrates an example of a WLAN sensing procedure (also known as a Wi-Fi sensing procedure) according to some embodiments. In examples, a WLAN sensing procedure allows a STA to perform WLAN sensing. In an example, a WLAN sensing procedure enables a STA to obtain one or more sensing measurements of the wireless transmission channel between two or more STAs and or the wireless transmission channel between a receive antenna and a transmit antenna of a STA. In examples, a WLAN sensing procedure is composed of one or more of a sensing session setup, a sensing measurement setup, one or more sensing measurement instances, sensing measurement setup termination, and sensing session termination.

FIG. 6 illustrates a sensing session setup with a STA with MAC ADDR=A and AID=1, In examples, a sensing session setup establishes a sensing session. In examples, the sensing session may be identified by the AID of the STA involved in the sensing session. FIG. 6 illustrates a sensing measurement setup procedure for the STA with MAC ADDR=A, where the sensing measurement setup ID=1.

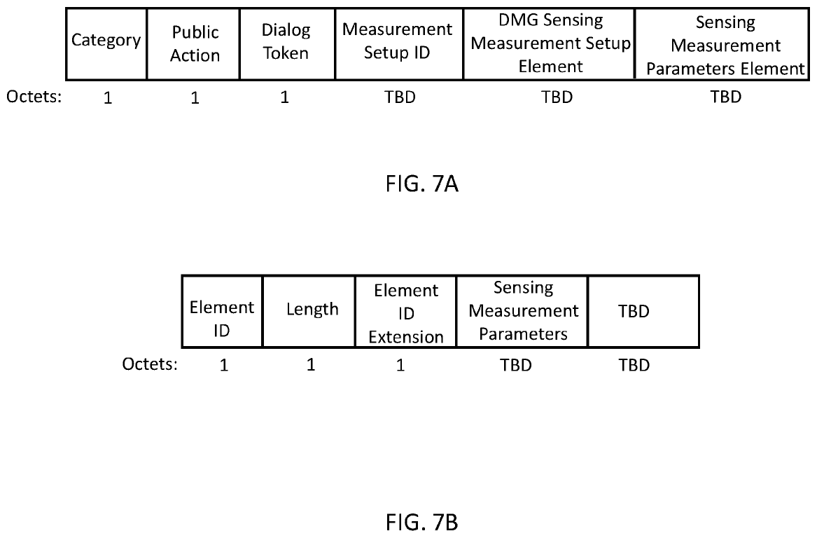

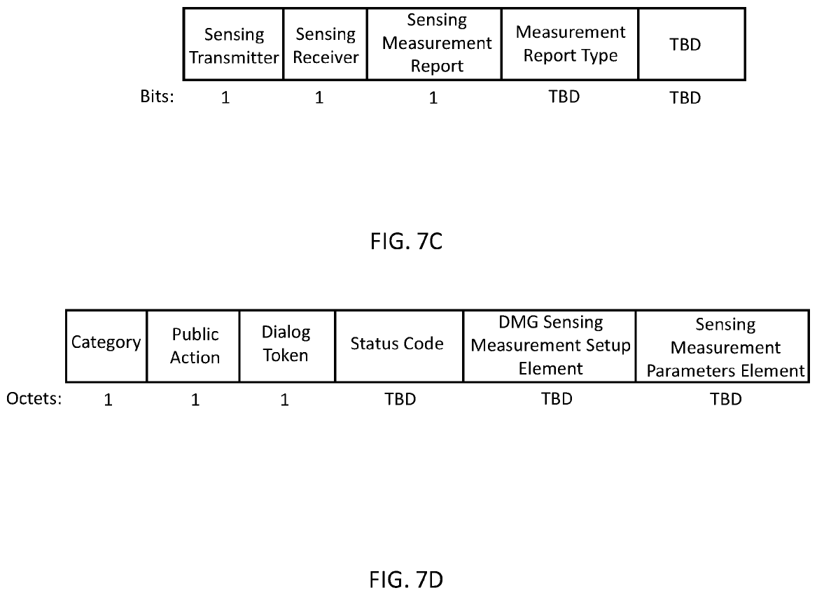

In examples, a sensing measurement setup allows for a sensing initiator and a sensing responder to exchange and agree on operational attributes associated with a sensing measurement instance. A sensing initiator may transmit a Sensing Measurement Setup Request frame to a sensing responder with which it intends to perform a sensing measurement setup. An example of a Sensing Measurement Setup Request frame is provided in FIG. 7A. In examples, the Sensing Measurement Setup Request frame is a Public Action frame, and in examples is identified by a Public Action field value. As shown in the example illustrated in FIG. 7A, in embodiments, a Sensing Measurement Set Request frame format may include one or more of a Category field, a Public Action field, a Dialog Token field, a Measurement Setup ID field, a DMG Sensing Measurement Setup Element field, and a Sensing Measurement Parameters element. In examples, a Category value code is defined for a “Protected Sensing Frame.” In an embodiment, a Protected Sensing Action field is defined in the octet immediately after the Category field in order to differentiate Protected Sensing Frame formats from Public Sensing Frame formats.

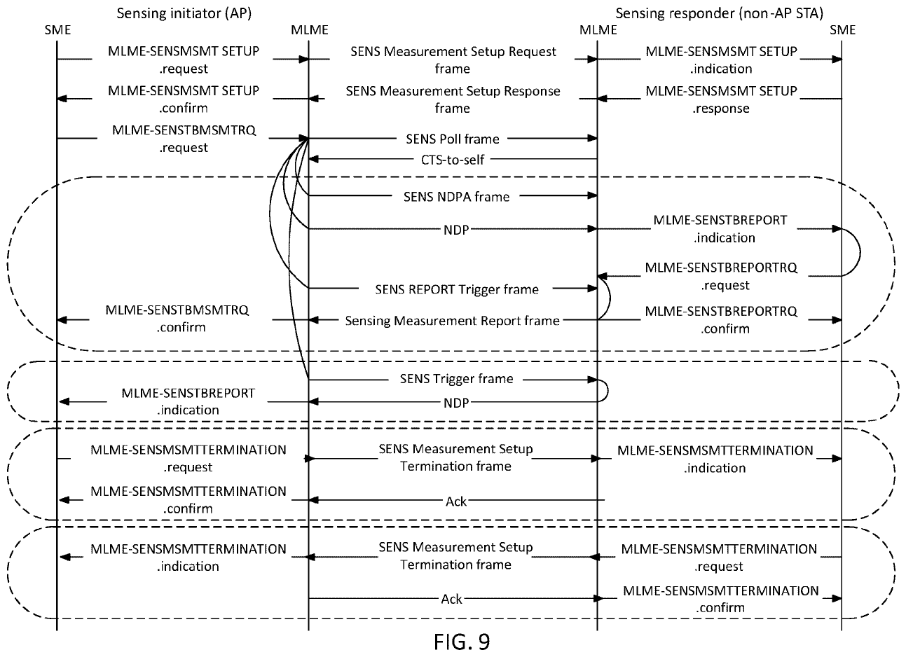

FIG. 7B illustrates an example, according to some embodiments, of a Sensing Measurement Parameters element. In examples, a Sensing Measurement Parameters element indicates operational attributes of a corresponding sensing measurement instance. In examples, the Sensing Measurement Parameters element comprises a Sensing Measurement Parameters field. FIG. 7C illustrates an example of a format of a Sensing Measurement Parameters field, according to some embodiments. In an example, a Sensing Measurement Parameters field comprises a Sensing Transmitter subfield. The Sensing Transmitter subfield may be set to 1 to indicate a sensing responder assumes a sensing transmitter role, such as sensing transmitter 504-1. In an example the sensing responder assumes a sensing transmitter role according to the Sensing Transmitter subfield for the Sensing Measurement Setup ID associated with the Sensing Measurement Parameters field. In an example, the Sensing Measurement Parameters field comprises a Sensing Receiver subfield. The Sensing Receiver subfield may be set to 1 to indicate a sensing responder assumes a sensing receiver role, such as sensing receiver 502-1. In an example, the sensing responder assumes a sensing receiver role according to the Sensing Receiver subfield for the Sensing Measurement Setup ID associated with the Sensing Measurement Parameters field. FIG. 7B is an example of a representation of IEEE Draft P802.11bf_D2.0 FIG. 9-1002bc—Sensing Measurement Parameters element format.

Referring again to FIG. 7C, in examples, a Sensing Measurement Parameters field format includes a Sensing Measurement Report subfield if the Sensing Receiver subfield indicates that the sensing responder should assume a sensing receiver role. In an example, the Sensing Measurement Report subfield may indicate whether or not a sensing responder sends Sensing Measurement Report frames in sensing measurement instances that result from the sensing measurement setup.

Referring again to FIG. 7C, in examples, a Sensing Measurement Parameters field format includes a Measurement Report Type subfield. In examples, the Measurement Report Type subfield indicates the type of measurement result reported in sensing measurement instance(s) corresponding to the sensing measurement setup ID, for example when the sensing initiator is a sensing transmitter, such as sensing transmitter 504-1.

In examples, after the sensing responder receiver the Sensing Measurement Setup Request frame, the sensing responder may transmit a Sensing Measurement Setup Response frame. An example of a Sensing Measurement Setup Response frame is provided in FIG. 7D. In examples, the sensing responder may use a Status Code field in the Sensing Measurement Setup Response frame to indicate whether the sensing responder accepts the requested sensing measurement setup parameters in the received Sensing Measurement Setup Request frame. In an embodiment, the Status Code field may be set to 0 indicating a successful sensing measurement setup, where the sensing responder accepts the operational attributes included in the Sensing Measurement Setup Request frame. In examples, the sensing responder may indicate in the Sensing Measurement Setup Response frame that the operational attributes included in the Sensing Measurement Setup Request frame sent by the sensing initiator are not accepted, for example by setting a Status Code field to a non-zero value. In examples, the sensing responder may indicate in the Sensing Measurement Setup Response frame preferred sensing measurement parameters, for example to indicate to the sensing initiator one or more operational attributes preferred by the sensing responder. In examples, the sensing responder may indicate to the sensing initiator that preferred sensing measurement parameters are included in the Sensing Measurement Setup Response frame by setting a Status Code field to a non-zero value.

In examples, the sensing initiator may assign a role to the sensing responder as part of the sensing measurement setup sent in the Sensing Measurement Setup Request frame. For example, the sensing initiator may indicate to a sensing responder that the sensing responder is to assume the role of a sensing receiver, such as sensing receiver 502-1, or the role of a sensing transmitter, such as sensing transmitter 504-1, or the role of sensing receiver 502-1 and sensing transmitter 504-1. In examples, sensing initiator may indicate to sensing responder whether the sensing responder sends sensing measurement report frames in sensing measurement instances. In an embodiment, the role assigned to the sensing responder and/or whether the sensing responder sends sensing measurement report frames persists until the sensing measurement setup is terminated.

Referring again to FIG. 6 and the sensing session with the STA with MAC ADDR=A identified by the STA AID, AID=1, the sensing measurement setup is followed by one or more sensing measurement instances and measurement reporting instances which may be performed based on the defined operational attribute set. In the example shown in FIG. 6, the one or more sensing measurement instances for the STA with MAC ADDR=A may be assigned sensing measurement instance IDs, for example a first sensing measurement instance may be assigned sensing measurement instance ID=1, and a second measurement instance may be assigned sensing measurement instance ID=2. In examples, a sensing measurement instance may be uniquely associated with a sensing measurement setup.

Referring again to FIG. 6, a second sensing measurement setup may be initiated for the STA with MAC ADDR=A, which may be identified as sensing measurement setup ID=2. As with sensing measurement setup ID=1, sensing measurement setup ID=2 may be associated with a second operational attribute set. In examples, after the second sensing measurement setup, any subsequent one or more sensing measurement instances may be performed based on either the first operational attribute set (sensing measurement setup ID=1) or the second operational attribute set (sensing setup measurement ID=2.)

Referring again to FIG. 6, FIG. 6 illustrates a sensing session setup with a STA with MAC ADDR=B and UID=2. In examples, the sensing session may be identified by the UID of the STA with MAC ADDR-B. FIG. 6 further illustrates a sensing measurement setup for the STA with MAC ADDR=B. In the example, the operational attribute set for the sensing measurement setup for the STA with MAC ADDR=B is the same as the second operational attribute set established with the STA with MAC ADDR=A, and the sensing measurement setup ID is used for both the STA with MAC ADDR=A and the STA with MAC ADDR=B. That is, a sensing measurement setup ID (which may also be referred to as a sensing measurement setup label) may apply to one or more STA. In examples according to FIG. 6, subsequent sensing measurement instances associated with sensing measurement setup ID=2 may be associated with the STA with MAC ADDR=A, the STA with MAC ADDR=B, or with both the STA with MAC ADDR=A and the STA with MAC ADDR=B. An example of one-to-many triggering is shown in FIG. 6 where AID=1 and UID=2 are both associated with a single measurement instance and measurement reporting (measurement instance ID=2 and measurement setup ID=2.)

In examples, an operational attribute set of a sensing session may be terminated by performing a sensing measurement setup termination procedure, for example as is shown in FIG. 6 for sensing measurement setup ID=1 and the STA with MAC ADDR=A. In examples, the sensing measurement setup ID of a terminated sensing measurement setup may be used for a subsequent sensing measurement setup. This is shown in FIG. 6 where a sensing measurement setup with ID=1 is established for the STA with MAC ADDR-B, after the termination of the sensing measurement setup ID=1 with the STA with MAC ADDR=A. In some embodiments, a sensing session may be terminated using a sensing session termination procedure, as shown in FIG. 6.

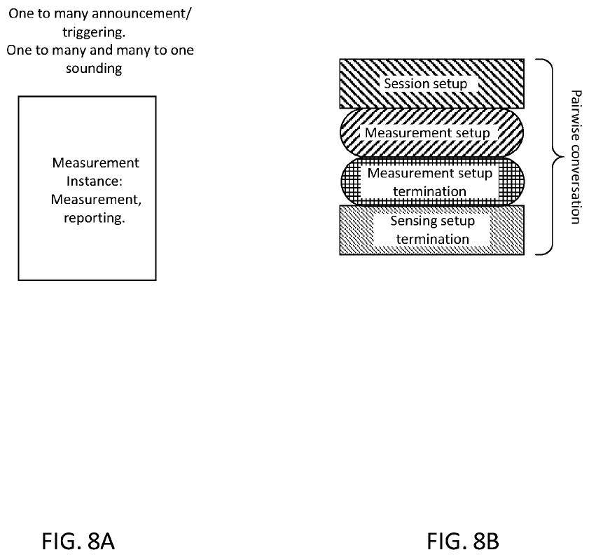

FIG. 8A illustrates exchanges between a sensing initiator and a sensing responder that may be one-to-many or many-to-one. In examples, a measurement instance and/or measurement reporting may have a one-to-one (single device to single device) announcement or triggering or may have a one-to-many (single device to multiple devices) announcement or triggering. In examples, a measurement instance may have a one-to-one, one-to-many, or many-to-one (many devices to a single device) sounding.

As previously described, a sensing session is an agreement between a sensing initiator and a sensing responder to participate in a WLAN sensing procedure, that is a sensing session is pairwise and in examples, may be identified by MAC addresses of the sensing initiator and the sensing responder or by the associated AID/UID. FIG. 8B shows an example of pairwise exchanges or procedures that may take place between a sensing initiator and a sensing responder related to a sensing session, which include a sensing session setup, a sensing measurement setup, a sensing measurement setup termination, and a sensing session termination.

In examples, a sensing measurement instance of a WLAN sensing procedure may be a trigger-based (TB) sensing measurement instance. FIG. 9 depicts a message flow of a sensing session of a WLAN sensing procedure comprising a sensing measurement setup procedure followed by one or more trigger-based (TB) sensing measurement instances that consists of either NDPA sounding or trigger frame (TF) sounding, following by a sensing measurement setup termination procedure, according to some examples. In examples, a TB sensing measurement instance may be used where the sensing initiator is an AP and one or more non-AP STAs are sensing responders. In examples, a TB sensing measurement instance may include a polling phase, an NDPA sounding phase, a trigger frame (TF) sounding phase, and a reporting phase.

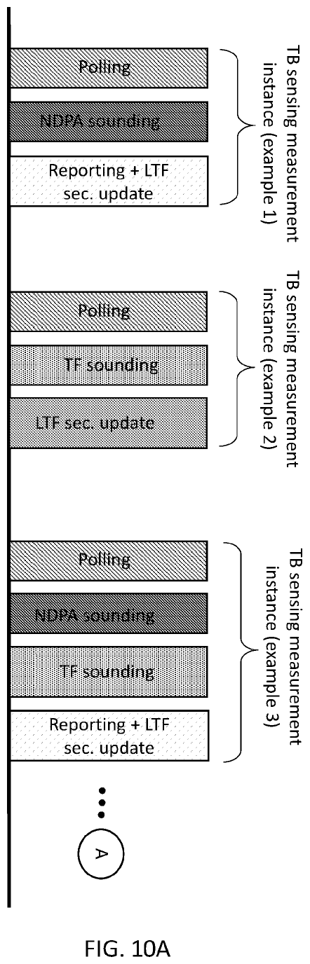

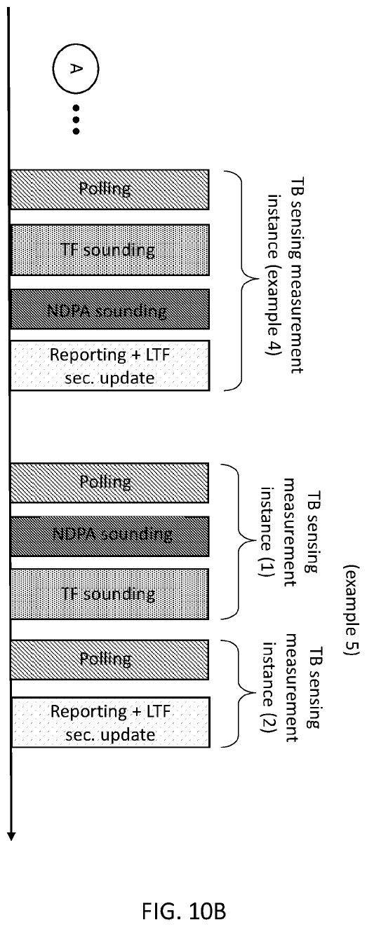

FIG. 10A and FIG. 10B illustrate five examples of TB sensing measurement instances. Example 1 of FIG. 10A illustrates an example of a TB sensing measurement instance comprising a polling phase, an NDPA sounding phase, and a reporting phase. Example 2 of FIG. 10A illustrates an example of a TB sensing measurement instance comprising a polling phase and a TF sounding phase. Example 3 of FIG. 10A and example 4 of FIG. 10B illustrate two examples of a TB sensing measurement instance comprising a polling phase, an NDPA sounding phase, a TF sounding phase, and a reporting phase. Example 5 of FIG. 10B shows two TB sensing measurement instances, where the first TB sensing measurement instance comprises a polling phase, an NDPA sounding phase, and a TF sounding phase, and the second TB sensing measurement instance comprises a polling phase and a reporting phase. In examples, the TF sounding phase of the TB sensing measurement instance may precede the NDPA sounding phase of the TB sensing measurement instance, for example as in Example 4. In examples, the NDPA sounding phase of the TB sensing measurement instance may precede the NDPA sounding phase of the TB sensing measurement instance, for example as in Example 3. In some embodiments, the reporting phase of the second TB sensing measurement instance in Example 5 may be addressed to sensing responders other than the sensing responders involved in the TF sounding phase or the NDPA sounding phase of the first TB measurement instance.

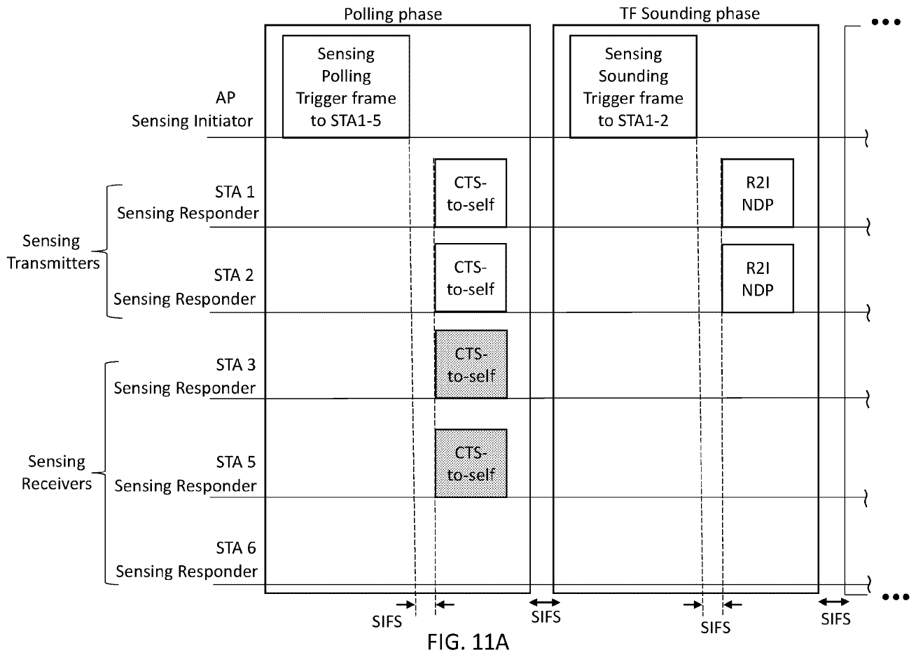

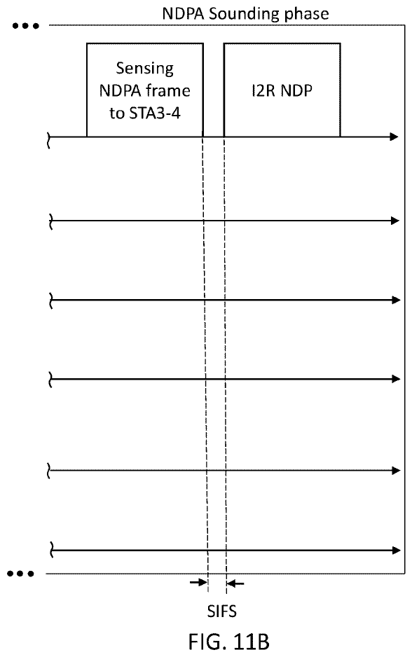

FIG. 11A and FIG. 11B are one example of a TB sensing measurement instance with a single AP in the role of a sensing initiator and five STAs, referred to as STA 1, STA 2, STA 3, STA 4, and STA 5, all of which in the example are sensing responders. In the example, the TB sensing measurement instance comprises a polling phase, a TF sounding phase, and an NDPA sounding phase. In the example, STA 1 and STA 2 are sensing transmitters, such as sensing transmitter 504-1 and sensing transmitter 504-2. In the example of FIG. 11A and FIG. 11B, STA 3, STA 4, and STA 5 are sensing receivers, such as sensing receiver 502-1, sensing receiver 502-2, and sensing receiver 502-3. In examples, in the polling phase, the AP as the sensing initiator transmits a Sensing Polling Trigger frame to STA 1, STA 2, STA 3, STA 4, and STA 5. In an embodiment, sensing transmitter STA 1 (504-1) and sensing transmitter STA 2 (504-2) respond to the Sensing Polling Trigger frame with an indication that the STA is available to participate in a sensing measurement instance. In examples, the indication is a CTS-to-self frame. In an embodiment, sensing receiver STA 3 (502-1) and sensing receiver STA 4 (502-2) respond to the Sensing Polling Trigger frame with an indication that the STA is available to participate in a sensing measurement instance. In examples, the indication is a CTS-to-self frame. In the example, sensing receiver STA 5 (502-3) does not respond to the Sensing Polling Trigger frame sent by the AP as the sensing initiator, indicating that STA 5 (502-3) will not participate in the sensing measurement instance.

The sensing measurement instance of FIG. 11A and FIG. 11B includes a TF Sounding phase. In examples, in the TF Sounding phase, the AP as the sensing initiator sends a Sensing Sounding Trigger frame to sensing transmitter STA 1 (504-1) and to sensing transmitter STA 2 (504-2). In examples, a period of one or more SIFS elapses between the AP receiving the CTS-to-self frames from STA 1, STA 2, STA 3, and STA 4 before sending the Sensing Sounding Trigger frame. In examples, responsive to receiving the Sensing Sounding Trigger frame, sensing transmitter STA 1 (504-1) and sensing transmitter STA 2 (504-2) send sensing transmissions to the AP. In examples, the sensing transmissions may comprise NDP transmissions. In an example, one or more of the NDP transmissions to the AP may be R2I NDP transmissions (as shown in the example of FIG. 11A and FIG. 11B). In examples, a period of one or more SIFS elapses between sensing transmitter STA 1 (504-1) receiving the Sensing Sounding Trigger frame and transmitting a sensing transmission, and in examples a period of one or more SIFS elapses between sensing transmitter STA 2 (504-2) receiving the Sensing Sounding Trigger frame and transmitting a sensing transmission. In examples, the AP may assume the role of sensing receiver 502-4, and the AP may make sensing measurements on the sensing transmissions from sensing transmitter STA 1 (504-1) and sensing transmitter STA 2 (504-2).

Referring again to FIG. 11A and FIG. 11B, in a NDPA sounding phase, the AP acting as sensing initiator assumes the role of sensing transmitter (504-3). In examples, the AP as sensing transmitter 504-3 transmits a sensing transmission. In examples, the sensing transmission may be a broadcast transmission. In examples, the sensing transmission may be a unicast transmission to one or more STAs, for example to sensing receiver STA 3 (502-1) and/or to sensing receiver STA 4 (502-2). In examples, a period of one or more SIFS elapses between the AP as sensing transmitter 504-3 sending the sensing NDPA frame and when the AP as sensing transmitter 504-3 sends the one or more sensing transmissions. In examples, one or more of the sensing transmissions may be a full bandwidth NDP frame. In examples, one or more of the sensing transmissions may be a partial bandwidth NDP frame. In examples, one or more of the NDP frames may be an I2R NDP frame.

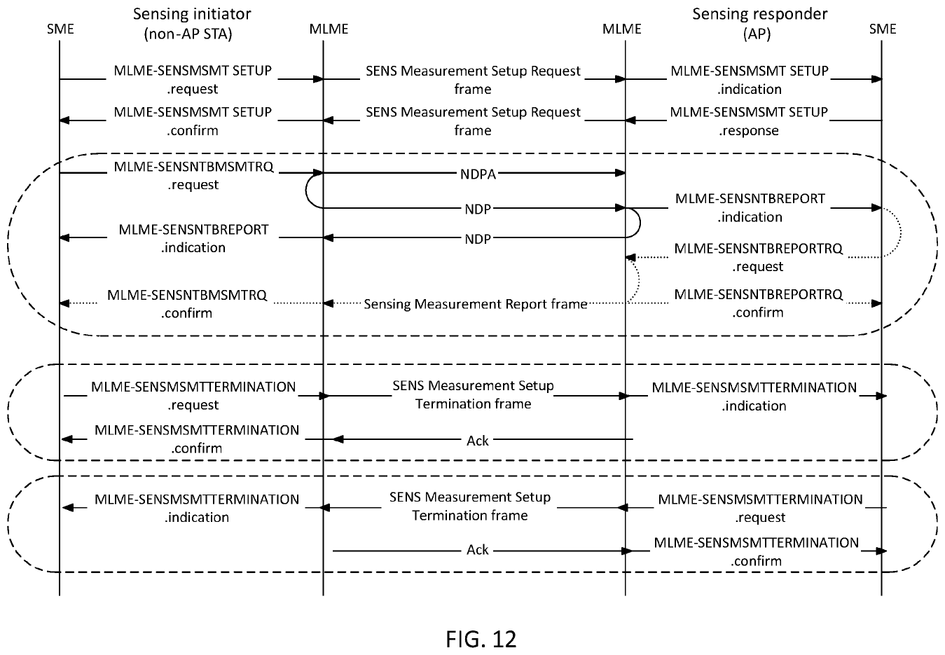

In examples, a sensing measurement instance of a WLAN sensing procedure may be a non-trigger-based (non-TB) sensing measurement instance. FIG. 12 depicts a message flow of a sensing measurement setup procedure followed by one or more non-TB sensing measurement instances of a WLAN sensing procedure that consist of one or more of downlink sounding or uplink sounding, according to some embodiments, followed by a sensing measurement setup termination procedure, according to some examples. In examples, a non-TB sensing measurement instance may be used where the sensing initiator is a non-AP STA and an AP is the sensing responder. In examples of uplink sounding as shown in FIG. 12, the sensing initiator (non-AP STA) acting as a sensing transmitter (for example, sensing transmitter 504-1) transmits a sensing announcement frame followed by a sensing transmission. In examples, the sensing announcement frame may be an NDPA frame. In examples, the sensing transmission may be an NDP frame. In examples, responsive to receiving the sensing transmission, the AP acting as a sensing receiver (for example, sensing receiver 502-1) may transmit to the sensing initiator (non-AP STA in the role of sensing transmitter 504-1) a sensing measurement report, for example one or more Sensing Measurement Report frames. In examples of downlink sounding as shown in FIG. 12, the sensing initiator (non-AP STA) acting as a sensing receiver (for example, sensing receiver 502-1) transmits a sensing announcement frame. In examples, the sensing announcement frame may be an NDPA frame. In examples, responsive to receiving the sensing announcement frame, the AP acting as sensing transmitter (for example, sensing transmitter 504-1) may transmit one or more sensing transmissions. In examples, one or more of the sensing transmissions may be an NDP frame. In examples, the non-AP STA acting as a sensing receiver (502-1), responsive to receiving a sensing transmission, may make a sensing measurement on the sensing transmission. In examples, the sensing measurement setup may be terminated by the sensing initiator or the sensing responder transmitting a SENS Measurement Setup Termination frame. In examples, the sensing responder or sensing initiator (respectively) may respond with an acknowledgment.

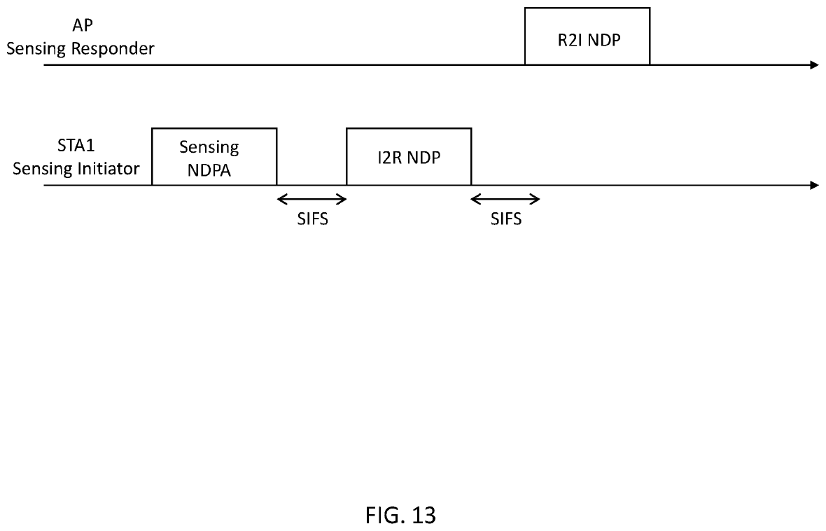

FIG. 13 illustrates a detailed example of a non-TB sensing measurement instance, according to some embodiments. In examples, STA 1 acting as sensing initiator and sensing transmitter, such as sensing transmitter 504-1, transmits a sensing announcement frame. In examples, the sensing announcement frame may be a sensing NDPA frame. In examples, one or more SIFS may elapse followed by STA 1 acting as sensing initiator and sensing transmitter (such as sensing transmitter 504-1) transmitting one or more sensing transmissions. In examples, one or more of the sensing transmissions may be an NDP frame. In an example. STA 1 acting as sensing initiator and sensing receiver, such as sensing receiver 502-1, transmits a sensing announcement frame. In examples, the sensing announcement frame may be a sensing NDPA frame. In examples, one or more SIFS may elapse followed by AP1 acting as sensing responder and sensing transmitter (such as sensing transmitter 504-1) transmitting one or more sensing transmissions. In examples, one or more of the sensing transmissions may be an NDP frame.

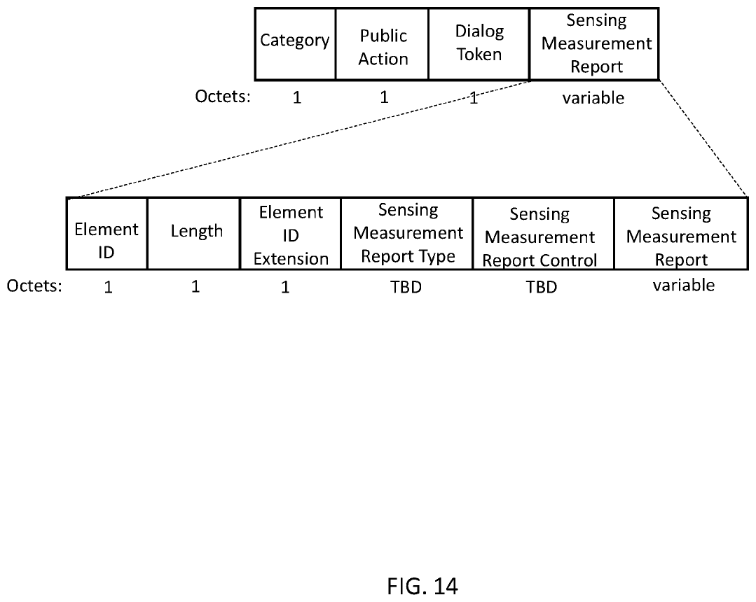

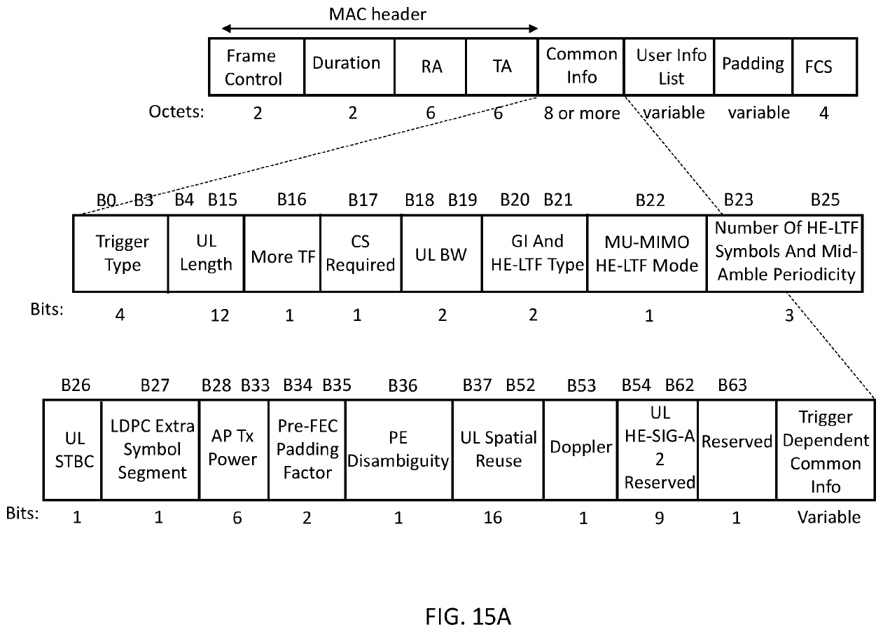

FIG. 14 illustrates an example of a Sensing Measurement Report frame. In some embodiments, a Sensing Measurement Report frame is a Public Action category or a Public Action No Ack category. In some examples, a Sensing Measurement Report frame may be transmitted to provide WLAN sensing measurements, for example to a sensing agent or a sensing algorithm of a sensing initiator. In examples, a Sensing Measurement Report frame may comprise one or more Sensing Measurement Report elements. A Sensing Measurement Report element may comprise a single sensing measurement report, in some embodiments. In examples, a Sensing Measurement Report element may include a Sensing Measurement Report type field, which may contain a number that identifies the type of sensing measurement report. For example, a value of 0 may indicate that the sensing measurement type is a CSI measurement, whereas a non-zero value may indicate that the sensing measurement type is a TD-CRI measurement.

Referring again to FIG. 14, in embodiments a Sensing Measurement Report element may include a Sensing Measurement Report Control field. In examples, the Sensing Measurement Report Control field may contain information necessary to interpret the Sensing Measurement Report field. For example, the Sensing Measurement Report Control field format may comprise one or more subfields. In an embodiment, one or more subfields of the Sensing Measurement Report Control field may include PHY layer parameters used by the sensing receiver when performing the sensing measurement, for example receiver antenna beamforming or spatial layer information.

In a sensing session, exchanges of transmissions between one or more of plurality of sensing receivers 502-(1-M) and one or more of plurality of sensing transmitters 504-(1-N) may occur. In an example, control of these transmissions may be with the MAC layer of the IEEE 802.11 stack. According to an implementation, one or more of plurality of sensing receivers 502-(1-M) may secure a TXOP which may be allocated to one or more sensing transmissions by one or more of plurality of sensing transmitters 504-(1-N). According to an implementation, one or more of plurality of sensing receivers 502-(1-M) may allocate channel resources (for example, RUs or spatial layers) within a TXOP to the one or more of plurality of sensing transmitters 504-(1-N). In an example, one or more of plurality of sensing receivers 502-(1-M) may allocate the channel resources to the one or more of plurality of sensing transmitters 504-(1-N) by allocating time, bandwidth and/or spatial layers within the TXOP to the one or more of plurality of sensing transmitters 504-(1-N).

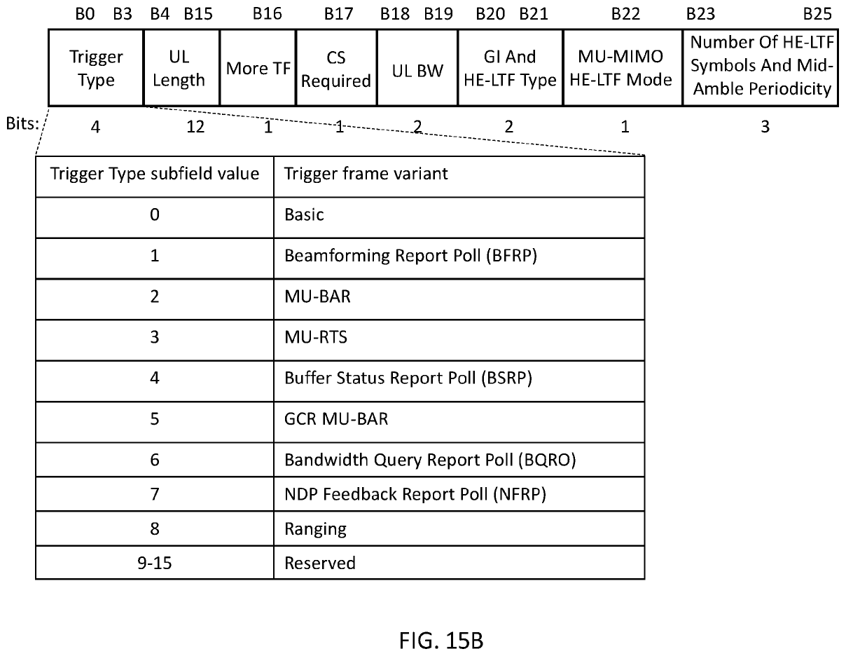

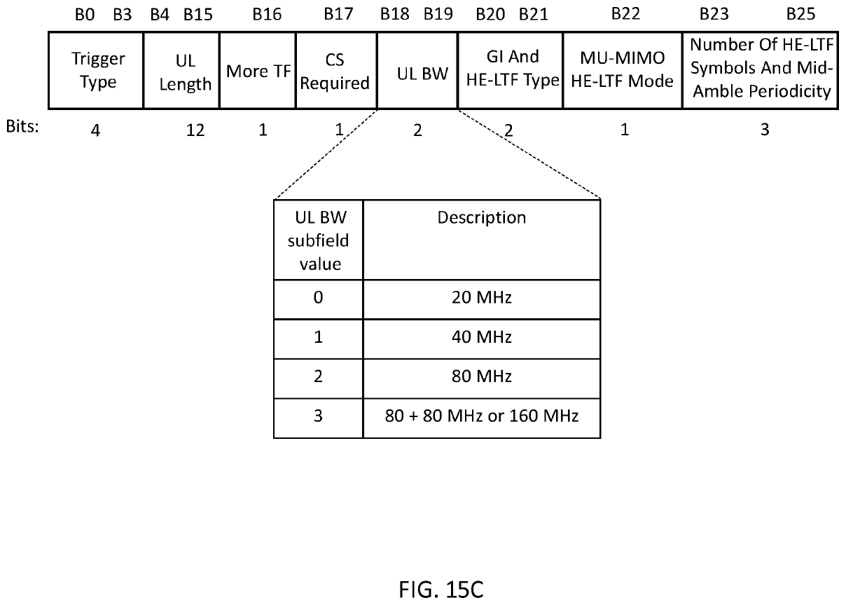

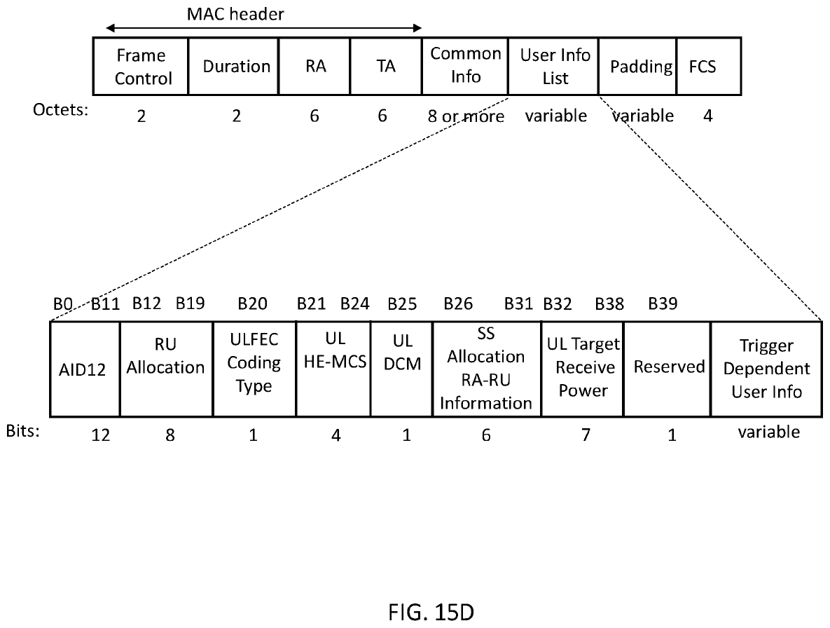

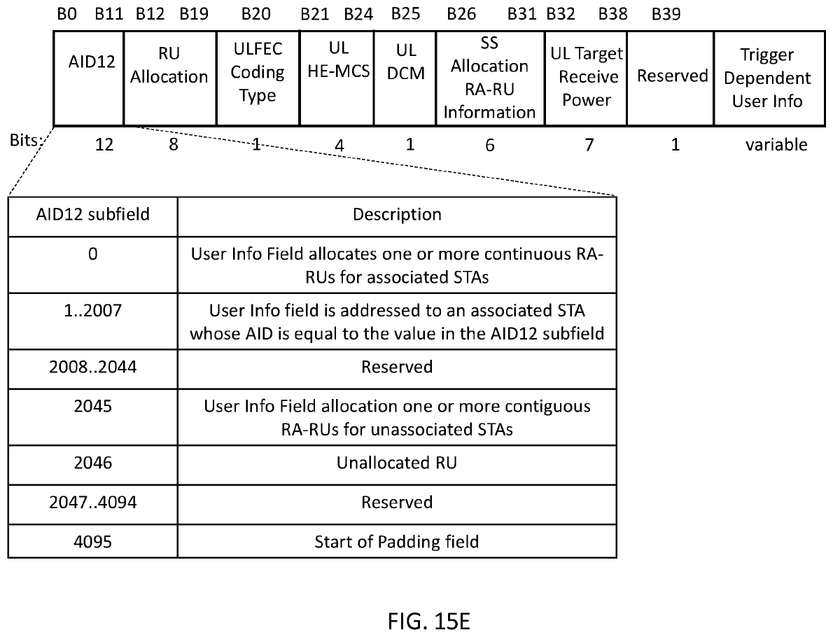

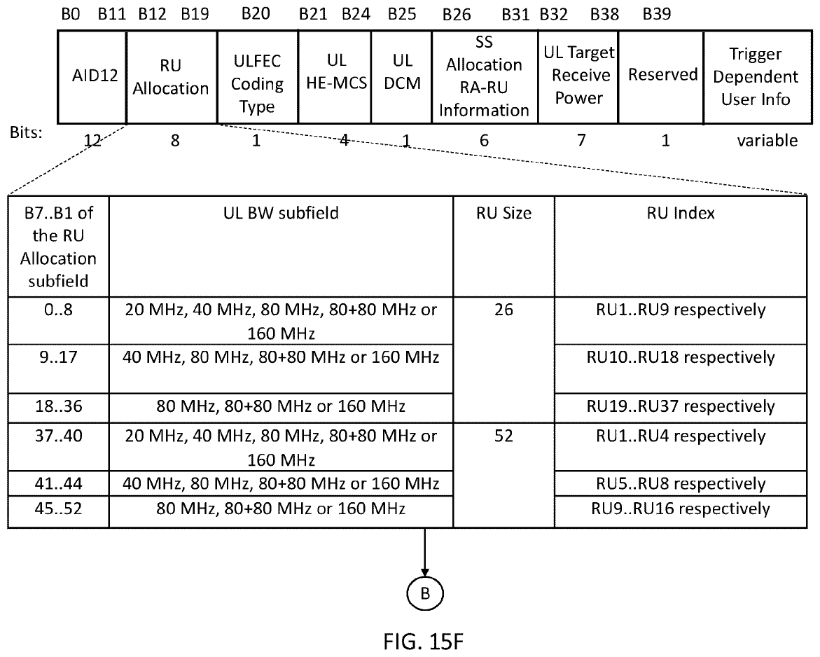

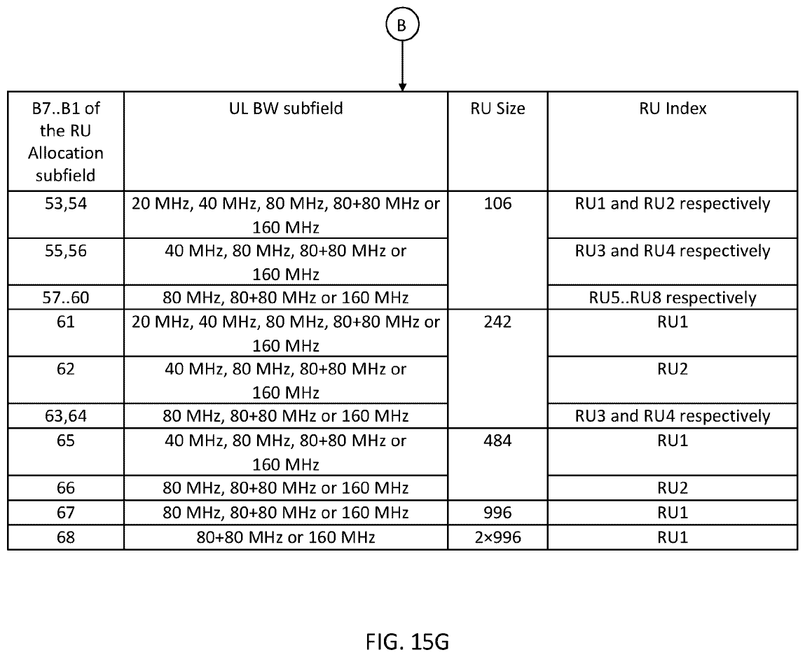

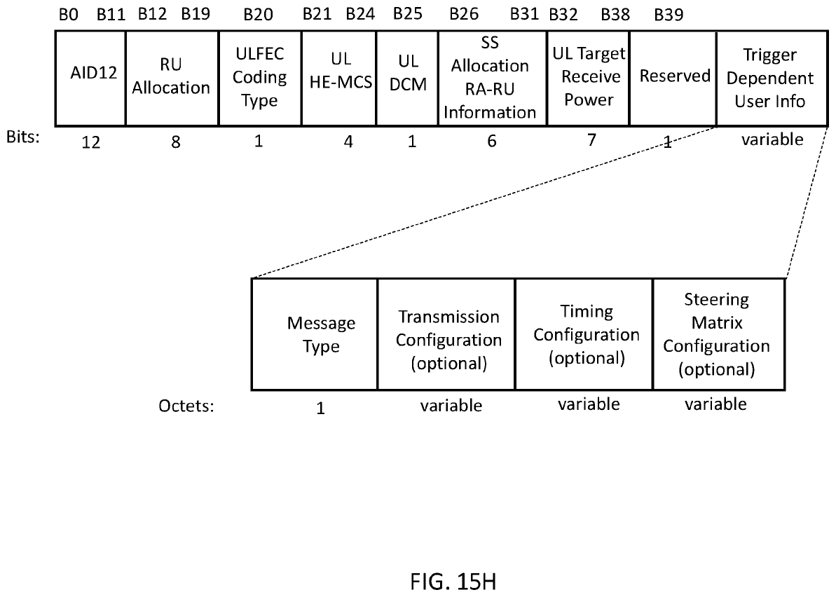

According to an implementation, an example of a hierarchy of fields within sensing trigger message is shown in FIG. 15A to FIG. 15H.

As described in FIG. 15A, the Common Info field may contain information which is common to one or more of plurality of sensing transmitters 504-(1-N). According to some implementations, the requirement of an NDPA preceding an NDP may be optional. This may be indicated to one or more of plurality of sensing transmitters 504-(1-N) and may for example be encoded into a “Trigger Dependent Common Info” field if the requirement is common to plurality of sensing transmitters 504-(1-N), or into a “Trigger Dependent User Info” field if the requirement is specific to one or more of plurality sensing transmitters 504-(1-N). According to an example, the requirement for a sensing announcement (for example, an NDPA) preceding a sensing response NDP may be encoded by a single bit where 0 (bit clear) indicates that a sensing announcement is optional and 1 (bit set) indicates that a sensing announcement is required.

As described in FIG. 15B, a Trigger Type (within B0 . . . 3 of “Common Info” field) may be defined which represents a sensing trigger message. In examples, a sensing Trigger message may have a Trigger Type subfield value of any Reserved value from 9-15, for example a Sensing Trigger message may have a Trigger Type subfield value of 9. In an example of triggering a sensing transmission from a sensing transmitter 504-1, a Trigger Dependent User Info field may include sensing trigger message data. In an implementation, a time-synchronized sensing transmission may be required from plurality of sensing transmitters 504-(1-N) responding to a sensing trigger message. In an example, the requirement for one or more time-synchronized sensing transmissions may be encoded into a Trigger Dependent Common Info field. According to an example, the requirement for one or more time-synchronized sensing transmissions may be encoded by a single bit where 0 (bit clear) represents a request for a normal or non-time-synchronized response and 1 (bit set) represents a request for a time-synchronized response. In some examples, a method of time-synchronization may be requested in the sensing trigger. In examples, the method of time-synchronization to be requested may be encoded into a Trigger Dependent Common Info field. In examples, the encoding may use two bits as shown in the following table.

| Encoding | Method | Description |
|---|---|---|
| 00 | A | Sensing announcement followed by sensing NDP. |
| 01 | B | Padding followed by a sensing response message. |
| 10 | C | Sensing NDP without an initial sensing |
| | | announcement. |
| 11 | N/A | For future use or extensions. |

As described in FIG. 15C the sensing trigger message may have an uplink bandwidth (UL BW) subfield value of 0, 1, 2 or 3 corresponding to bandwidths of 20 MHz, 40 MHz, 80 MHz, or 80+80 MHz (160 MHz).

As described in FIG. 15D, the User Info List contains information which is specific to each of the plurality of sensing transmitters 504-(1-N). In examples, the User Info List may include the AID of a sensing transmitter, an RU allocation for a sensing transmitter, and other Trigger Dependent User Info.

As described in FIG. 15E, the AID12 subfield of the User Info List illustrated in FIG. 15D may be used to address a specific sensing transmitter of the plurality of sensing transmitters 504-(1-N).

As described in FIG. 15F and FIG. 15G, the RU Allocation subfield is used to allocate resource units (RU) to each of the plurality of sensing transmitters 504-(1-N).

As described in FIG. 15H, the Trigger Dependent User Info subfield may be used to request the transmission configuration and/or steering matrix configuration for one or more of the plurality of sensing transmitters 504-(1-N) that the sensing trigger message is triggering.

### C. Systems and Methods for Determination of Sensing Roles in a Mesh Network

The present disclosure generally relates to systems and methods for Wi-Fi sensing. In particular, the present disclosure relates to systems and methods for determination of sensing roles in a mesh sensing network.

A Wi-Fi sensing system may be configured to detect features of interest in a sensing space. The Wi-Fi sensing system may be a network of Wi-Fi-enabled devices which are part of an IEEE 802.11 network (sometimes referred to as a basic service set (BSS) or extended service set (ESS)). The features of interest may include motion of objects and motion tracking, presence detection, intrusion detection, gesture recognition, fall detection, breathing rate detection, and other applications. The sensing space may refer to any physical space in which a Wi-Fi sensing system may operate and may include a place of abode, a place of work, a shopping mall, a sports hall or sports stadium, a garden, or any other physical space.

Typically, a Wi-Fi device in a Wi-Fi sensing network performs a sensing measurement calculation or executes a sensing algorithm. In examples, a sensing algorithm may process multiple sensing measurements to achieve a sensing goal in a sensing space, where the multiple measurements provide sufficient sensing coverage. In examples, good coverage of a sensing space may be achieved when there is spatial diversity in the sensing transmissions used for sensing measurements. In examples, sensing measurements may be aggregated by a single device, for example, requiring one or more sensing measurements to be transmitted between devices including over the air, enabling the single device to be able to process them to achieve a sensing goal.

Easy Mesh is a vendor-neutral standard managed by Wi-Fi Alliance. In examples, Easy Mesh may be an application layer standard which extends access point (AP)/station (STA) architecture by adding components above the MAC/PHY. In Easy Mesh, a fronthaul link may be used for communication between an AP and one or more STAs and a backhaul link provides for communications between an AP and another AP. An AP which can assume the role of an AP or a STA may be referred to as a multi-AP device. The AP/STA architecture enables a multi-AP device to act as a STA on a backhaul link with another AP, while at the same time acting as an AP towards client devices (via a fronthaul link). In examples, a backhaul link between two APs may be wired or wireless. Further, in examples, higher end multi-AP devices have multiple radios, and they can establish a backhaul link with an AP on a different channel, thereby enabling the backhaul link and fronthaul links with client devices to operate concurrently.

In an example, a mesh network may include two APs (referred to as a first AP and a second AP) and many STAs. The first AP may have a wireless backhaul link with the second AP where the second AP is acting as a STA according to the Easy Mesh standard. A Wi-Fi sensing system may benefit from a sensing measurement on the backhaul link to improve coverage in the sensing space. The determination (or selection) of the roles of the two APs in this scenario (i.e., whether an AP is a sensing initiator, a sensing responder, a sensing receiver, or a sensing transmitter) in a mesh network is important to make sure this selection has minimum effect on the throughput of the communication networks.

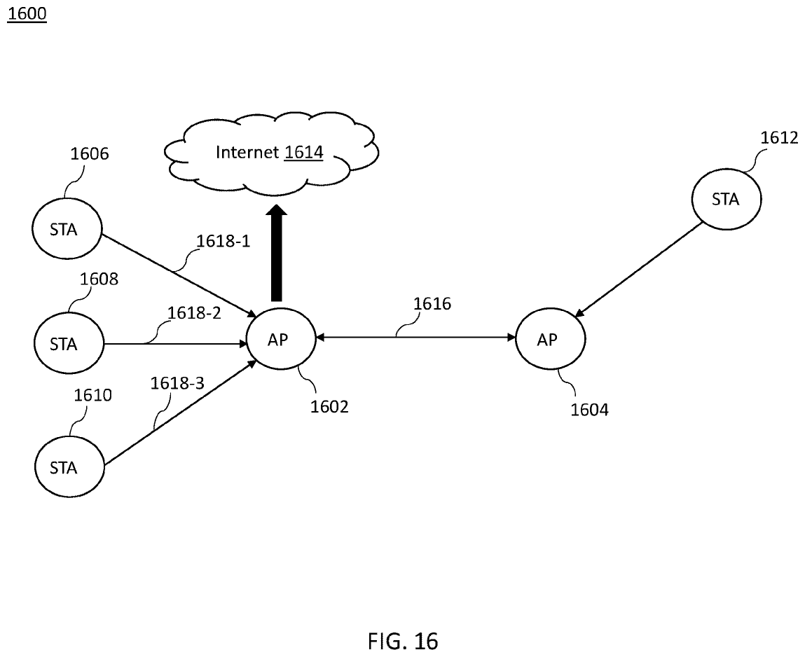

FIG. 16 depicts example 1600 of a Wi-Fi sensing network implemented by as a mesh network (which in example may be an Easy Mesh network), according to some embodiments. In particular, FIG. 16 depicts an example of a Wi-Fi sensing network that is realized by APs and STAs.

In the example of FIG. 16, the Wi-Fi sensing network includes two APs including AP 1602 and AP 1604. The Wi-Fi sensing network also includes four STAs including STA 1606, STA 1608, STA 1610, and STA 1612. In examples, AP 1602 may be connected with Internet 1614. As can be seen in FIG. 16, AP 1604 is not directly connected to Internet 1614. In the example shown in FIG. 16, there is a wireless backhaul link (represented by reference number “1616”) between AP 1602 and AP 1604 that may be used by the Wi-Fi sensing network as a channel over which Wi-Fi sensing may be carried out. In the example of FIG. 16, STA 1606, STA 1608, and STA 1610 may communicate with AP 1602 via wireless fronthaul links (represented by reference numbers “1618-1”, “1618-2”, and “1618-3”). In examples, either AP (i.e., AP 1602 or AP 1604) may execute a sensing algorithm and determine a sensing result, and in examples may communicate a sensing result to a consumer. To reduce network overhead (e.g., to minimize wireless transmissions in the Wi-Fi network), the AP performing the sensing algorithm processing may be determined to be a sensing receiver, since the AP performing the sensing algorithm processing will utilize CSI information which is determined in a sensing receiver. It the AP performing the sensing algorithm is a sensing receiver, then over-the-air reporting of CSI (which can be large) may be minimized.

The present disclosure describes a system and a method to determine an optimum sensing session setup for a wireless backhaul link for improved Wi-Fi network performance. According to an implementation, determination of the optimum sensing session setup may be made in terms of allocation of sensing roles, for example, a sensing initiator role, a sensing responder role, a sensing transmitter role, and a sensing receiver role to APs at either side of the wireless backhaul link. In examples, a decision criterion for the allocation of roles to the APs at either side of the wireless backhaul link may be based on a model or an algorithm that distributes computational requirements of generation of a sensing result between the APs. In an example, there may be a first AP at one side of a backhaul link and a second AP at the other side of the backhaul link, and AP congestion may be determined for the first AP and the second AP. In examples, if the first AP is determined to have a large value for AP congestion and the second AP is determined to have a small value for AP congestion, then the second AP may be selected as a sensing receiver for the wireless backhaul link. Accordingly, the second AP may be responsible for processing of the sensing measurement of the backhaul link, and the first AP may be responsible for transmitting a sensing transmission to the second AP. This selection of roles of the first AP and the second AP may allow the use of available computational resources available on the second AP which may be otherwise unused. By the same measure, this selection of roles of the first AP and the second AP may reduce the likelihood of overloading computational resources of the first AP.

In examples, for an optimum sensing session setup, it must first be determined that the backhaul link is a reciprocal backhaul link.

According to an implementation, determination of the optimum sensing session setup may be carried out by a networking device configured to operate as an AP within a mesh network. In examples, the AP may be sensing receiver 502-1. In an implementation, AP reciprocity determination agent 523-1 may identify a candidate reciprocal AP with which the AP has a reciprocal wireless backhaul link. In an example, the reciprocal wireless backhaul link may be understood as a backhaul link. In examples, the candidate reciprocal AP may be sensing receiver 502-2. According to some implementations, the AP may be sensing transmitter 504-1 and the candidate reciprocal AP may be sensing transmitter 504-2.

Examples by which AP reciprocity determination agent 523-1 (where the AP assumes the role of sensing receiver 502-1) or AP reciprocity determination agent 543-1 (where the AP assumes the role of sensing transmitter 504-1) identifies a reciprocal AP with which the AP has the reciprocal wireless link are described in detail below.

In an implementation, the AP may act as sensing transmitter 504-1 and may transmit, via a transmitting antenna (for example, transmitting antenna 532-1), a first sensing transmission to a candidate reciprocal AP acting as a sensing receiver 502-1. In response to receiving the first sensing transmission via receiving antenna 514-1, the candidate reciprocal AP may make a first sensing measurement on the first sensing transmission. The candidate reciprocal AP may then send the first sensing measurement to the AP. In an implementation, the AP may receive, via a receiving antenna (for example, receiving antenna 534-1), the first sensing measurement made on the first sensing transmission.

According to an implementation, the candidate reciprocal AP may act as a sensing transmitter 504-1, and may transmit a second sensing transmission, via transmitting antenna 532-1 to the AP acting as a sensing receiver 502-1. In an implementation, the AP may receive, via receiving antenna 514-1, the second sensing transmission from the candidate reciprocal AP. In response to receiving the second sensing transmission, the AP may generate a second sensing measurement based on the second sensing transmission. In an implementation, the AP may compare the first sensing measurement to the second sensing measurement. Responsive to the comparing, the AP may identify the candidate reciprocal AP as having a reciprocal wireless link (i.e., it is determined that the backhaul link is reciprocal). In an example implementation, AP reciprocity determination agent 523-1 or AP reciprocity determination agent 543-1 may compare the first sensing measurement to the second sensing measurement. Further, based on the comparison, AP reciprocity determination agent 523-1 or AP reciprocity determination agent 543-1 may identify the candidate reciprocal AP as having a reciprocal wireless link. In examples, a candidate reciprocal AP that is determined as having a reciprocal wireless link with the AP may be referred to as a reciprocal AP. In examples, AP 1602 may initiate the determination of the reciprocal backhaul link, and AP 1602 may be referred to as AP and AP 1604 may be referred to as reciprocal AP. In examples, AP 1604 may initiate the determination of the reciprocal backhaul link, and AP 1604 may be referred to as AP and AP 1602 may be referred to as reciprocal AP.

Referring again to FIG. 5, in an implementation, AP reciprocity determination agent 523-1 or AP reciprocity determination agent 543-1 may determine if the first sensing measurement and the second sensing measurement are identical or nearly identical. According to an implementation, AP reciprocity determination agent 523-1 may determine a similarity between the first sensing measurement and the second sensing measurement based on a similarity threshold. In an example, the similarity threshold may be preconfigured or predefined, for example, by a system administrator. In an example, the similarity threshold may be 95 percent. In an implementation, where the similarity of the first sensing measurement and the second sensing measurement exceeds the similarity threshold, then the first sensing measurement and the second sensing measurement may be determined to be the same. As a result, the channel may be determined to be reciprocal.

In examples, each of the first sensing measurement and the second sensing measurement may be channel state information (CSI) and may include many frequency domain pulses. In some examples, each of the first sensing measurement and the second sensing measurement may be time domain channel representation information (TD-CRI) and may include many time domain pulses. In an implementation, to determine whether the first sensing measurement and the second sensing measurement are identical or nearly identical, each of the many frequency domain pulses or each of the many time domain pulses may be compared one by one. The measured value of the each of the many frequency domain pulses or each of the many time domain pulses to the first sensing measurement and second sensing measurement may be subtracted from each other to determine a residual difference between them. In examples, the measured value of the frequency domain pulses or the time domain pulses may be complex i.e., may include in-phase and quadrature phase components, or amplitude and phase components. In an implementation, AP reciprocity determination agent 523-1 or AP reciprocity determination agent 543-1 may perform summation of all residual differences (i.e., the differences across all frequency domain pulses or all time domain pulses) to determine an overall residual difference and this overall residual difference may form the metric for determination that the first sensing measurement and the second sensing measurement are identical or nearly identical.

In some examples, an amplitude profile of all frequency domain pulses or all time domain pulses that make up the first sensing measurement and the second sensing measurement may be derived and a regression analysis of the first sensing measurement and the second sensing measurement may be carried out. In an example, an nth order regression may be made to the amplitude profile (where n may be linear, quadratic, cubic, or any other order that may be appropriate). In some examples, the regression analysis may include multiple regressions with different values of n to determine the best fit. The parameters of the regression (for example, a linear parameter, a quadratic parameter, a cubic parameter, etc.) which are determined by the regression analysis of the first sensing measurement and the second sensing measurement may be compared to determine the similarity of the first sensing measurement and the second sensing measurement. In an example, the parameter of each order of the regression of the first sensing measurement and the second sensing measurement may be differenced to determine a residual difference. In examples, the residual difference may be summed to form an overall residual difference which forms the metric for determination that the first sensing measurement and the second sensing measurement are identical or nearly identical.

In some examples, the order of sensing transmissions and the location of the comparison of sensing measurements may be varied between the AP and the reciprocal AP. However, the general features of the given example, i.e., a trigger-based measurement in one direction and a non-trigger-based measurement in the opposite direction, the transfer of one sensing measurement to the other AP via a message such as a sensing measurement report, the comparison of sensing measurements on a single AP, may be consistent in those other examples. The reciprocity of the channel may then be used as an input into the determination (or creation) of an optimum sensing measurement setup.

According to an implementation, after identifying the reciprocal AP as having the reciprocal wireless link, AP metrics determination agent 524-1 or AP metrics determination agent 544-1 may be configured to determine a first AP role determination metric associated with the AP. In examples, the first AP role determination metric may be determined according to a first AP bandwidth metric, a first computational metric, and a first over the air (OTA) metric of the AP. Examples by which AP metrics determination agent 524-1 or AP metrics determination agent 544-1 determines the first AP role determination metric associated with the AP are described in detail below.

According to an implementation, AP metrics determination agent 524-1 or AP metrics determination agent 544-1 may initially determine a first AP congestion metric. The first AP congestion metric may represent the AP congestion at a time instance. In examples, AP congestion is the usage of computational resources of an AP. A lower AP congestion metric may indicate lower AP congestion on an AP. In examples, the AP congestion metric may be a numerical scale (for example, integers between 1 and 10). In some examples, the AP congestion metric may be a binary scale (for example, 0 or 1). In examples, an AP with a lower AP congestion metric may be better suited for some Wi-Fi sensing roles over others and the allocation of Wi-Fi sensing roles may depend on AP congestion metrics. Aspects of a Wi-Fi network or a Wi-Fi sensing network which contribute to AP congestion (or the first AP congestion metric) are described below.

In examples, a contribution to AP congestion may be the number of associated stations to the AP. A number of associated STAs metric may reflect this contribution. According to an implementation, AP metrics determination agent 524-1 or AP metrics determination agent 544-1 may determine the first AP congestion metric based on a number of associated STAs metric. In examples, the number of associated STAs metric may be determined according to a number of stations associated with the AP scaled by respective levels of activity on the stations. In an implementation, AP metrics determination agent 524-1 or AP metrics determination agent 544-1 may determine the number of associated stations in a time interval by summing the number of associations managed by the AP. According to an implementation, AP metrics determination agent 524-1 or AP metrics determination agent 544-1 may scale an association between the AP and an associated station by a scaling value based on measured activity on the station. In an example, AP metrics determination agent 524-1 or AP metrics determination agent 544-1 may determine the measured activity based on the number of data, management, and/or control frames received and transmitted between the AP and the associated station. In some implementations, AP metrics determination agent 524-1 or AP metrics determination agent 544-1 may determine the scaling value based on a frame profiling tool (or a profiling operation) running on the AP, the associated station, or on a third device. In an example, the associated station may be in an idle mode or a sleep mode. As a result, AP metrics determination agent 524-1 or AP metrics determination agent 544-1 may allot a low scaling value to the association between the AP and the associated station. In some implementations, AP metrics determination agent 524-1 or AP metrics determination agent 544-1 may determine a transmission/reception priority based on an access category of the AP to a station. In examples, voice and video may be given the highest priority and a station which is operating with this access category may be allocated a high scaling value which reflects a greater computation overhead (computational load value) associated with the high priority traffic.

In examples, another contribution to the AP congestion may be the bandwidth of sensing or non-sensing transmissions that the AP is managing. An AP bandwidth metric may reflect the total bandwidth of associated stations to the AP. According to an implementation, AP metrics determination agent 524-1 or AP metrics determination agent 544-1 may determine a first AP bandwidth metric. In examples, the first AP bandwidth metric may be based on a total bandwidth allocated to stations associated with the AP. In an example implementation, to determine the first AP bandwidth metric, the negotiated bandwidth of all associated stations in active communication with the AP may be used. In one scenario, stations that are in an idle mode but are associated with the AP may be assigned a minimum allocatable bandwidth for the purposes of determining the first AP bandwidth metric. The minimum allocatable bandwidth may be determined based on capabilities of the AP. In the example of FIG. 16, the minimum allocatable bandwidth may be 20 MHz. In an example, if AP 1602 is associated with three stations including STA 1606, STA 1608, and STA 1610, and STA 1606 is allocated 20 MHz bandwidth, and STA 1608 and STA 1610 are allocated 80 MHz bandwidth each, then the first AP 1602 bandwidth metric may be the sum of all allocated bandwidth (i.e., 180 MHz). In an example, the first AP bandwidth metric may be normalized by a normalization factor. For example, the first AP bandwidth metric may be normalized by the maximum available bandwidth per station supported by the AP. In an example, the maximum available bandwidth per station supported by the AP may be 80 MHz. In this case, the total maximum bandwidth is 240 MHz, and the normalization factor is 240. In the example, the normalized AP bandwidth metric may be 0.75 (180/240=0.75). In another scenario, STA 1610 may be in an idle mode and may be assigned a minimum allocatable bandwidth value of 20 MHz. In this example, the first AP bandwidth metric may be 120 MHz and the normalized AP bandwidth metric may be 0.51 (120/240=0.5063). In some implementations, the first AP bandwidth metric may be modified by a scaling value based on an access category of the AP to a station. In examples, voice and video may be given the highest priority, and a station which is operating with this access category may be allocated a high scaling value which reflects a greater computation overhead (computational load value) associated with the high priority traffic.

According to an implementation, AP metrics determination agent 524-1 or AP metrics determination agent 544-1 may determine the first AP bandwidth metric according to orthogonal frequency-division multiple access (OFDMA) activity of stations associated with the AP. In examples, where uplink OFDMA (UL-OFDMA) is being used by stations to communicate with the AP, either for Wi-Fi sensing or for data communications, the configuration of the stations at the time of the sensing transmission may contribute to the AP congestion. In examples, UL-OFDMA may cause AP congestion to increase due to an increase in computation load associated with making a sensing measurement from a partial-band sensing transmission (i.e., a sensing transmission made using UL-OFDMA). In an example, when a single transmission opportunity (TXOP) in an allocated bandwidth is shared between many stations using UL-OFDMA, then the number of stations may cause an adjustment to the first AP bandwidth metric. This reflects that the processing of the allocated bandwidth may require a higher computational load and may contribute more greatly to AP congestion. In an example, the first AP bandwidth metric may be scaled by a value that reflects the number of stations that share the allocated bandwidth. An example of a look-up table for scaling factors of stations sharing the bandwidth is described in Table 1 provided below.

TABLE 1
Examples of a look-up table for scaling factors
of STAs sharing bandwidth with UL-OFDMA

| Number of stations | |
|---|---|
| sharing a bandwidth | Scaling Factor |
| 2 | 1.05 |
| 3 | 1.1 |
| 4 | 1.2 |
| 5 | 1.5 |
| 6 | 1.7 |
| . | . |
| . | . |
| . | . |
| 10 | 2.5 |

In an example, the scaling factor may be determined a priori based on the implementation of UL-OFDMA by the AP and may be stored as a value in the look-up table (for example, Table 1) included within the AP or in the Wi-Fi sensing network. In an implementation, the look-up table may be stored in metrics data storage 526-1 or metrics data storage 546-1. According to an implementation, AP metrics determination agent 524-1 or AP metrics determination agent 544-1 may access the look-up table stored in metrics data storage 526-1 or metrics data storage 564-1 whenever the first AP bandwidth metric is to be determined.

In examples, the scaling factor may increase linearly with the number of stations which are sharing the bandwidth and may be calculated as a function of the number of stations based on Equation (9) provided below

$$scaling factor = 1 + \frac{{N}_{S T A}}{10} \qquad ( 9 )$$

In some implementations, another non-linear, but deterministic model may be used to determine the scaling factor.

According to an implementation, AP metrics determination agent 524-1 or AP metrics determination agent 544-1 may determine a first computational metric of the AP. In an implementation, AP metrics determination agent 524-1 or AP metrics determination agent 544-1 may determine processes which are executing on the AP. Examples of processes may include, but are not limited to, a sensing algorithm, a sensing initiation, a Wi-Fi ranging operation, and a mesh network controller. In examples, AP metrics determination agent 524-1 or AP metrics determination agent 544-1 may allocate a computational load value to each process which is executing on the AP. In examples, the computational load value may be measured by a profiling operation. In some examples, the computational load value may be allocated by a look-up operation from a database (for example, metrics data storage 526-1 or metrics data storage 546-1) that stores computational load values for processes which have been determined a priori.

In an example, processes in a Wi-Fi sensing system may be assigned different computational load values. These computational load values may be used to define the first computational metric for each AP. For example, the processing of a sensing measurement from a station may be assigned one computational load value, the processing of a sensing measurement between APs over a backhaul link may be assigned a different computational load value, and the processing of sensing measurements into a sensing result may be assigned a yet another computational load value.

According to an implementation, AP metrics determination agent 524-1 or AP metrics determination agent 544-1 may determine the first computational metric of the AP based on performing a summation of the individual computational load values assigned to the processes running on the AP. In some examples, AP metrics determination agent 524-1 or AP metrics determination agent 544-1 may determine computational load values only for major Wi-Fi processes such as a sensing algorithm or a mesh network controller. In examples, the residual AP congestion for normal operation of the AP may be considered to be a fixed, standard value.

In an implementation, AP metrics determination agent 524-1 or AP metrics determination agent 544-1 may determine a first OTA metric of the AP. In examples, the first OTA metric may be determined according to a space metric, and a hops metric. In an example, the hops metric may be equal to a number of wireless links between the AP and an internet connected AP. Further, the space metric may be based on a location and visibility of the AP. Examples by AP metrics determination agent 524-1 or AP metrics determination agent 544-1 determines the first OTA metric of the AP are described in detail below.

In some sensing networks (for example, a mesh network where APs may act as relays to relay a station to the Internet), not all APs are connected to the Internet. In some situations, a sensing algorithm may execute on a device or a Cloud service which is not within the Wi-Fi sensing network and may be accessed by the Wi-Fi sensing network over the Internet. In these situations, sensing measurements are transferred outside the Wi-Fi sensing network, and the transfer may be carried out by at least one AP with a connection to the Internet. In some examples, the connection between an AP and the Internet may be a wired link. In other examples, the connection between an AP and the Internet may be a wireless link.

In examples, transmission of the sensing measurement between APs which are not connected to the Internet imposes an overhead on the network transmission within the Wi-Fi sensing network. To minimize this overhead, the Wi-Fi sensing network may determine which APs are configured to be connected to the Internet, and whether their connection to the Internet is a wired link or a wireless link. Based on this information, over the air transmission of sensing measurements may be minimized. According to an implementation, AP metrics determination agent 524-1 or AP metrics determination agent 544-1 may determine an internet connected AP in order to determine the first OTA metric.

Further, in examples, a sensing receiver which is optimal based on minimization of over the air transmission of sensing measurements may not be optimal based on the requirements of the Wi-Fi sensing network (the sensing goal). In an example, the AP with the most direct connection to the Internet may have poor visibility of the sensing space. Therefore, AP metrics determination agent 524-1 or AP metrics determination agent 544-1 may determine the space metric that considers the location and the visibility of the AP. Further, AP metrics determination agent 524-1 or AP metrics determination agent 544-1 may determine the hops metric based on hops required to access the Internet. In an implementation, AP metrics determination agent 524-1 or AP metrics determination agent 544-1 may process the space metric and the hops metric to determine the first OTA metric.

In some implementations, AP metrics determination agent 524-1 or AP metrics determination agent 544-1 may determine a map of a mesh network. The map may identify the connection of AP device to AP device and may also show the AP device (or AP devices) which is connected to the Internet and the manner in which it is connected to the Internet (i.e., wired or wireless). In examples, the map may be used to determine the hops metric. In an example, a wireless link between APs may be allocated a hop value of 1. In some examples, a wired link may be allocated a hop value of 0. In other examples, a wired link may be allocated a small value (e.g., 0.2) to reflect that even though the link requires no OTA transmission, it is still a hop. In examples, the hops metric may be calculated as the sum of hop values of the shortest possible route from an AP to the Internet. In examples, there may be only one possible route from an AP to the Internet and the hops metric is the sum of the hop values of this route.

In an example, the map of the mesh network may include location data for each AP in the Wi-Fi network. The location of each AP may be determined by any means and may include configuration by a system administrator (for example, via a Web interface) or may be inferred from a device hostname or proximity to other devices in known locations. The map of the mesh network may be overlayed with a map of the sensing space in which the Wi-Fi network is implemented. In examples, this overlay may represent the physical layout of the sensing space or may include data on obstacles and obstructions in the sensing space. In examples, the data may reflect an attenuating factor to Wi-Fi signals that the obstacles and obstructions may impart. In examples, a high attenuating factor may be assigned to an obstacle such as a stone wall, but a medium attenuating factor may be assigned to a wooden floor. The attenuating factor may take into account the antenna structure of the AP device and may increase an attenuation factor if, for example, the antennas are not optimized to transmit in the vertical plane (for example, between floors of a house). The map of the mesh network, including attenuating factors due to obstacles and obstructions, may allow the calculation of the space metric. In examples, where an AP has many obstructions and a high total attenuation factor towards another AP, the space metric may be high space metric. Further, in examples, where an AP is well-located in the sensing space, then the space metric may be a low space metric.

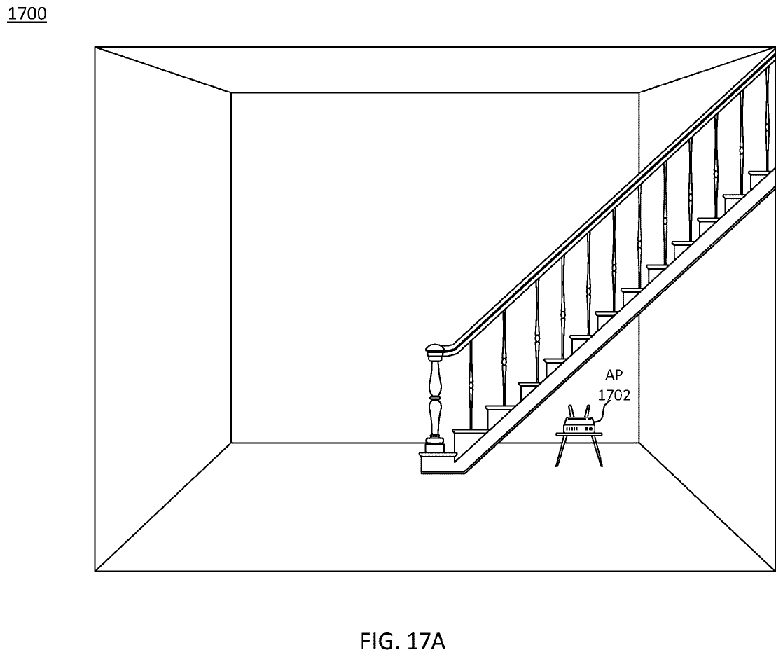

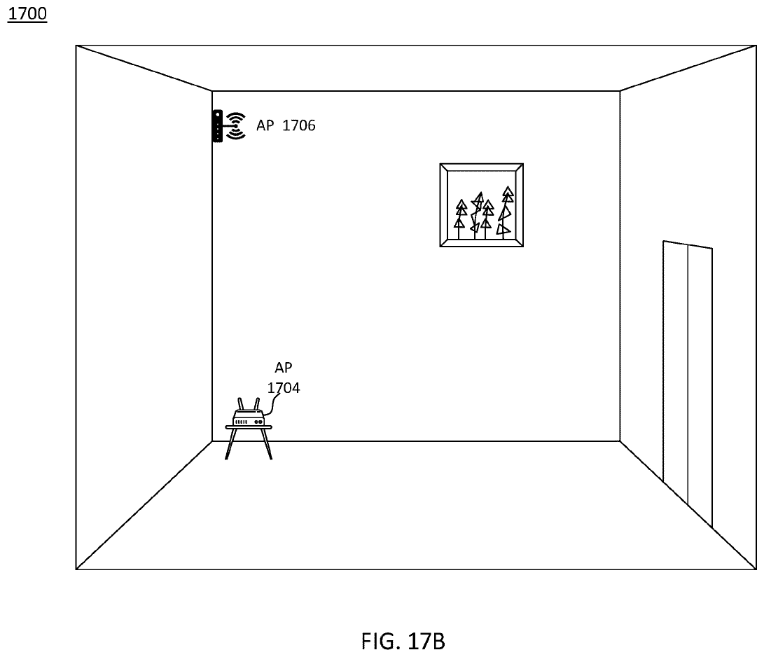

FIG. 17A and FIG. 17B depict example 1700 of a high space metric and a low space metric for an AP, according to some embodiments.

In the example shown in FIG. 17A, the AP (represented by reference number “1702”) is located in a poor location (i.e., under the stairs) with poor visibility. Since the AP has an obstruction (i.e., the stairs), the space metric for the AP may be a high space metric. Further, in the example shown in FIG. 17B, the AP (represented by reference number “1704”) is located in a location with good visibility (i.e., in a corner of a room with nothing obstructing its sensing space). Since the AP is well-located in the sensing space, the space metric for the AP may be a low space metric.

In examples, a poor location for an AP may result in data retransmissions in the Wi-Fi network which may increase AP congestion based on the processing of these retransmissions. As a result, a high space metric may cause a modification to other AP congestion metrics to model this effect. In an example, the space metric may be scaled into a modifier value between 1 and 5 which may be used to modify the number of associated stations. In the example, the highest space metric may be mapped to the value of 5, meaning that each associated station to a poorly placed AP may be considered to be equivalent to 5 stations due to retransmissions and inefficiency. In the same example, the lowest space metric may be mapped to the value of 1, meaning that each associated station to a well-placed AP may be considered to be equivalent to only 1 station, as expected.

In an example, it may be assumed that there is a backhaul link between an AP1 (for example AP 1702) and an AP2 (for example AP 1704), and AP1 1702 is connected to Internet but is located behind an object which obstructs its visibility (has a high space metric). In examples, while AP2 1704 has good visibility (has a low space metric), it is not connected to the Internet. In an example, AP2 1704 is connected via a wireless backhaul connection to another AP (for example, an AP3 1706) and AP3 is connected to the Internet. In the example of FIG. 17, a high space metric may be assigned to AP1 (poor visibility) while its hops metric may be given a value of 1, as it is connected to the Internet. In this example, AP2 may be assigned a low space metric (good visibility) while its hops metric may be given a value of 2, as it is not directly connected to the Internet but has a backhaul connection to an AP that is connected to the Internet. In examples, AP metrics determination agent 524-1 or AP metrics determination agent 544-1 may process these hops metric values and calculate an OTA metric for an AP. In an example, an AP with a lower OTA metric may be more suited to take on the role of a sensing receiver 502-1.

According to an implementation, an AP role determination metric may be determined for the reciprocal AP (for example, in the role of sensing receiver 502-2 or in the role of sensing transmitter 504-2). For instance, AP metrics determination agent 524-1 (if reciprocal AP is in the role of sensing receiver 502-2) or AP metrics determination agent 544-1 (if reciprocal AP is in the role of sensing transmitter 504-2) may be configured to determine a second AP role determination metric associated with the reciprocal AP. According to an implementation, AP metrics determination agent 524-1 or AP metrics determination agent 544-1 may determine the second AP role determination metric according to a second AP bandwidth metric, a second computational metric, and a second OTA metric. In some implementations, AP metrics determination agent 524-1 or AP metrics determination agent 544-1 may send the second AP role determination metric to the AP.

As described earlier, the first AP role determination metric may be determined according to the first AP bandwidth metric, the first computational metric, and the first over the air (OTA) metric of the AP. In examples, a combination of the first AP bandwidth metric, the first computational metric, and the first OTA metric may be used to determine the optimum sensing session setup if all metrics have similar suitability criteria. The combination of metrics may be referred to as a combined AP role determination metric. In some examples, the individual metrics may not have similar suitability criteria, for example an AP which has poor visibility (high space metric), even if it has a good hops metric, may not be selected as a sensing receiver.

In examples, the first AP role determination metric may be a combined AP role determination metric determined according to a first combination of at least two of a first AP bandwidth metric, a first computational metric, and a first OTA metric. In an implementation, a weighting factor may be applied to one or more individual metrics before it is used in combination with one or more different individual metrics in a combined AP role determination metric. In examples, the weighting factor may act to emphasize one individual metric over another (high weighting versus low weighting). Likewise, a combination of the second AP bandwidth metric, the second computational metric, and the second OTA metric may be used to determine the optimum sensing session setup if all these metrics have similar suitability criteria. In examples, the second AP role determination metric may be a combined AP role determination metric determined according to a second combination of at least two of a second AP bandwidth metric, a second computational metric, and a second OTA metric. In examples, the first combination and the second combination are weighted combinations.

According to an implementation, role determination and role allocation agent 525-1 may be configured to receive the second AP role determination metric associated with the reciprocal AP from the reciprocal AP, for example, over a Wi-Fi data link or by other means. In an implementation, role determination and role allocation agent 525-1 (if the AP assumes the role of sensing receiver 502-1) or role determination and role allocation agent 545-1 (if the AP assumes the role of sensing transmitter 504-1) may be configured to compare the first AP role determination metric to the second AP role determination metric. Further, role determination and role allocation agent 525-1 or role determination and role allocation agent 545-1 may be configured to determine sensing roles for the AP and the reciprocal AP based on the comparison of the first AP role determination metric and the second AP role determination metric.

In an implementation, role determination and role allocation agent 525-1 or role determination and role allocation agent 545-1 may be configured to allocate a first sensing role to the AP based on the comparing. In an example, the first sensing role may be a sensing receiver role 502-1. In an example, role determination and role allocation agent 525-1 or role determination and role allocation agent 545-1 may assign the sensing receiver role to the AP based on the comparing. According to an implementation, role determination and role allocation agent 525-1 or role determination and role allocation agent 545-1 may allocate a second sensing role to the reciprocal AP based on the comparing. In an example, the second sensing role may be a sensing transmitter role 504-1.

In examples, role determination and role allocation agent 525-1 or role determination and role allocation agent 545-1 allocates the first sensing role to the AP and the second sensing role to the reciprocal AP to manage the backhaul link between the AP and the reciprocal AP in the Wi-Fi sensing network. In examples, the allocation of sensing roles may be based on the ability of the AP and the reciprocal AP to execute the respective roles. According to an implementation, role determination and role allocation agent 525-1 or role determination and role allocation agent 545-1 may act to distribute AP congestion in the Wi-Fi sensing network and to balance the computational load on the AP and the reciprocal AP.

In an example, a sensing receiver 502-1 may calculate a sensing measurement based on a sensing transmission from a sensing transmitter 504-1. The calculation of the sensing measurement may be a computationally intensive process and so a sensing receiver role for a backhaul link may be suited to an AP which has a low combined AP role determination metric. In another example, many backhaul links between combinations of APs may be required to measure the sensing space and it may be beneficial to have a single sensing receiver and multiple sensing transmitters to minimize the OTA transmission to determine the sensing result. In examples, this requirement may be reflected in the weighting of the AP role determination metrics where the hops metric may be weighted more than the computational metric.

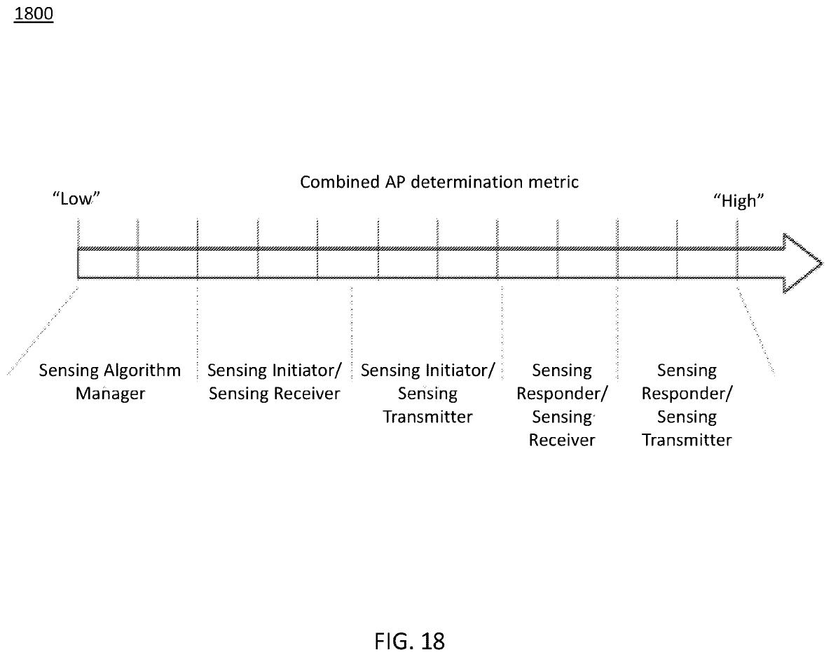

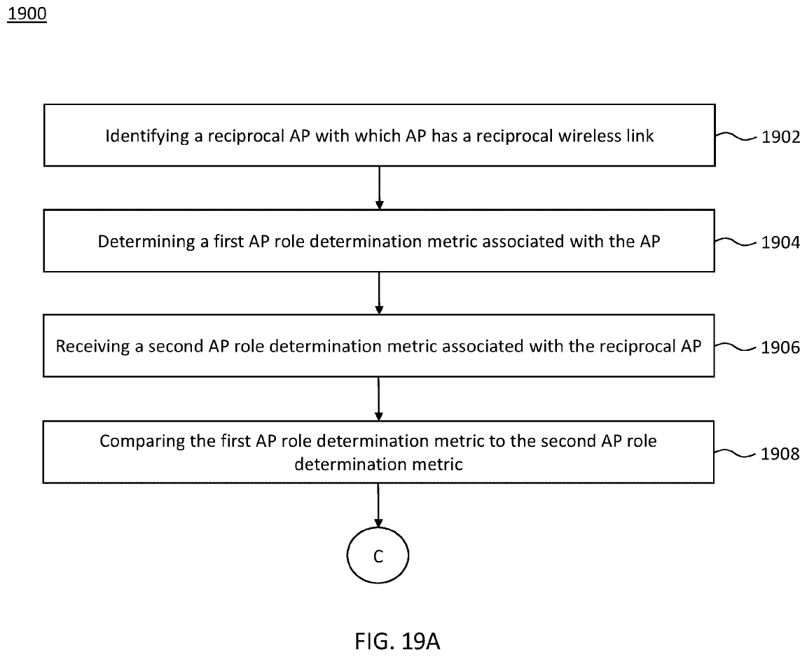

FIG. 18 depicts example 1800 of allocation of sensing roles based on a combined AP determination metric, according to one or more embodiments.

In an example, the range of combined AP role determination metrics may be mapped to sensing roles. An example mapping is shown in FIG. 18. In the example shown in FIG. 18, each sensing role is allocated to a separate range of combined AP determination metric values. In some examples, there may be overlap at the edge of a band where a single value of combined AP determination metric may map to more than one combination of sensing roles.

According to an implementation, after role determination and role allocation agent 525-1 or role determination and role allocation agent 545-1 has determined or allotted the sensing roles for the AP and the reciprocal AP, role determination and role allocation agent 525-1 or role determination and role allocation agent 545-1 may communicate the sensing roles to the AP and the reciprocal AP. In an example, role determination and role allocation agent 525-1 or role determination and role allocation agent 545-1 may communicate the sensing roles to the AP and the reciprocal AP via a data message. In some examples, role determination and role allocation agent 525-1 or role determination and role allocation agent 545-1 may communicate the sensing roles to the AP and the reciprocal AP via a Sensing Measurement Setup frame.

In examples, depending on the allocated sensing role to the AP, a suitable form of sensing transmission may be selected to make the sensing measurement. The sensing measurement may made over a backhaul link. In an implementation, role determination and role allocation agent 525-1 or role determination and role allocation agent 545-1 may determine to use a trigger based protocol or a non-trigger based protocol according to the first sensing role and the reciprocal wireless link. In an example, where the AP is allocated a sensing initiator role and a sensing receiver role, then a trigger based sensing transmission may be used where a Trigger frame triggers the sensing responder/sensing transmitter to make a sensing transmission. In an example, an NDP frame constitutes the sensing transmission. Further, in examples, where the AP is allocated a sensing initiator role and a sensing transmitter role, then a non-trigger based sensing transmission may be used where a sensing transmission is sent and received by one or more sensing receivers. In an example, an NDP frame constitutes the sensing transmission. In examples, the one or more sensing receivers (acting as a sensing responder) may make a sensing measurement on the sensing transmission and the sensing measurement may be transferred back to the sensing initiator in a sensing measurement report frame. In examples, the transmission of the sensing measurement report frame may be triggered by a Trigger frame from the sensing initiator to the sensing responder.

FIG. 19A and FIG. 19B depict flowchart 1900 for allocating a first sensing role to an AP and a second sensing role to a reciprocal AP based on a comparison of a first AP role determination metric and a second AP role determination metric, according to some embodiments. In an implementation, flowchart 1900 may be carried out by a networking device configured to operate as an AP (for example, sensing receiver 502-1 or sensing transmitter 504-1) within a mesh network.

In a brief overview of an implementation of flowchart 1900, at step 1902, a reciprocal AP (for example, sensing receiver 502-2 or sensing transmitter 504-2) with which the AP has a reciprocal wireless link may be identified. At step 1904, a first AP role determination metric associated with the AP may be determined. At step 1906, a second AP role determination metric associated with the reciprocal AP may be received by the AP. At step 1908, the first AP role determination metric may be compared to the second AP role determination metric. At step 1910, a first sensing role may be allocated to the AP based on the comparing. At step 1912, a second sensing role may be allocated to the reciprocal AP based on the comparing.

Step 1902 includes identifying a candidate reciprocal AP with which AP has a reciprocal wireless link. According to an implementation, sensing receiver 502-1 may be configured to identify the candidate reciprocal AP with which the AP has the reciprocal wireless link. According to some implementations, identifying the candidate reciprocal AP includes transmitting a first sensing transmission to the candidate reciprocal AP, receiving a first sensing measurement made on the first sensing transmission, receiving a second sensing transmission from the candidate reciprocal AP, generating a second sensing measurement based on the second sensing transmission, comparing the first sensing measurement to the second sensing measurement, and responsive to the comparing, identifying the candidate reciprocal AP as a reciprocal AP having a reciprocal wireless link. According to some implementations, identifying the candidate reciprocal AP includes transmitting a Sensing Sounding Trigger frame to the candidate reciprocal AP, receiving a first sensing transmission from the candidate reciprocal AP, generating a first sensing measurement based on the first sensing transmission, transmitting a second sensing transmission to the candidate reciprocal AP, receiving a second sensing measurement based on the second sensing transmission, comparing the first sensing measurement to the second sensing measurement, and responsive to the comparing, identifying the candidate reciprocal AP as a reciprocal AP having a reciprocal wireless link.

Step 1904 includes determining a first AP role determination metric associated with the AP. According to an implementation, sensing receiver 502-1 may be configured to determine the first AP role determination metric associated with the AP. In an implementation, determining the first AP role determination metric includes determining a first AP congestion metric. In examples, determining the first AP congestion metric is based on a number of associated STAs metric. In examples, the number of associated STAs metric may be determined according to a number of stations associated with the AP scaled by respective levels of activity on the stations. In some implementations, determining the first AP role determination metric may be based on a first AP bandwidth metric. In examples, the first AP bandwidth metric may be determined according to orthogonal frequency-division multiple access (OFDMA) activity of stations associated with the AP. In an example, the first AP bandwidth metric is based on a total bandwidth allocated to stations associated with the AP. In some implementations, determining the first AP role determination metric may be based on a first computational metric of the AP. Further, in some implementations, determining the first AP role determination metric may be based on a first over the air (OTA) metric of the AP. In examples, the first OTA metric may be determined according to a space metric and a hops metric. In an example, the hops metric may be equal to a number of wireless links between the AP and an internet connected AP. Further, in an example, the space metric may be based on a location and visibility of the AP. According to an implementation, the first AP role determination metric may be determined according to the first AP bandwidth metric, the first computational metric, and the first OTA metric.

Step 1906 includes receiving a second AP role determination metric associated with the reciprocal AP. According to an implementation, sensing receiver 502-1 may be configured to receive the second AP role determination metric associated with the reciprocal AP. In examples, sensing receiver 502-1 may be configured to receive the second AP role determination metric from sensing transmitter 504-2.

Step 1908 includes comparing the first AP role determination metric to the second AP role determination metric. According to an implementation, sensing receiver 502-1 may be configured to compare the first AP role determination metric to the second AP role determination metric. According to an implementation, the first AP role determination metric may be a combined AP role determination metric determined according to a first combination of at least two of the first AP bandwidth metric, the first computational metric, and the first OTA metric. Further, according to an implementation, the second AP role determination metric may be a combined AP role determination metric determined according to a second combination of at least two of a second AP bandwidth metric, a second computational metric, and a second OTA metric. In examples, the first combination and the second combination may be weighted combinations.

Step 1910 includes allocating a first sensing role to the AP based on the comparing. According to an implementation, sensing receiver 502-1 may be configured to allocating the first sensing role to the AP based on the comparing. In examples, the first sensing role may be a sensing receiver role and allocating the first sensing role to the AP includes assigning the sensing receiver role to the AP based on the comparing. According to some implementations, sensing receiver 502-1 may determine to use a trigger based WLAN sensing protocol or a non-trigger based WLAN sensing protocol according to the first sensing role and the reciprocal wireless link.

Step 1912 includes allocating a second sensing role to the reciprocal AP based on the comparing. According to an implementation, sensing receiver 502-1 may be configured to allocate the second sensing role to the reciprocal AP based on the comparing.

FIG. 20A, FIG. 20B, and FIG. 20C depict flowchart 2000 for identifying a reciprocal AP with which an AP has a reciprocal wireless link and allocating a first sensing role to the AP and a second sensing role to the reciprocal AP based on a comparison of a first AP role determination metric and a second AP role determination metric, according to some embodiments. In an implementation, flowchart 2000 may be carried out by a networking device configured to operate as an AP (for example, sensing receiver 502-1 or sensing transmitter 504-1) within a mesh network.

In a brief overview of an implementation of flowchart 2000, at step 2002, a first sensing transmission is transmitted to a reciprocal AP (for example, sensing receiver 502-2). At step 2004, a first sensing measurement may be made on the first sensing transmission. At step 2006, a second sensing transmission may be received from the reciprocal AP. At step 2008, a second sensing measurement may be generated based on the second sensing transmission. At step 2010, the first sensing measurement may be compared to the second sensing measurement. At step 2012, responsive to the comparing, the reciprocal AP may be identified as having a reciprocal wireless link with AP. At step 2014, upon identifying that the reciprocal AP has the reciprocal wireless link, a first AP role determination metric associated with the AP may be determined, where the first AP role determination metric is determined according to a first AP bandwidth metric, a first computational metric, and a first over the air (OTA) metric. Step 2016 includes receiving a second AP role determination metric associated with the reciprocal AP, where the second AP role determination metric is determined according to a second AP bandwidth metric, a second computational metric, and a second OTA metric. At step 2018, the first AP role determination metric may be compared to the second AP role determination metric. At step 2020, a first sensing role may be allocated to the AP based on the comparing. At step 2022, a second sensing role may be allocated to the reciprocal AP based on the comparing.

Step 2002 includes transmitting a first sensing transmission to a reciprocal AP. According to an implementation, AP acting as sensing transmitter 504-1 may be configured to transmit the first sensing transmission to the reciprocal AP. In an example, reciprocal AP may be sensing receiver 502-2. In an implementation, in response to receiving the first sensing transmission, the reciprocal AP may make a first sensing measurement on the first sensing transmission.

Step 2004 includes receiving the first sensing measurement made on the first sensing transmission. According to an implementation, AP acting as sensing transmitter 504-1 may be configured to receive the first sensing measurement made on the first sensing transmission from the reciprocal AP.

Step 2006 includes receiving a second sensing transmission from the reciprocal AP. According to an implementation, AP acting as sensing receiver 502-1 may be configured to receive the second sensing transmission from the reciprocal AP.

Step 2008 includes generating a second sensing measurement based on the second sensing transmission. According to an implementation, AP acting as sensing receiver 502-1 may be configured to generate the second sensing measurement based on the second sensing transmission.

Step 2010 includes comparing the first sensing measurement to the second sensing measurement. According to an implementation, AP as sensing receiver 502-1 may be configured to compare the first sensing measurement to the second sensing measurement.

Step 2012 includes responsive to the comparing, identifying the reciprocal AP as having a reciprocal wireless link with AP. According to an implementation, AP acting as sensing receiver 502-1 may be configured to, responsive to the comparing, identify the reciprocal AP as having the reciprocal wireless link with AP.

Step 2014 includes upon identifying that the reciprocal AP has the reciprocal wireless link, determining a first AP role determination metric associated with the AP, wherein the first AP role determination metric is determined according to a first AP bandwidth metric, a first computational metric, and a first over the air (OTA) metric. According to an implementation, AP acting as sensing receiver 502-1 may be configured to determine the first AP role determination metric associated with the AP upon identifying that the reciprocal AP has the reciprocal wireless link. In an implementation, AP acting as sensing receiver 502-1 may determine the first AP role determination metric according to the first AP bandwidth metric, the first computational metric, and the first OTA metric. According to an implementation, AP acting as sensing receiver 502-1 may determine the first AP bandwidth metric according to orthogonal frequency-division multiple access (OFDMA) activity of stations associated with the AP. In an example, the first AP bandwidth metric is based on a total bandwidth allocated to stations associated with the AP. In an implementation, AP acting as sensing receiver 502-1 may determine the first OTA metric according to a space metric and a hops metric. In an example, the hops metric may be equal to a number of wireless links between the AP and an internet connected AP. Further, in an example, the space metric may be based on a location and visibility of the AP.

Step 2016 includes receiving a second AP role determination metric associated with the reciprocal AP, wherein the second AP role determination metric is determined according to a second AP bandwidth metric, a second computational metric, and a second OTA metric. According to an implementation, AP acting sensing receiver 502-1 may be configured to receive the second AP role determination metric associated with the reciprocal AP from the reciprocal AP, where the second AP role determination metric is determined according to the second AP bandwidth metric, the second computational metric, and the second OTA metric

Step 2018 includes comparing the first AP role determination metric to the second AP role determination metric. According to an implementation, AP acting sensing receiver 502-1 may be configured to compare the first AP role determination metric to the second AP role determination metric. According to an implementation, the first AP role determination metric may be a combined AP role determination metric determined according to a first combination of at least two of the first AP bandwidth metric, the first computational metric, and the first OTA metric. Further, according to an implementation, the second AP role determination metric may be a combined AP role determination metric determined according to a second combination of at least two of a second AP bandwidth metric, a second computational metric, and a second OTA metric. In examples, the first combination and the second combination may be weighted combinations.

Step 2020 includes allocating a first sensing role to the AP based on the comparing. According to an implementation, AP acting as sensing receiver 502-1 may be configured to allocating the first sensing role to the AP based on the comparing. In examples, the first sensing role may be a sensing receiver role and allocating the first sensing role to the AP includes assigning the sensing receiver role to the AP based on the comparing. According to some implementations, AP acting as sensing receiver 502-1 may determine to use a trigger based protocol or a non-trigger based protocol according to the first sensing role and the reciprocal wireless link.

Step 2022 includes allocating a second sensing role to the reciprocal AP based on the comparing. According to an implementation, AP acting as sensing receiver 502-1 may be configured to allocate the second sensing role to the reciprocal AP based on the comparing.

In the method of FIG. 20A, FIG. 20B, and FIG. 20C, the AP may be a sensing initiator and the candidate reciprocal AP may be a sensing responder. In the example described above, the AP is described as acting in the role of sensing receiver 502-1, which candidate reciprocal AP is acting in the role of sensing transmitter 504-1. Without loss of generality, the AP may perform the method of FIG. 20A, FIG. 20B, and FIG. 20C acting in the role of sensing transmitter 504-1 while candidate reciprocal AP is acting in the role of sensing receiver 502-1.

Embodiment 1 is a method for Wi-Fi sensing carried out by a networking device configured to operate as an access point (AP) within a mesh network and including at least a receiving antenna, a transmitting antenna, and at least one processor configured to execute instructions, the method comprising: identifying, by the at least one processor, a reciprocal AP with which the AP has a reciprocal wireless link; determining, by the at least one processor, a first AP role determination metric associated with the AP; receiving, by the at least one processor, a second AP role determination metric associated with the reciprocal AP; comparing, by the at least one processor, the first AP role determination metric to the second AP role determination metric; allocating, by the at least one processor, a first sensing role to the AP based on the comparing; and allocating, by the at least one processor, a second sensing role to the reciprocal AP based on the comparing.

Embodiment 2 is the method of embodiment 1, wherein identifying the reciprocal AP includes: transmitting, via the transmitting antenna, a first sensing transmission to the reciprocal AP; receiving, via the receiving antenna, a first sensing measurement made on the first sensing transmission; receiving, via the receiving antenna, a second sensing transmission from the reciprocal AP; generating, by the at least one processor, a second sensing measurement based on the second sensing transmission; comparing the first sensing measurement to the second sensing measurement; and responsive to the comparing, identifying the reciprocal AP as having the reciprocal wireless link.

Embodiment 3 is the method of any of embodiments 1 or 2, wherein determining the first AP role determination metric includes determining a first AP congestion metric.

Embodiment 4 is the method of embodiment 3, wherein determining the first AP congestion metric is based on a number of associated STAs metric.

Embodiment 5 is the method of embodiment 4, wherein the number of associated STAs metric is determined according to a number of stations associated with the AP scaled by respective levels of activity on the stations.

Embodiment 6 is the method of any of embodiments 1 to 5, wherein determining the first AP role determination metric is based on a first AP bandwidth metric.

Embodiment 7 is the method of embodiment 6, wherein the first AP bandwidth metric is determined according to orthogonal frequency-division multiple access (OFDMA) activity of stations associated with the AP.

Embodiment 8 is the method of embodiment 7, wherein the first AP bandwidth metric is based on a total bandwidth allocated to stations associated with the AP.

Embodiment 9 is the method of any of embodiments 1 to 8, wherein determining the first AP role determination metric is based on a first computational metric of the AP.

Embodiment 10 is the method of any of embodiments 1 to 9, wherein determining the first AP role determination metric is based on a first over the air (OTA) metric of the AP.

Embodiment 11 is the method of embodiment 10, wherein the first OTA metric is determined according to a space metric and a hops metric.

Embodiment 12 is the method of embodiment 11, wherein the hops metric is equal to a number of wireless links between the AP and an internet connected AP.

Embodiment 13 is the method of embodiment 11, wherein the space metric is based on a location and visibility of the AP.

Embodiment 14 is the method of any of embodiments 1 to 13, wherein the first sensing role is a sensing receiver role, and allocating the first sensing role to the AP includes assigning the sensing receiver role to the AP based on the comparing.

Embodiment 15 is the method of any of embodiments 1 to 14, wherein the first AP role determination metric is determined according to a first AP bandwidth metric, a first computational metric, and a first OTA metric.

Embodiment 16 is the method of any of embodiments 1 to 15, further comprising determining to use a trigger based protocol or a non-trigger based protocol according to the first sensing role and the reciprocal wireless link.

Embodiment 17 is the method of any of embodiments 1 to 16, wherein the first AP role determination metric is a first combined AP role determination metric determined according to a first combination of at least two of a first AP bandwidth metric, a first computational metric, and a first OTA metric, and the second AP role determination metric is a second combined AP role determination metric determined according to a second combination of at least two of a second AP bandwidth metric, a second computational metric, and a second OTA metric.

Embodiment 18 is the method of embodiment 17, wherein the first combination and the second combination are weighted combinations.

Embodiment 19 is a system for Wi-Fi sensing comprising a networking device configured to operate as an access point (AP) within a mesh network and including at least a receiving antenna, a transmitting antenna, and at least one processor configured to execute instructions for: identifying, by the at least one processor, a reciprocal AP with which the AP has a reciprocal wireless link; determining, by the at least one processor, a first AP role determination metric associated with the AP; receiving, by the at least one processor, a second AP role determination metric associated with the reciprocal AP; comparing, by the at least one processor, the first AP role determination metric to the second AP role determination metric; allocating, by the at least one processor, a first sensing role to the AP based on the comparing; and allocating, by the at least one processor, a second sensing role to the reciprocal AP based on the comparing.

Embodiment 20 is the system of embodiment 19, wherein the instructions for identifying the reciprocal AP include further instructions for: transmitting, via the transmitting antenna, a first sensing transmission to the reciprocal AP; receiving, via the receiving antenna, a first sensing measurement made on the first sensing transmission; receiving, via the receiving antenna, a second sensing transmission from the reciprocal AP; generating, by the at least one processor, a second sensing measurement based on the second sensing transmission; comparing the first sensing measurement to the second sensing measurement; and responsive to the comparing, identifying the reciprocal AP as having the reciprocal wireless link.

Embodiment 21 is the system of any of embodiments 19 to 20, wherein determining the first AP role determination metric includes determining a first AP congestion metric.

Embodiment 22 is the system of embodiment 21, wherein determining the first AP congestion metric is based on a number of associated STAs metric.

Embodiment 23 is the system of embodiment 22, wherein the number of associated STAs metric is determined according to a number of stations associated with the AP scaled by respective levels of activity on the stations.

Embodiment 24 is the system of any of embodiments 19 to 23, wherein determining the first AP role determination metric is based on a first AP bandwidth metric.

Embodiment 25 is the system of embodiment 24, wherein the first AP bandwidth metric is determined according to orthogonal frequency-division multiple access (OFDMA) activity of stations associated with the AP.

Embodiment 26 is the system of embodiment 25, wherein the first AP bandwidth metric is based on a total bandwidth allocated to stations associated with the AP.

Embodiment 27 is the system of any of embodiments 19 to 26, wherein determining the first AP role determination metric is based on a first computational metric of the AP.

Embodiment 28 is the system of any of embodiments 19 to 27, wherein determining the first AP role determination metric is based on a first over the air (OTA) metric of the AP.

Embodiment 29 is the system of embodiment 28, wherein the first OTA metric is determined according to a space metric and a hops metric.

Embodiment 30 is the system of embodiment 29, wherein the hops metric is equal to a number of wireless links between the AP and an internet connected AP.

Embodiment 31 is the system of embodiment 29, wherein the space metric is based on a location and visibility of the AP.

Embodiment 32 is the system of any of embodiments 19 to 31, wherein the first sensing role is a sensing receiver role, and allocating the first sensing role to the AP includes assigning the sensing receiver role to the AP based on the comparing.

Embodiment 33 is the system of any of embodiments 19 to 32, wherein the first AP role determination metric is determined according to a first AP bandwidth metric, a first computational metric, and a first OTA metric.

Embodiment 34 is the system of any of embodiments 19 to 33, wherein the instructions are further configured for determining to use a trigger based protocol or a non-trigger based protocol according to first sensing role and the reciprocal wireless link.

Embodiment 35 is the system of any of embodiments 19 to 34, wherein the first AP role determination metric is a first combined AP role determination metric determined according to a first combination of at least two of a first AP bandwidth metric, a first computational metric, and a first OTA metric, and the second AP role determination metric is a second combined AP role determination metric determined according to a second combination of at least two of a second AP bandwidth metric, a second computational metric, and a second OTA metric.

Embodiment 36 is the system of embodiment 35, wherein the first combination and the second combination are weighted combinations.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

1. A method for Wi-Fi sensing carried out by a networking device configured to operate as an access point (AP) within a mesh network and including at least a receiving antenna, a transmitting antenna, and at least one processor configured to execute instructions, the method comprising:
identifying, by the at least one processor, a reciprocal AP with which the AP has a reciprocal wireless link;
determining, by the at least one processor, a first AP role determination metric associated with the AP;
receiving, by the at least one processor, a second AP role determination metric associated with the reciprocal AP;
comparing, by the at least one processor, the first AP role determination metric to the second AP role determination metric;
allocating, by the at least one processor, a first sensing role to the AP based on the comparing;
and
allocating, by the at least one processor, a second sensing role to the reciprocal AP based on the comparing.

2. The method of claim 1, wherein identifying the reciprocal AP includes:
transmitting, via the transmitting antenna, a first sensing transmission to the reciprocal AP; receiving, via the receiving antenna, a first sensing measurement made on the first sensing
transmission;
receiving, via the receiving antenna, a second sensing transmission from the reciprocal AP; generating, by the at least one processor, a second sensing measurement based on the second
sensing transmission;
comparing the first sensing measurement to the second sensing measurement; and
responsive to the comparing, identifying the reciprocal AP as having the reciprocal wireless
link.

3. The method of claim 1, wherein determining the first AP role determination metric includes determining a first AP congestion metric.

4. The method of claim 3, wherein determining the first AP congestion metric is based on a number of associated STAs metric.

5. (canceled)

6. The method of claim 1, wherein determining the first AP role determination metric is based on one or more of a first AP bandwidth metric, a first computational metric, and a first over the air (OTA) metric.

7. The method of claim 6, wherein the first AP bandwidth metric is determined according to orthogonal frequency-division multiple access (OFDMA) activity of stations associated with the AP.

8-10. (canceled)

11. The method of claim 6, wherein the first OTA metric is determined according to a space metric and a hops metric.

12-13. (canceled)

14. The method of claim 1, wherein the first sensing role is a sensing receiver role, and allocating the first sensing role to the AP includes assigning the sensing receiver role to the AP based on the comparing.

15. (canceled)

16. The method of claim 1, further comprising determining to use a trigger based protocol or a non-trigger based protocol according to the first sensing role and the reciprocal wireless link.

17. The method of claim 1, wherein the first AP role determination metric is a first combined AP role determination metric determined according to a first combination of at least two of a first AP bandwidth metric, a first computational metric, and a first OTA metric, and
the second AP role determination metric is a second combined AP role determination metric determined according to a second combination of at least two of a second AP bandwidth metric, a second computational metric, and a second OTA metric.

18. (canceled)

19. A system for Wi-Fi sensing comprising a networking device configured to operate as an access point (AP) within a mesh network and including at least a receiving antenna, a transmitting antenna, and at least one processor configured to execute instructions for:
identifying, by the at least one processor, a reciprocal AP with which the AP has a reciprocal wireless link;
determining, by the at least one processor, a first AP role determination metric associated with the AP;
receiving, by the at least one processor, a second AP role determination metric associated with the reciprocal AP;
comparing, by the at least one processor, the first AP role determination metric to the second AP role determination metric;
allocating, by the at least one processor, a first sensing role to the AP based on the comparing; and
allocating, by the at least one processor, a second sensing role to the reciprocal AP based on the comparing.

20. The system of claim 19, wherein the instructions for identifying the reciprocal AP include further instructions for:
transmitting, via the transmitting antenna, a first sensing transmission to the reciprocal AP; receiving, via the receiving antenna, a first sensing measurement made on the first sensing
transmission;
receiving, via the receiving antenna, a second sensing transmission from the reciprocal AP; generating, by the at least one processor, a second sensing measurement based on the second
sensing transmission;
comparing the first sensing measurement to the second sensing measurement; and
responsive to the comparing, identifying the reciprocal AP as having the reciprocal wireless
link.

21. The system of claim 19, wherein determining the first AP role determination metric includes determining a first AP congestion metric.

22. The system of claim 21, wherein determining the first AP congestion metric is based on a number of associated STAs metric.

23. (canceled)

24. The system of claim 19, wherein determining the first AP role determination metric is based on one or more of a first AP bandwidth metric, a first computational metric, and a first over the air (OTA) metric.

25. The system of claim 24, wherein the first AP bandwidth metric is determined according to orthogonal frequency-division multiple access (OFDMA) activity of stations associated with the AP.

26-28. (canceled)

29. The system of claim 24, wherein the first OTA metric is determined according to a space metric and a hops metric.

30-31. (canceled)

32. The system of claim 19, wherein the first sensing role is a sensing receiver role, and allocating the first sensing role to the AP includes assigning the sensing receiver role to the AP based on the comparing.

33. (canceled)

34. The system of claim 19, wherein the instructions are further configured for determining to use a trigger based protocol or a non-trigger based protocol according to first sensing role and the reciprocal wireless link.

35. The system of claim 19, wherein the first AP role determination metric is a first combined AP role determination metric determined according to a first combination of at least two of a first AP bandwidth metric, a first computational metric, and a first OTA metric, and
the second AP role determination metric is a second combined AP role determination metric determined according to a second combination of at least two of a second AP bandwidth metric, a second computational metric, and a second OTA metric.

36. (canceled)
